(19) United States
(12) Patent Application Publication
(10) Pub. No.: US 2025/0350760 A1
(43) Pub. Date: Nov. 13, 2025

(54) METHOD AND DEVICE FOR VIDEO DECODING, AND METHOD FOR VIDEO ENCODING

(71) Applicant: GUANGDONG OPPO MOBILE TELECOMMUNICATIONS CORP., LTD., Dongguan (CN)

(72) Inventor: Fan WANG, Dongguan (CN)

(73) Assignee: GUANGDONG OPPO MOBILE TELECOMMUNICATIONS CORP., LTD., Dongguan (CN)

(21) Appl. No.: 19/271,599

(22) Filed: Jul. 16, 2025

Related U.S. Application Data
(63) Continuation of application No. PCT/CN2023/072930, filed on Jan. 18, 2023.

(51) Int. Cl. H04N 19/513; H04N 19/105; H04N 19/139; H04N 19/176; H04N 19/573

(52) U.S. Cl. CPC H04N 19/521; H04N 19/105; H04N 19/139; H04N 19/176; H04N 19/573

(57) ABSTRACT

A method for video decoding includes: K prediction modes for a current block are determined, where at least one of the K prediction modes is an N-directional prediction mode, and each of the K and N is a positive integer greater than 1; and the current block is predicted based on the K prediction modes to determine a prediction value of the current block.

### CROSS REFERENCE TO RELATED APPLICATION

This is a continuation of International Application No. PCT/CN2023/072930 filed on Jan. 18, 2023, the disclosure of which is hereby incorporated by reference in its entirety.

### TECHNICAL FIELD

The present disclosure relates to the technical field of video encoding and decoding, and more particularly to, a method for video encoding, and a method and device for video decoding.

### BACKGROUND

Digital video technologies may be integrated into multiple kinds of video devices, such as, digital televisions, smartphones, computers, e-readers, or video players, etc. With the development of video technologies, video data includes a large amount of data, and in order to facilitate the transmission of the video data, the video devices implement video compression technologies to make the transmission or storage of the video data more efficient.

Since temporal redundancy or spatial redundancy exists in videos, the redundancy in the videos may be eliminated or reduced through prediction, and the compression efficiency may be improved. At present, in order to improve the prediction effect, multiple prediction modes may be used for predicting the current block. However, at present, when the multiple prediction modes are used for predicting the current block, there is a problem of inaccurate prediction.

### BRIEF DESCRIPTION OF THE DRAWINGS

FIG. 1 is a schematic block diagram of a video encoding and decoding system involved in an embodiment of the present disclosure.

FIG. 2 is a schematic block diagram of a video encoder involved in an embodiment of the present disclosure.

FIG. 3 is a schematic block diagram of a video decoder involved in an embodiment of the present disclosure.

FIG. 4 is a schematic diagram of weight allocation.

FIG. 5 is a schematic diagram of weight allocation.

FIG. 6A is a schematic diagram of inter prediction.

FIG. 6B is a schematic diagram of weighted inter prediction.

FIG. 6C is a schematic diagram of a blending area.

FIG. 6D is another schematic diagram of a blending area.

FIG. 7A is a schematic diagram of intra prediction.

FIG. 7B is a schematic diagram of intra prediction.

FIG. 8A to FIG. 8I are schematic diagrams of intra prediction.

FIG. 9 is a schematic diagram of intra prediction modes.

FIG. 10 is a schematic diagram of intra prediction modes.

FIG. 11 is a schematic diagram of intra prediction modes.

FIG. 12 is a schematic diagram of Matrix-based Intra Prediction (MIP).

FIG. 13 is a schematic diagram of Template-based Intra Mode Derivation (TIMD) prediction.

FIG. 14A is a histogram corresponding to Decoder-side Intra Mode Derivation (DIMD).

FIG. 14B is a schematic diagram of DIMD prediction.

FIG. 15 is a schematic diagram of combination prediction.

FIG. 16A is a schematic diagram of a template.

FIG. 16B is a schematic diagram of a template.

FIG. 16C is a schematic diagram of deriving template weights.

FIG. 16D is a schematic diagram of neighbouring blocks.

FIG. 16E is a schematic diagram of weight allocation.

FIG. 16F is a schematic diagram of weight allocation.

FIG. 16G is a schematic diagram of a template partitioning.

FIG. 16H is another schematic diagram of a template partitioning.

FIG. 17A and FIG. 17B are schematic diagrams of a Merge with Motion Vector Difference (MMVD).

FIG. 18 is a flowchart of a method for video decoding according to an embodiment of the present disclosure.

FIG. 19 is a schematic diagram of matching involved in an embodiment of the present disclosure.

FIG. 20 is another schematic diagram of matching involved in an embodiment of the present disclosure.

FIG. 21 is yet another schematic diagram of matching involved in an embodiment of the present disclosure.

FIG. 22 is a flowchart of a method for video decoding according to an embodiment of the present disclosure.

FIG. 23 is a schematic block diagram of a device for video decoding according to an embodiment of the present disclosure.

FIG. 24 is a schematic block diagram of a device for video encoding according to an embodiment of the present disclosure.

FIG. 25 is a schematic block diagram of an electronic device according to an embodiment of the present disclosure.

FIG. 26 is a schematic block diagram of a video encoding and decoding system according to an embodiment of the present disclosure.

### DETAILED DESCRIPTION

The present disclosure may be applied to the field of picture encoding and decoding, video encoding and decoding, hardware video encoding and decoding, dedicated-circuit video encoding and decoding, real-time video encoding and decoding, etc. For example, the solutions of the present disclosure may be combined with an Audio Video Coding Standard (AVS), such as, an H.264/Audio Video Coding (AVC) standard, an H.265/High Efficiency Video Coding (HEVC) standard, and an H.266/Versatile Video Coding (VVC) standard. Alternatively, the solutions of the present disclosure may be performed in conjunction with other proprietary standards or industry standards. The proprietary standards or industry standards include the International Telecommunication Union (ITU)-Telecommunication Standardization Sector (T) H.261, the International Organization for Standardization (ISO)/International Electrotechnical Commission (IEC) Moving Pictures Experts Group (MPEG)-1 Visual, the ITU-TH.262, or the ISO/IECMPEG-2 Visual, the ITU-TH.263, the ISO/IECMPEG-4 Visual, the ITU-TH.264 (also referred to as ISO/IECMPEG-4AVC). The ITU-TH.264 includes the Scalable Video Codec (SVC) extension and the Multi-view Video Coding (MVC) extension. It is to be understood that the technologies in the present disclosure are not limited to any specific coding standard or coding technology.

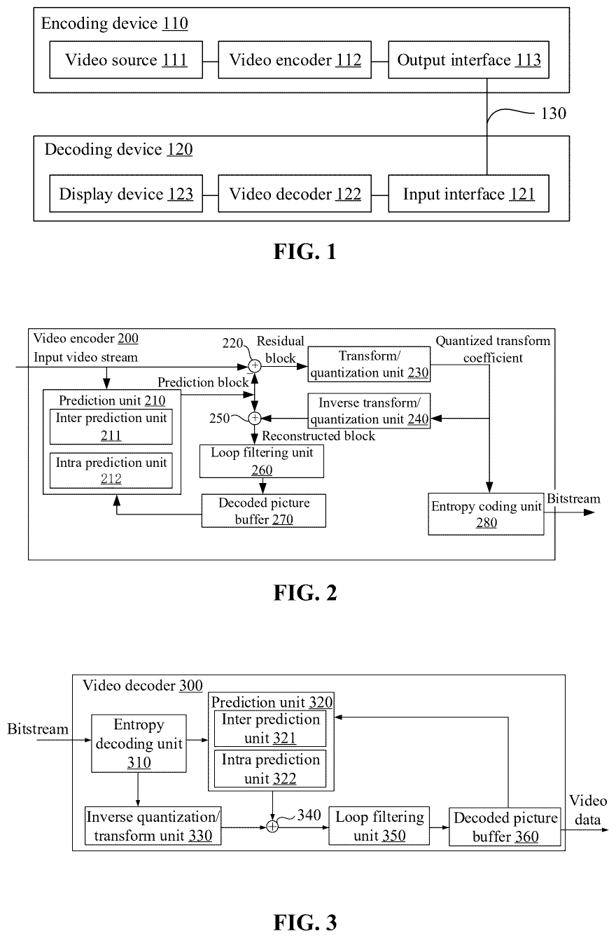

In order to facilitate understanding, the video encoding and decoding system involved in the embodiments of the present disclosure will be firstly described with reference to FIG. 1.

FIG. 1 is a schematic block diagram of a video encoding and decoding system involved in an embodiment of the present disclosure. It is to be noted that FIG. 1 is only an example, and the video encoding and decoding system according to the embodiment of the present disclosure includes, but is not limited to, the video encoding and decoding system shown in FIG. 1. As shown in FIG. 1, the video encoding and decoding system 100 includes an encoding device 110 and a decoding device 120. The encoding device is configured to perform encoding (which may be understood as compression) on video data to generate a bitstream; and transmit the bitstream to the decoding device. The decoding device decodes the bitstream generated by the encoding device to obtain decoded video data.

The encoding device 110 in the embodiment of the present disclosure may be understood as a device having a video encoding function, and the decoding device 120 may be understood as a device having a video decoding function. That is to say, the encoding device 110 and the decoding device 120 in the embodiment of the present disclosure include a broader range of devices including, such as, a smartphone, a desktop computer, a mobile computing device, a notebook (e.g., a laptop) computer, a tablet computer, a set-top box, a television, a camera, a display device, a digital media player, a video game console, an vehicle-mounted computer, etc.

In some embodiments, the encoding device 110 may transmit the encoded video data, such as the bitstream, to the decoding device 120 via a channel 130. The channel 130 may include one or more media and/or devices capable of transmitting the encoded video data from the encoding device 110 to the decoding device 120.

In an example, the channel 130 includes one or more communication media that enable the encoding device 110 to directly transmit the encoded video data to the decoding device 120 in real-time. In this example, the encoding device 110 may modulate the encoded video data according to a communication standard, and transmit the modulated video data to the decoding device 120. The communication media include wireless communication media, such as, radio frequency spectra. Optionally, the communication media may further include wired communication media, such as, one or more physical transmission lines.

In another example, the channel 130 includes a storage medium that may store video data encoded by the encoding device 110. The storage medium includes multiple kinds of locally accessible data storage media, such as, optical discs, Digital Video Discs (DVD), flash memories, etc. In this example, the decoding device 120 may acquire the encoded video data from the storage medium.

In another example, the channel 130 may include a storage server that may store video data encoded by encoding device 110. In this example, the decoding device 120 may download the stored encoded video data from the storage server. Optionally, the storage server may store the encoded video data and may transmit the encoded video data to the decoding device 120, and the storage server may be such as, a web server (e.g., for a website), a File Transfer Protocol (FTP) server, etc.

In some embodiments, the encoding device 110 includes a video encoder 112 and an output interface 113. The output interface 113 may include a modulator/demodulator (modem) and/or a transmitter.

In some embodiments, the encoding device 110 may include a video source 111 in addition to the video encoder 112 and the output interface 113.

The video source 111 may include at least one of a video capture device (e.g., a video camera), a video archiving, a video input interface, and a computer graphics system. The video input interface is configured to receive video data from a video content provider, and the computer graphics system is configured to generate the video data.

The video encoder 112 encodes the video data from the video source 111 to generate a bitstream. The video data may include one or more pictures or a sequence of pictures. The bitstream includes the encoded information of the picture or sequence of pictures in a form of a bit stream. The encoded information may include encoded picture data and associated data. The associated data may include a Sequence Parameter Set (SPS), a Picture Parameter Set (PPS), and other syntax structures. The SPS may include parameters applied to one or more sequences. The PPS may include parameters applied to one or more pictures. The syntax structures are a set of zero or multiple syntax elements ranked in a specified order in the bitstream.

The video encoder 112 directly transmits the encoded video data to the decoding device 120 via the output interface 113. The encoded video data may also be stored on a storage medium or a storage server for subsequent reading by the decoding device 120.

In some embodiments, the decoding device 120 includes an input interface 121 and a video decoder 122.

In some embodiments, the decoding device 120 may include a display device 123 in addition to the input interface 121 and the video decoder 122.

The input interface 121 includes a receiver and/or a modem. The input interface 121 may receive the encoded video data through the channel 130.

The video decoder 122 is configured to decode the encoded video data to obtain the decoded video data; and transmits the decoded video data to the display device 123.

The display device 123 displays the decoded video data. The display device 123 may be integrated with the decoding device 120 or be arranged external to the decoding device 120. The display device 123 may include multiple kinds of display devices, such as, a Liquid Crystal Display (LCD), a plasma display, an Organic Light Emitting Diode (OLED) display, or other types of display devices.

In addition, FIG. 1 is only an example, and the technical solutions of the embodiment of the present disclosure are not limited to the example shown in FIG. 1. For example, the technology of the present disclosure may also be applied to single-sided video encoding or single-sided video decoding.

Hereinafter, a video encoding framework involved in the embodiment of the present disclosure will be described.

FIG. 2 is a schematic block diagram of a video encoder involved in an embodiment of the present disclosure. It is to be understood that the video encoder 200 may be configured to perform lossy compression on a picture, and also be configured to perform lossless compression on a picture. The lossless compression may be visually lossless compression or mathematically lossless compression.

The video encoder 200 may be applied to picture data in a luma-chroma (YCbCr, YUV) format. For example, the YUV may have a ratio of 4:2:0, 4:2:2, or 4:4:4, Y represents Luma, Cb (U) represents chroma of blue, Cr (V) represents chroma of red. U and V represent Chroma for describing color and saturation. For example, for the color format, 4:2:0 represents 4 luma components and 2 chroma components per 4 pixels (YYYYCbCr), 4:2:2 represents 4 luma components and 4 chroma components per 4 pixels (YYYYCbCrCbCr), and 4:4:4 represents full pixel display (YYYYCbCrCbCrCbCrCbCr).

For example, the video encoder 200 reads the video data and for each picture in the video data, the picture is partitioned into multiple Coding Tree Units (CTUs). In some examples, the CTB may be referred to as a “tree block”, a “Largest Coding Unit” (LCU), or a “Coding Tree Block” (CTB). Each CTU may be associated with a pixel block having a size equal to the size of the CTU in a picture. Each pixel may correspond to one luminance (or, luma) sample and two chrominance (or, chroma) samples. Thus, each CTU may be associated with one luma sample block and two chroma sample blocks. One CTU may have a size of, such as, 128×128, 64×64, 32×32, etc. Furthermore, one CTU may be partitioned into several coding units (CUs) for coding, and the CUs may be rectangular blocks or square blocks. The CU may be further partitioned into prediction Units (PUs) and transform units (TUs), thereby separating the processing of encoding, prediction, and transform, and making the processing more flexible. In an example, the CTU is partitioned into CUs in a quadtree manner, and one CU is partitioned into TUs and PUs in a quadtree manner.

The video encoder and the video decoder may support various PU sizes. It is assumed that a specific CU has a size of 2N×2N, the video encoder and video decoder may support PUs having sizes of 2N×2N or N×N for intra prediction, and support symmetric PUs having sizes of 2N×2N, 2N×N, N×2N, N×N, or symmetric PUs having similar sizes for inter prediction. The video encoder and video decoder may also support asymmetric PUs having sizes of 2N×nU, 2N×nD, nL×2N, and nR×2N for inter prediction.

In some embodiments, as shown in FIG. 2, the video encoder 200 may include a prediction unit 210, a residual unit 220, a transform/quantization unit 230, an inverse transform/quantization unit 240, a reconstruction unit 250, a loop filtering unit 260, a decoded picture buffer 270, and an entropy coding unit 280. It is to be noted that video encoder 200 may include more, fewer, or different functional components compared with the functional components shown in FIG. 2.

Optionally, in the present disclosure, the current block may be referred to as a current Coding Unit (CU), a current Prediction Unit (PU), or the like. A prediction block may also be referred to as a prediction picture block or a picture prediction block. A reconstructed picture block may also be referred to as a reconstructed block or a reconstructed picture.

In some embodiments, the prediction unit 210 includes an inter prediction unit 211 and an intra prediction unit 212. Since there is a strong association between adjacent samples in one picture of a video, the intra prediction method is used in the video encoding and decoding technologies to eliminate spatial redundancy between adjacent samples. Since there is a strong similarity between adjacent pictures of the video, the inter prediction method is used in the video encoding and decoding technologies to eliminate the temporal redundancy between adjacent pictures, thus improving the encoding efficiency.

The inter prediction unit 211 may be used for the inter prediction. The inter prediction may include motion estimation and motion compensation. In the inter prediction, picture information of different pictures may be referred to, the motion information is used to find a reference block from a reference picture, and a prediction block is generated according to the reference block, to eliminate temporal redundancy. The picture used in the inter prediction may be a P picture and/or a B picture, where the P picture refers to a forward predictive picture and the B picture refers to a bi-directional predictive picture. The motion information is used to find the reference block from the reference picture, and the prediction block is generated according to the reference block in the inter prediction. The motion information includes a reference picture list where the reference picture is located, a reference picture index, and a motion vector. The motion vector may have integer-pixel precision or fractional-pixel precision. If the motion vector has fractional-pixel precision, interpolation filtering is required to be performed on the reference picture to generate a required fractional-pixel block. Herein, the integer-pixel block or the fractional-pixel block found in the reference picture according to the motion vector is referred to the reference block. In some technologies, the reference block may be directly used as the prediction block, and in some technologies, the reference block may be reprocessed to generate the prediction block. The reference block being reprocessed to generate the prediction block may also be understood as taking the reference block as a prediction block and then processing the prediction block to generate a new prediction block.

The intra prediction unit 212 predicts pixel information of the current picture block only with reference to the information of a same picture, to eliminate the spatial redundancy. The picture used in the intra prediction may be an I picture.

The intra prediction includes multiple prediction modes. Taking the H series of the international digital video coding standard as an example, in the H.264/AVC standard, there are 8 angular prediction modes and 1 non-angular prediction mode, and in the H.265/HEVC, the prediction mode is extended to include 33 angular prediction modes and 2 non-angular prediction modes. The intra prediction modes used in the HEVC include 35 prediction modes including the planar mode, Direct Current (DC) mode and 33 angular modes. The intra modes used in the VVC include 67 prediction modes including the planar mode, the DC mode, and 65 angular modes.

It is to be noted that with the increase of the number of the angular modes, the intra prediction will be more accurate and more in line with the development requirements for the high-definition digital video and ultra-high-definition digital video.

The residual unit 220 may generate a residual block of the CU based on a pixel block of the CU and a prediction block of the PU of the CU. For example, the residual unit 220 may generate a residual block of the CU, such that each sample in the residual block has a value equal to a difference between a sample in the pixel block of the CU and a corresponding sample in the prediction block of the PU of the CU.

The transform/quantization unit 230 may quantize a transform coefficient. The transform/quantization unit 230 may quantize a transform coefficient associated with the TU of the CU based on a quantization parameter (QP) value associated with the CU. The video encoder 200 may adjust, by adjusting the QP value associated with the CU, the degree of quantization applied to the transform coefficient associated with the CU.

The inverse transform/quantization unit 240 may apply inverse quantization and inverse transform to the quantized transform coefficient, respectively, to reconstruct a residual block from the quantized transform coefficient.

The reconstruction unit 250 may add each of samples of the reconstructed residual block to a respective sample of the one or more prediction blocks generated by the prediction unit 210, to generate a reconstructed picture block associated with the TU. By reconstructing the sample block of each TU of the CU in this manner, the video encoder 200 may reconstruct the pixel blocks of the CU.

The loop filtering unit 260 is configured to process the pixels that are inversely-transformed and inversely-quantized to compensate for the distortion information and provide a better reference for subsequently encoding pixels. For example, a deblocking filtering operation may be performed to reduce blocking artifacts of the pixel block associated with the CU.

In some embodiments, the loop filtering unit 260 includes a deblocking filtering unit and a sample adaptive compensation/adaptive loop filter (SAO/ALF) unit. The deblocking filtering unit is configured to remove blocking artifacts and the SAO/ALF unit is configured to remove ringing artifacts.

The decoded picture buffer 270 may store the reconstructed pixel block. The inter prediction unit 211 may perform the inter prediction on PUs of other pictures by using a reference picture including the reconstructed pixel block. In addition, the intra prediction unit 212 may use the reconstructed pixel block in the decoded picture buffer 270 to perform the intra prediction on other PUs in the picture being the same as the picture where the CU is located.

The entropy coding unit 280 may receive the quantized transform coefficient from the transform/quantization unit 230. The entropy coding unit 280 may perform one or more entropy coding operations on the quantized transform coefficient to generate entropy-coded data.

FIG. 3 is a schematic block diagram of a video decoder involved in an embodiment of the present disclosure

As shown in FIG. 3, the video decoder 300 includes: an entropy decoding unit 310, a prediction unit 320, an inverse quantization/transform unit 330, a reconstruction unit 340, a loop filtering unit 350, and a decoded picture buffer 360. It is to be noted that video decoder 300 may include more, fewer, or different functional components compared with the functional components shown in FIG. 3.

The video decoder 300 may receive a bitstream. The entropy decoding unit 310 may parse the bitstream to extract syntax elements from the bitstream. As a part of parsing the bitstream, the entropy decoding unit 310 may parse the entropy-coded syntax elements in the bitstream. The prediction unit 320, the inverse quantization/transform unit 330, the reconstruction unit 340, and the loop filtering unit 350 may decode the video data according to the syntax elements extracted from the bitstream, i.e., may generate decoded video data.

In some embodiments, the prediction unit 320 includes an intra prediction unit 322 and an inter prediction unit 321.

The intra prediction unit 322 may perform intra prediction to generate a prediction block of the PU. The intra prediction unit 322 may use an intra prediction mode to generate a prediction block of a PU based on pixel blocks of spatial adjacent PUs. The intra prediction unit 322 may also determine an intra prediction mode for the PU from one or more syntax elements parsed from the bitstream.

The inter prediction unit 321 may construct a first reference picture list (referred to List 0) and a second reference picture list (referred to List 1) based on syntax elements parsed from the bitstream. In addition, if the inter prediction coding is performed on the PU, the entropy decoding unit 310 may parse the motion information of the PU. The inter prediction unit 321 may determine one or more reference blocks of the PU according to the motion information of the PU. The inter prediction unit 321 may generate a prediction block of the PU from the one or more reference blocks of the PU.

The inverse quantization/transform unit 330 may perform the reverse quantization (i.e., de-quantization) on the transform coefficient associated with the TU. The inverse quantization/transform unit 330 may determine the degree of quantization by using the QP value associated with the CU of the TU.

After the transform coefficient is inversely quantized, the inverse quantization/transform unit 330 may apply one or more inverse transforms to the inversely-quantized transform coefficient in order to generate a residual block associated with the TU.

The reconstruction unit 340 uses the residual block associated with the TU of the CU and the prediction block of the PU of the CU to reconstruct the pixel block of the CU. For example, the reconstruction unit 340 may add a sample of the residual block to a respective sample of the prediction block to reconstruct the pixel blocks of the CU, to obtain a reconstructed picture block.

The loop filtering unit 350 may perform a deblocking filtering operation to reduce blocking artifacts of the pixel block associated with the CU.

The video decoder 300 may store the reconstructed picture of the CU in the decoded picture buffer 360. The video decoder 300 may use the reconstructed picture in the decoded picture buffer 360 as a reference picture for subsequent prediction, or alternatively, the video decoder 300 may transmit the reconstructed picture to a display device for presentation.

The basic process of video encoding and decoding is as follows. At the encoding end, one picture is partitioned into blocks. For a current block, the prediction unit 210 generates a prediction block of the current block by using the intra prediction or the inter prediction. The residual unit 220 may calculate a residual block based on the prediction block and the original block of the current block, i.e., calculating a difference between the prediction block and the original block of the current block, and the residual block may also be referred to as residual information. The residual block is transformed and quantized by the transform/quantization unit 230, and then information that is insensitive to the human eye may be removed to eliminate visual redundancy. Optionally, the residual block before being transformed and quantized by the transform/quantization unit 230 may be referred to as a time-domain residual block, and the time-domain residual block after being transformed and quantized by the transform/quantization unit 230 may be referred to as a frequency residual block or a frequency-domain residual block. The entropy coding unit 280 receives the quantized transform coefficient output from the transform/quantization unit 230, performs entropy coding on the quantized transform coefficient, and outputs a bitstream. For example, the entropy coding unit 280 may eliminate character redundancy according to the target context model and probability information of the binary bitstream.

At the decoding end, the entropy decoding unit 310 may parse the bitstream to obtain prediction information, quantization coefficient matrix, and the like of the current block, and the prediction unit 320 uses the intra prediction or the inter prediction to generate a prediction block of the current block based on the prediction information. The inverse quantization/transform unit 330 performs inverse quantization and inverse transform on the quantization coefficient matrix obtained from the bitstream to obtain residual blocks. The reconstruction unit 340 adds the prediction blocks to the residual blocks to obtain reconstructed blocks. The reconstructed blocks constitute a reconstructed picture, and the loop filtering unit 350 performs loop filtering on the reconstructed picture based on the picture or the blocks to obtain a decoded picture. The encoding end also needs to perform operations analogous to those in the decoding end to obtain the decoded picture. The decoded picture may also be referred to as a reconstructed picture, and the reconstructed picture may be used as a reference picture for performing the inter prediction on a subsequent picture.

It is to be note that the block partitioning information, and mode information (such as prediction, transform, quantization, entropy coding, loop filtering) or parameter information, etc., determined at the encoding end are carried in the bitstream when necessary. The decoding end determines the block partitioning information, and the mode information (such as the prediction, the transform, the quantization, the entropy coding, the loop filtering) or the parameter information, etc., being the same as those of the encoding end by parsing the bitstream and analyzing according to the existing information, so as to ensure that the decoded picture obtained by the encoding end is the same as the decoded picture obtained by the decoding end.

The foregoing is the basic process of the video encoding and decoding under a block-based hybrid coding framework, and with the development of technology, some modules or operations in the framework or the process may be optimized. The present disclosure is applicable to this kind of basic process of the video encoding and decoding under the block-based hybrid coding framework, but is not limited to this framework and process described above.

In the embodiment of the present disclosure, the current block may be a current Coding Unit (CU), a current Prediction Unit (PU), or the like. Due to the requirement of parallel processing, a picture may be partitioned into slices, etc. The slices in the same picture may be processed in parallel. That is to say, there is no data dependence between the slices. The term “frame” is a commonly expression that may generally be understood as that one frame is one picture. In the present disclosure, one frame may also be replaced with one picture or one slice or the like.

In the current Versatile Video Coding (VVC) that is a video encoding and decoding standard, there is an inter prediction mode referred to Geometric Partitioning Mode (GPM). In the Video Coding Standard (AVS) currently being formulated, there is an inter prediction mode referred to Angular Weighted Prediction (AWP) mode. Although these two modes have different names and different specific implementation forms, they have something in common in principle.

It is to be noted that in the conventional unidirectional prediction, only one reference block having the same size as the current block is found, and in the conventional bi-directional prediction, two reference blocks having the same size the current block are used, and a sample value of each point in the prediction block is an average of a sample value of a point at a position in one reference block that corresponds to a position of the point in the prediction block and a sample value of a point at a position in another reference block that corresponds to the position of the point in the prediction block, i.e., all points in each reference block account for 50%. In the bi-directional weighted prediction, the proportions of the two reference blocks are different from each other, for example, all points in the first one of the reference blocks account for 75% and all points in the second one of the reference block account for 25%. But all points in the same reference block have the same proportion. But all points in the same reference block have the same proportion. Other optimization manners, such as Decoder side Motion Vector Refinement (DMVR) technology, Bi-directional Optical Flow (BIO), etc., may cause some changes in the reference sample or the prediction sample, but which is unrelated to principle mentioned. The Bi-directional Optical Flow may also be abbreviated as BDOF. However, two reference blocks having the same size as the current block are also used in the GPM or AWP, but for certain pixel positions in the prediction block, sample values of positions in the first one of the reference blocks that correspond to the certain pixel positions are used at the proportion of 100%, for certain pixel positions in the prediction block, sample values of positions in the second one of the reference blocks that correspond to the certain pixel positions are used at the proportion of 100%, and in the boundary area or blending area, sample values of the positions in the two reference blocks that correspond to the pixel positions in the boundary area or blending area are used in a certain proportion. The weights of the boundary area are also gradually blended. How these weights are allocated is determined by modes of GPM or AWP. The weight of each pixel position is determined according to the modes of GPM or AWP. Of course, in some cases, such as a case where the block has a very small size, in the some modes of GPM or AWP, it may not guarantee that the sample values of the positions in the first one of the reference blocks that correspond to certain pixel positions in the prediction block may be used for the certain pixel positions at the proportion of 100%, and the sample values of the positions in the second one of the reference blocks that correspond to certain pixel positions in the prediction block may be used for the certain pixel positions at the proportion of 100%. It may also be considered that two reference blocks having sizes different from the size of the current block are used in the GPM or AWP. That is to say, for each of the two reference blocks, a desired part of a picture is used as the reference block, i.e., the part having a weight of non-zero is used as the reference block, and the part having a weight of 0 is removed, which is a matter of implementation and is not the focus of this disclosure.

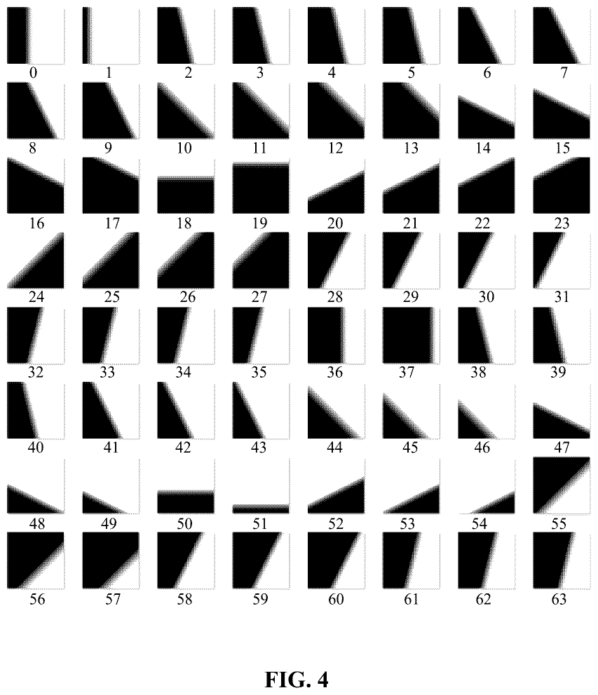

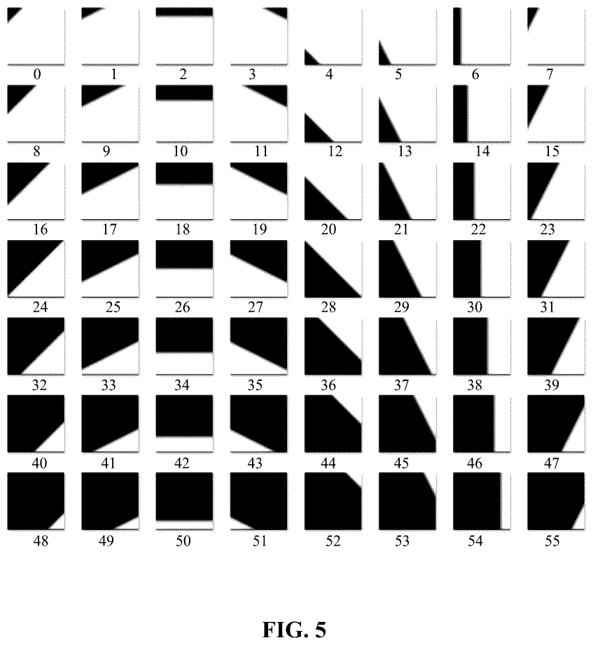

Exemplarily, FIG. 4 is a schematic diagram of weight allocation, and as shown in FIG. 4, which shows a schematic diagram of weight allocation in multiple partitioning modes of the GPM on a current block having a size of 64×64 provided by an embodiment of the present disclosure, and there are 64 partitioning modes in the GPM. FIG. 5 is a schematic diagram of weight allocation, as shown in FIG. 5, which shows a schematic diagram of weight allocation in multiple partitioning modes of the AWP on a current block having the size of 64×64 provided by an embodiment of the present disclosure, and there are 56 partitioning modes in the AWP. Regardless of FIG. 4 or FIG. 5, in each partitioning mode, the black area represents that the weight value of the corresponding position in the first one of the reference blocks is 0%, the white area represents that the weight value of the corresponding position in the first one of the reference blocks is 100%, the gray area represents that the weight values of the corresponding positions in the first one of the reference blocks are certain weight values greater than 0% and less than 100% according to different shades of color, and the weight value of the corresponding position in the second one of the reference blocks is 100% minus the weight value of the corresponding position in the first one of the reference blocks.

The weight derivation method of the GPM is different from the weight derivation method of the AWP. In the GPM, the angle and offset are determined according to each mode; and then a weight matrix for each mode is calculated. In the AWP, a one-dimensional line of weights is firstly made; and then the entire matrix is spread with the one-dimensional line of weights by using a method similar to angular intra prediction.

It is to be understood that only a rectangular partitioning mode existed in the early encoding and decoding technologies, whether for the partitioning of the CU, the PU, or the Transform Unit (TU). However, the GPM or AWP achieves the predicted non-rectangular partitioning effect without partitioning. In the GPM and AWP, a mask of the weights of the two reference blocks is used, i.e., the diagram of the weights described above. This mask determines the weights of the two reference blocks when the prediction block is generated, or it may be simply understood as that a part of the positions in the prediction block comes from the first one of the reference blocks, and a part of the positions comes from the second one of the reference blocks, while the blending area is obtained by performing weighting on the positions in the two reference blocks that correspond to the positions in the blending area, which makes the blending smoother. In the GPM and the AWP, the current block is not partitioned into two CUs or PUs according to the partitioning line. Therefore, for the transform, quantization, inverse transform, inverse quantization, etc. performed on the residual after prediction, the current block is processed as a whole.

In the GPM, the partitioning of geometry, and more specifically the partitioning of prediction, is simulated by using the weight matrix. To implement GPM, two prediction values are required in addition to the weight matrix, and each prediction value is determined by one piece of unidirectional motion information. These two pieces of unidirectional motion information come from one motion information candidate list, such as, a merge motion information candidate list (mergeCandList). In the GPM, two indices are used in the bitstream to determine the two pieces of unidirectional motion information from the mergeCandList.

In the inter prediction, motion information is used for representing “motion”. The basic motion information includes information of a reference frame (or reference picture) and information of a Motion Vector (MV). In the commonly used bi-directional prediction, 2 reference blocks are used to predict the current block. One forward reference block and one backward reference block may be used as the two reference blocks. Optionally, it is also allowed that both 2 reference blocks are the forward reference blocks or both 2 reference blocks are backward reference blocks. The expression of the forward means that the time corresponding to the reference picture is located before a time where the current picture is located, and the expression of the backward means that the time corresponding to the reference picture is located after a time where the current picture is located. In other words, the expression of the forward means that the position of the reference picture is located before the current picture in the video, and the expression of the backward means that the position of the reference picture is located after the current picture in the video. In other words, the expression of the forward means that a Picture Order Count (POC) of the reference picture is smaller than a POC of the current picture, and the expression of the backward means that the POC of the reference picture is larger than the POC of the current picture. In order to use bi-directional prediction, it is naturally necessary to be able to find two reference blocks, so two sets of information of reference pictures and motion vectors are needed. Each set of them may be understood as one piece of unidirectional motion information, and one piece of bi-directional motion information is formed when these two sets are combined together. In specific implementation, the same data structure may be used for the unidirectional motion information and the bi-directional motion information, except that the two sets of information of reference pictures and motion vectors in the bi-directional motion information are valid, while one set of information of reference pictures and motion vectors in the unidirectional motion information is invalid.

In some embodiments, two reference picture lists are supported, denoted as RPL0 and RPL1, where RPL is an abbreviation for Reference Picture List. In some embodiments, the P slice may use only RPL0 and the B slice may use both RPL0 and RPL1. For one slice, there are several reference pictures in each reference picture list, and the codec finds a certain reference picture through the reference picture index. In some embodiments, the motion information is represented by the reference picture index and the motion vector. For the bi-directional motion information described above, the reference picture index refIdxL0 corresponding to the reference picture list 0, the motion vector mvL0 corresponding to the reference picture list 0, the reference picture index refIdxL1 corresponding to the reference picture list 1, and the motion vector mvL1 corresponding to the reference picture list 1 are used. Herein, the reference picture index corresponding to the reference picture list 0 and the reference picture index corresponding to the reference picture list 1 may be understood as the information of the reference picture described above. In some embodiments, two flag bits are used for indicating whether the motion information corresponding to the reference picture list 0 is used and whether the motion information corresponding to the reference picture list 1 is used, respectively, which are denoted as predFlagL0 and predFlagL1, respectively. It may also be understood that the predFlagL0 and the predFlagL1 indicate whether the above-mentioned unidirectional motion information is valid. Although the data structure of motion information is not explicitly mentioned, the reference picture index, the motion vector, and the flag bit indicating “valid or not corresponding to each reference picture list are used together to represent the motion information. In some standard texts, the motion vector is used instead of the motion information, and it is also considered that the reference picture index and the flag indicating whether the corresponding motion information is used are attachments of the motion vector. In the present disclosure, “motion information” is still used for convenience of description, but it is to be understood that “motion vector” may also be used for description.

The motion information used by the current block may be stored. The block to be subsequently encoded or decoded of the current picture may use the motion information of the block that has been encoded or decoded previously, such as, the neighbouring block, according to the adjacent positional relationship, which takes advantage of spatial association, so this kind of motion information that has been encoded or decoded is referred to spatial motion information. The motion information used by each block of the current picture may be stored. The picture to be subsequently encoded or decoded may use the motion information of the picture that has been encoded or decoded previously according to the reference relationship, which takes advantage of the association in the time domain, so this kind of motion information of the picture that has been encoded or decoded is referred to motion information in the time domain. The storage method of motion information used for each block of the current picture usually is that a matrix having a fixed size, such as a matrix having a size of 4×4, is used as a minimum unit, and each minimum unit separately stores a set of motion information. In this way, every time a block is encoded or decoded, the minimum units corresponding to the position of the block may store the motion information of this block. In this way, when the motion information in the spatial domain or the motion information in the time domain is used, the motion information corresponding to a position may be directly found according to the position. If the conventional unidirectional prediction is used for a block having a size of 16×16, then all minimum units each having a size of 4×4 corresponding to this block store the motion information of this unidirectional prediction. If the GPM or the AWP is used for a block, all minimum units corresponding to the block will determine the motion information stored by each minimum unit according to the mode of GPM or AWP, the first one of the motion information, and the second one of the motion information, and the respective position of each minimum unit. One method is that if all 4×4 pixels corresponding to a minimum unit come from the first one of the motion information, then the minimum unit stores the first one of the motion information, and if all 4×4 pixels corresponding to a minimum unit come from the second one of the motion information, then the minimum unit stores the second one of the motion information. If the 4×4 pixels corresponding to a minimum unit come from both the first one of the motion information and the second one of the motion information, then one of the two pieces of motion information may be selected to be stored in the AWP; and in the GPM, if the two pieces of motion information point to different reference picture lists, then the two pieces of motion information are combined into bi-directional motion information to be stored; otherwise, only the second one of the motion information is stored.

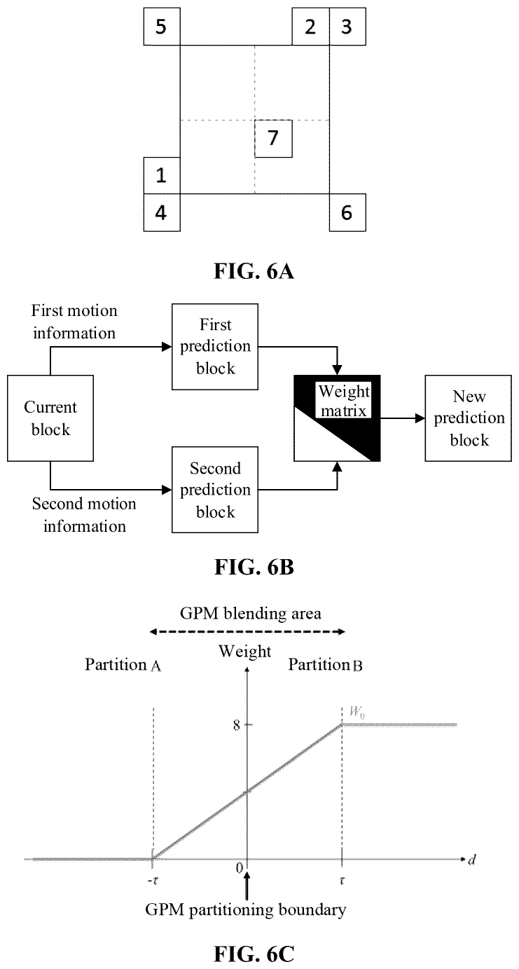

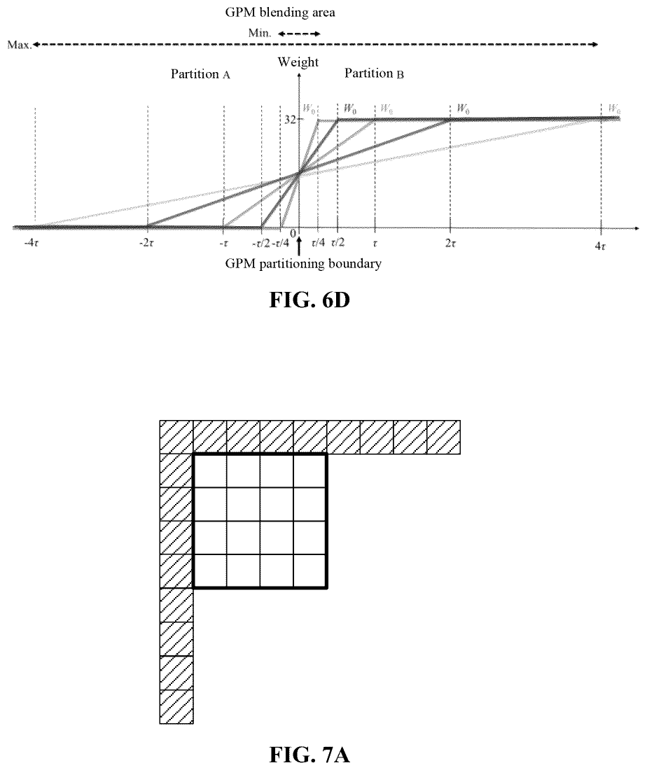

Optionally, the mergeCandList is constructed based on the spatial-domain motion information, the time-domain motion information, the history-based motion information, and some other motion information. Exemplarily, for the mergeCandList, positions shown as 1 to 5 in FIG. 6A are uses for deriving spatial-domain motion information and positions shown as 6 or 7 in FIG. 6A to are uses for deriving time-domain motion information. The history-based motion information is obtained by adding motion information of a block into a first-in-first-out list every time the block is encoded or decoded. Some checks may be required in the addition process, such as, whether the motion information is duplicated with the existing motion information in the list. In this way, the motion information in this history-based list may be referred to when the current block is encoded or decoded.

In some embodiments, the syntax description for the GPM is as shown in Table 1.

TABLE 1

| | |
|---|---|
| regular_merge_flag[x0][y0] | ae(v) |
| if( regular_merge_flag[x0][y0] == 1 ) { | |
| if( sps_mmvd_enabled_flag ) | |
| mmvd_merge_flag[x0][y0] | ae(v) |
| if( mmvd_merge_flag[x0][y0] == 1 ) { | |
| if( MaxNumMergeCand > 1 ) | |
| mmvd_cand_flag[x0][y0] | ae(v) |
| mmvd_distance_idx[x0][y0] | ae(v) |
| mmvd_direction_idx[x0][y0] | ae(v) |
| } else if( MaxNumMergeCand > 1 ) | |
| merge_idx[x0][y0] | ae(v) |
| } else { | |
| if( sps_ciip_enabled_flag && sps_gpm_enabled_flag && | |
| sh_slice_type == B && | |
| cu_skip_flag[x0][y0] == 0 && cbWidth >= 8 && | |
| cbHeight >= 8 && | |
| cbWidth < (8*cbHeight) && cbHeight < (8*cbWidth) && | |
| cbWidth < 128 && cbHeight < 128 ) | |
| ciip_flag[x0][y0] | ae(v) |
| if( ciip_flag[x0][y0] && MaxNumMergeCand > 1 ) | |
| merge_idx[x0][y0] | ae(v) |
| if( !ciip_flag[x0][y0] ) { | |
| merge_gpm_partition_idx[x0][y0] | ae(v) |
| merge_gpm_idx0[x0][y0] | ae(v) |
| if( MaxNumGpmMergeCand > 2 ) | |
| merge_gpm_idx1[x0][y0] | ae(v) |
| } | |
| } | |

As shown in Table 1, in the merge mode, if the value of the regular_merge_flag is not 1, the CIIP or the GPM may be used for the current block. If the CIIP is not used for the current block, then the GPM is used, which is shown as the syntax “if (!ciip_flag[x0][y0])” in Table 1.

As can be seen from Table 1 above, in the GPM, three pieces of information, i.e., merge_gpm_partition_idx, merge_gpm_idx0, and merge_gpm_idx1, are required to be transmitted in the bitstream. x0, y0 is used for determining the coordinates (x0, y0) of the top-left luma pixel of the current block relative to the top-left luma pixel of the picture. The merge_gpm_partition_idx determines the partitioning shape in the GPM, which is “simulation partitioning” as mentioned above. The merge_gpm_partition_idx is the index of the weight matrix derivation mode or weight matrix derivation mode mentioned, or the index of the weight derivation mode or weight derivation mode in the present disclosure. The merge_gpm_idx0 is the first one of merge candidate indices, and the first one of merge candidate indices is used for determining the first motion information according to the mergeCandList or referred to as the first merge candidate. The merge_gpm_idx1 is the second one of the merge candidate indices, and the second one of merge candidate indices is used for determining second motion information according to the mergeCandList or referred to as the second merge candidate. If MaxNumGpmMergeCand>2, i.e., a length of the candidate list is greater than 2, then merge_gpm_idx1 is required to be decoded; otherwise, merge_gpm_idx1 may be directly determined.

The decoding process for the GPM is introduced below.

The input information to the decoding process includes: a coordinates (xCb, yCb) of the top-left luma location of the current block relative to the top-left luma location of the picture, a width cbWidth of the luma component of the current block, a height cbHeight of the luma component of the current block, the luma motion vectors mvA and mvB in 1/16 pixel precision, the chroma motion vectors mvCA and mvCB, the reference picture indices refIdxA and refIdxB, and the prediction list flags predListFlagA and predListFlagB.

Exemplarily, the motion information may be represented by a combination of the motion vectors, the reference picture indices, and the prediction list flags. 2 reference picture lists are supported in the VVC, and each reference picture list may have multiple reference pictures. In the unidirectional prediction, only one reference block of one reference picture in one of the reference picture lists is used as a reference, and in the bi-directional prediction, one reference block of each reference picture in each of the two reference picture lists is used as references. While for the GPM in the VVC, 2 unidirectional predictions are used. In the above mvA and mvB, mvCA and mvCB, refIdxA and refIdxB, predListFlagA and predListFlagB, “A” may be understood as the first one of the prediction modes and “B” may be understood as the second one of the prediction modes. “X” is used for representing “A” or “B”, predListFlagX represents whether X uses the first one of the reference picture lists or the second one of the reference picture lists, refIdxX represents the reference picture index in the reference picture list used by X, mvX represents the luma motion vector used by X, and mvCX represents the chroma motion vector used by X. Again, it may be considered that in the VVC, the motion vectors, the reference picture indices, and the prediction list flags are combined to represent the motion information described herein.

The information output by the decoding process includes: an (cbWidth)×(cbHeight) matrix predSamplesL of luma prediction samples; an (cbWidth/SubWidthC)×(cbHeight/SubHeightC) matrix of chroma prediction samples for the component Cb, if which is required, and an (cbWidth/SubWidthC)×(cbHeight/SubHeightC) matrix of chroma prediction samples for the component Cr, if which is required.

Exemplarily, the luma component is taken as an example below, and the processing of the chroma component is similar to that of the luma component.

It is assumed that the predSamplesLAL and predSamplesLBL have the size of (cbWidth)×(cbHeight), and are prediction sample matrices made according to two prediction modes. The predSamplesL is derived in following method. predSamplesLAL and predSamplesLBL are respectively determined according to the luma motion vectors mvA and mvB, the chroma motion vectors mvCA and mvCB, the reference picture indices refIdxA and refIdxB, and the prediction list flags predListFlagA and predListFlagB. That is to say, prediction is respectively performed according to the motion information of the two prediction modes, and the detailed process will not be repeated. Generally, the GPM is a merge mode, and it may be considered that both prediction modes of the GPM are the merge modes.

According to merge_gpm_partition_idx[xCb][yCb], the partition angle index variable angleIdx of the GPM and the distance index variable distanceIdx of the GPM are determined by using Table 2.

TABLE 2
correspondence between angleIdx and distanceIdx according to
merge_gpm_partition_idx

| merge_gpm_partition_idx | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_gpm_partition_idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 1 | 2 | 3 | 0 | 1 | 2 | 3 |
| merge_gpm_partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| merge_gpm_partition_idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |

It is to be noted that, because the GPM may be used for all three components (such as Y, Cb, and Cr), in some standard texts, the process of generating the prediction sample matrix of the GPM for one component is packaged into a sub-process, i.e., the weighted sample prediction process for geometric partitioning mode, all three components will invoke this process, but the invoked parameters are different. Herein, only the luma component is used as an example. The prediction matrix predSamplesL [xL][yL] of the current luma block (where xL=0 . . . cbWidth−1 and yL=0 . . . cbHeight−1) is derived by the weighted sample prediction process for GPM. nCbW is set to be cbWidth, nCbH is set to be cbHeight, and the prediction sample matrices predSamplesLAL and predSamplesLBL maded by the two prediction modes, and angleIdx and distanceIdx are used as inputs.

In some embodiments, a derivation of the weighted sample prediction process for includes the following operations.

The inputs to this process are: a width nCbW of the current block, a height nCbH of the current block; two (nCbW)×(nCbH) matrices of prediction samples predSamplesLA and predSamplesLB; a partition angle index variable angleIdx of the GPM; a distance index variable distanceIdx of the GPM; and a component index variable cIdx. In this example, the luma is taken as an example, and thus cIdx is 0, which indicates the luma component.

The output of this process is a (nCbW)×(nCbH) matrix pbSamples of prediction samples of GPM.

Exemplarily, the variables nW, nH, shift1, offset1, displacementX, displacementY, partFlip and shiftHor are derived as follows:

$$n W = ( cIdx == 0 ) ? nCbW : nCbW ⋆ SubWidthC ;$$

$$nH = ( cIdx == 0 ) ? nCbH : nCbH ⋆ SubHeightC ;$$

shift1=Max (5, 17−BitDepth), where the BitDepth is a bit depth of the encoding and decoding;
offset1=1<< (shift1−1), where “<<” indicates a left shift;

$$displacementX = angleIdx ;$$

$$displacementY = ( angleIdx + 8 ) \% 32 ;$$

$$partFlip = ( angleIdx >= 13 \&\& angleIdx <= 27 ) ? 0 : 1 ;$$

$$shiftHor = ( angleIdx \% 16 == 8 \vert \vert ( angleIdx \% 16 != 0 \&\& nH >= nW ) ) ? 0 : 1.$$

The variables offsetX and offsetY are derived as follows.

If shiftHor is equal to 0:

$$offsetX = ( - n W ) >> 1 ,$$

$$offsetY = ( ( - nH ) >> 1 ) + ( angleIdx < 16 ? ( distanceIdx * nH ) >> 3 : - ( ( distanceIdx ⋆ nH ) >> 3 ) ) .$$

If shiftHor is equal to 1:

$$offsetX = ( ( - nW ) >> 1 ) + ( angleIdx < 16 ? ( distanceIdx ⋆ nW ) >> 3 : - ( ( distanceIdx ⋆ nW ) >> 3 ) ,$$

$$offsetY = ( - nH ) >> 1.$$

The variables xL and yL are derived as follows:

$$x L = ( cIdx == 0 ) ? x : x ⋆ SubWidthC ,$$

$$yL = ( cIdx == 0 ) ? y : y ⋆ SubHeightC ,$$

The variable w Value representing the weight of the prediction sample at the current position is derived as follows: wValue is a weight of prediction values predSamplesLA[x][y] of the prediction matrix of the first one of prediction modes at the point (x, y), and (8−wValue) is a weight of prediction values predSamplesLB[x][y] of the prediction matrix of the first one of prediction modes at the point (x, y).

The distance matrix disLut is determined according to Table 3.

TABLE 3

| idx | 0 | 2 | 3 | 4 | 5 | 6 | 8 | 10 | 11 | 12 | 13 | 14 |
|---|---|---|---|---|---|---|---|---|---|---|---|---|
| disLut[idx] | 8 | 8 | 8 | 4 | 4 | 2 | 0 | −2 | −4 | −4 | −8 | −8 |
| idx | 16 | 18 | 19 | 20 | 21 | 22 | 24 | 26 | 27 | 28 | 29 | 30 |
| disLut[idx] | −8 | −8 | −8 | −4 | −4 | −2 | 0 | 2 | 4 | 4 | 8 | 8 |

$$weightIdx = ( ( ( xL + offsetX ) << 1 ) + 1 ) ⋆ disLut [ displacementX ] + ( ( ( yL + offsetY ) << 1 ) + 1 ) ⋆ disLust [ displacementY ] ,$$

$$weightIdxL = partFlip ? 32 + weightIdx : 32 - weightIdx ,$$

$$wValue = Clip 3 ( 0 , 8 , ( weightIdxL + 4 ) >> 3 ) ,$$

The prediction sample values pbSamples[x][y] are derived as follows:

$$pbSamples [ x ] [ y ] = C lip 3 ( 0 , ( 1 << BitDepth ) - 1 , ( predSamplesLA [ x ] [ y ] * wValue + predSamplesLB [ x ] [ y ] ⋆ ( 8 - wValue ) + offset 1 ) >> shift 1 ) .$$

It is to be noted that a weight value is derived for each position of the current block, and then one prediction value pbSamples[x][y] of the GPM is calculated. Due to this manner, the weight w Value does not have to be written in the form of a matrix, but it is to be understood that if the wValue of each position is stored in a matrix, then the matrix is a weight matrix. The manner that the weight of each point is calculated separately and weighted to obtain the prediction values of the GPM has a principle same as the manner that all the weights are calculated and then uniformly weighted to obtain the prediction sample matrix of the GPM. The usage of the weight matrix in many descriptions in the present disclosure is to make the expression easier to understand, and to make the drawing with the weight matrix more intuitive. In fact, the weight of each position may also be used to describe. For example, the weight matrix derivation mode may also be described to be the weight derivation mode.

In some embodiments, as shown in FIG. 6B, the decoding flow of GPM may be expressed as follows. The bitstream is parsed to determine whether the GPM technology is used for the current block; if the GPM technology is used for the current block, the weight derivation mode (or partitioning mode or weight matrix derivation mode), and the first motion information and the second motion information are determined; a first prediction block is determined according to the first motion information, and a second prediction block is determined according to the second motion information; a weight matrix is determined according to the weight matrix derivation mode; and a prediction block of the current block is determined according to the first prediction block, the second prediction block and the weight matrix.

In some embodiments, a gradient of the GPM weights is fixed. In some embodiments, the gradient of the GPM weights is variable, and the GPM variable weight gradient enables that the gradient of the weight change is adjusted to obtain blending areas with different widths of the GPM under the condition that a partitioning line angle and a partitioning line offset are the same for the weight change. FIG. 6C and FIG. 6D are compared, FIG. 6C is a schematic diagram of a blending area of the GPM in the VVC, and FIG. 6D is an example of a GPM variable weight gradient.

One implementation method of the GPM variable weight gradient is that a flag is transmitted in the bitstream, which is referred to the weight gradient index gpm_blending_idx herein. When the decoder calculates the weights, the decoder derives the weights according to the parsed weight gradient index. A possible method is that, taking the process of deriving the weights in the VVC as an example, the weightIdx is multiplied by a weight gradient parameter blendingCoeff, as shown below. A value of the blendingCoeff may be ¼, ½, 1, 2, 4, etc., and the blendingCoeff may be derived by a blending gradient index gpm_blending_idx.

$$\begin{matrix}… \\ weightIdx = \begin{matrix}( ( ( xL + offsetX ) << 1 ) + 1 ) ⋆ disLust [ displacementX ] + \\ ( ( ( yL + offsetY ) << 1 ) + 1 ) ⋆ disLust [ displacementY ]\end{matrix} \\ weightIdx = weightIdx ⋆ blendingCoeff \\ weightIdxL = partFlip ? 32 + weightIdx : 32 - weightIdx \\ wValue = Clip 3 ( 0 , 8 , ( weightIdxL + 4 ) >> 3 ) \\ …\end{matrix}$$

Of course, instead of transmitting the weight gradient index in the bitstream, the weight gradient index gpm_blending_idx or the blendingCoeff may be directly derived according to a block size, etc. In this way, although there is no such weight gradient index in the bitstream, it is may also be considered that the weight gradient parameter is determined in the derivation process.

The intra prediction is introduced below.

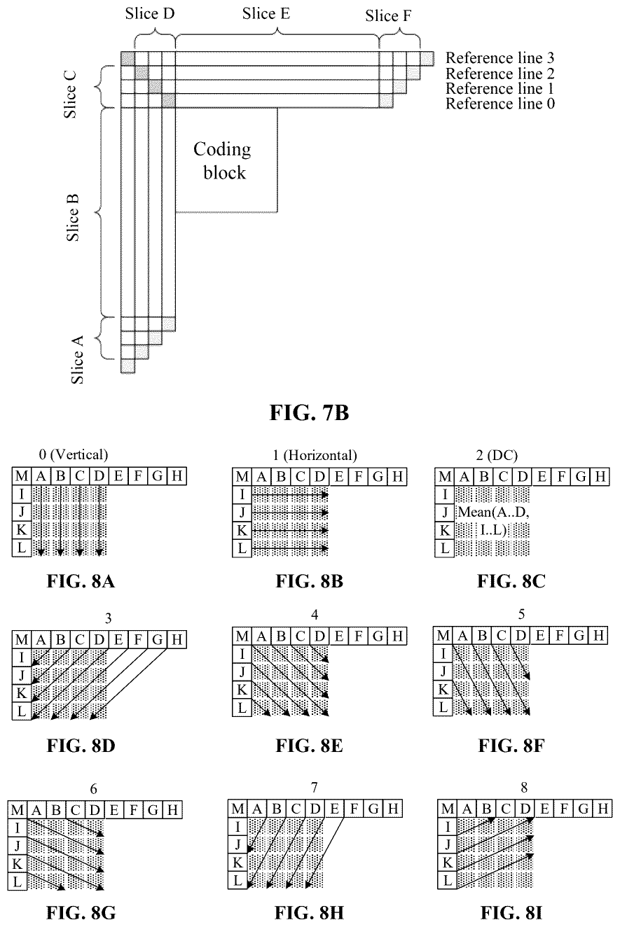

In the intra prediction method, reconstructed samples that have been encoded or decoded around the current block are used as reference samples to predict the current block. FIG. 7A is a schematic diagram of intra prediction. As shown in FIG. 7A, the current block has a size of 4×4, and the samples in the left column and the top row of the current block are reference samples of the current block, and these reference samples are used to predict the current block in the intra prediction. These reference samples may already be all available, i.e. all have been encoded or decoded. Alternatively, a part of the samples may be not available, for example, if the current block is located at the leftmost of the entire picture, then the reference samples on the left of the current block are not available. Alternatively, when the current block is encoded or decoded, the bottom left portion of the current block have not been encoded or decoded, so the reference samples at the bottom left are not available. In the case where the reference sample is not available, the positions of the unavailable reference samples may be padded with available reference samples, certain values or padded by certain methods, or may not be padded.

FIG. 7B is a schematic diagram of intra prediction. As shown in FIG. 7B, in a Multiple Reference Line (MRL) intra prediction method, more reference samples may be used to improve encoding and decoding efficiency, for example, samples of four reference rows/columns are used as reference samples of the current block.

Furthermore, the intra prediction has multiple prediction modes, and FIG. 8A to FIG. 8I are schematic diagrams of intra prediction. As shown in FIG. 8A to FIG. 8I, in H.264, the intra prediction performed on 4×4 block may mainly include nine modes. In the mode 0 as shown in FIG. 8A, the samples above the current block are copied along the vertical direction to the current block to be used as the prediction values. In the mode 1 as shown in FIG. 8B, the reference samples on the left are copied along the horizontal direction to the current block to be used as the prediction values. In the mode 2 as shown in FIG. 8C, i.e., the DC mode, the average of eight points A to D and I to L is used as the prediction value of all points. In the modes 3 to 8 as shown in FIG. 8D to FIG. 8I, the reference samples are copied according to a certain angle to the corresponding positions of the current block. Since some positions in the current block may not correspond exactly to the reference sample, the weighted average of the reference samples or the fractional-pixel of the reference sample obtained by the interpolation may be used.

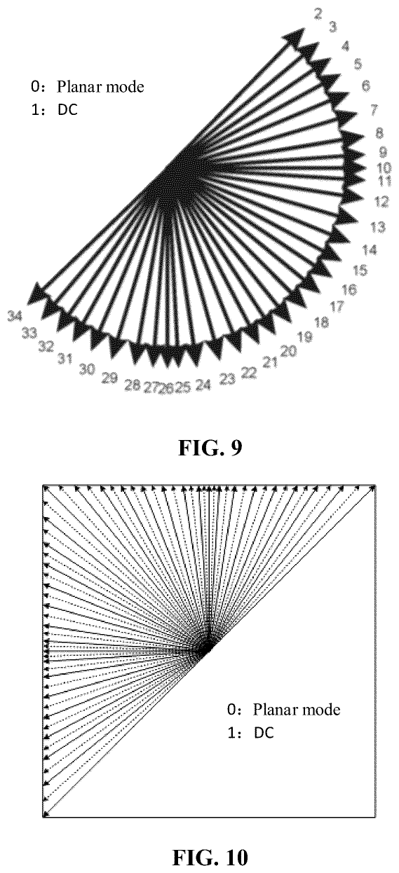

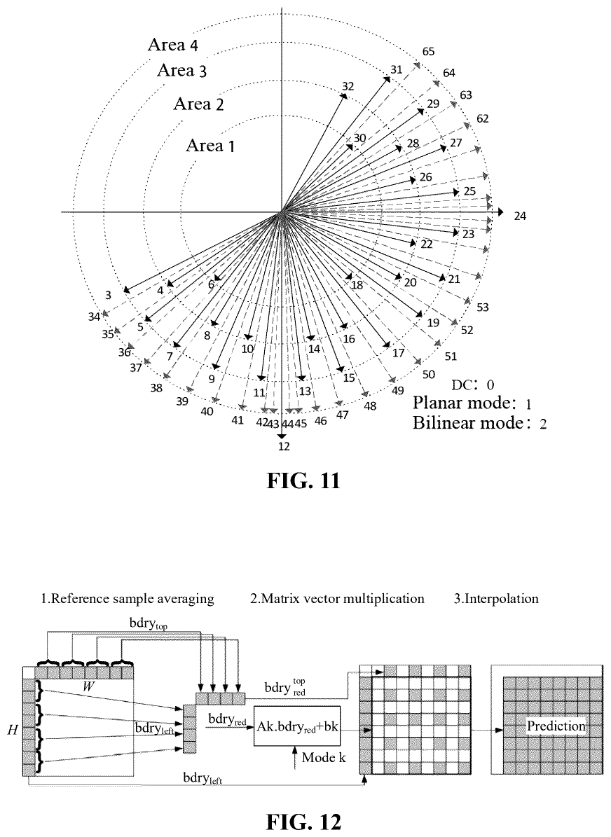

In addition, there are the plane mode, planar mode, etc., and with the development of technology and the expansion of blocks, there are more and more angular prediction modes. FIG. 9 is a schematic diagram of intra prediction modes. As shown in FIG. 9, the intra prediction modes used in the HEVC include 35 prediction modes, including the planar mode, the DC mode, and 33 angular modes. FIG. 10 is a schematic diagram of intra prediction modes. As shown in FIG. 10, the intra modes used in the VVC include 67 prediction modes including the planar mode, the DC mode, and 65 angular modes. FIG. 11 is a schematic diagram of intra prediction modes. As shown in FIG. 11, 66 prediction modes are used in the VS3 and include the DC mode, the plane mode, the bilinear mode, the PCM mode, and 62 angular modes.

In addition, there are some technologies to improve the prediction, such as, the fractional-pixel interpolation for improving the reference samples, filtering the samples to be predicted, etc. For example, in the Multiple Intra Prediction Filter (MIPF) in the AVS3, different filters are used for different block sizes to generate prediction values. For samples at different positions within the same block, one filter is used for generating prediction values for samples closer to the reference sample, and another filter is used for generating prediction values for samples farther from the reference sample. Technologies for filtering samples to be predicted may be, such as, Intra Prediction Filter (IPF) in the AVS3, and reference samples may be used for filtering prediction values.

In the intra prediction, the Most Probable Modes (MPM) List that is an intra mode encoding technology may be used to improve encoding and decoding efficiency. One mode list may be constituted by an intra prediction mode by using the surrounding blocks that have been encoded or decoded, an intra prediction mode derived according to the intra prediction mode of the surrounding blocks that have been encoded or decoded, such as, the adjacent mode, and some intra prediction modes commonly used or with relatively high probability of use, such as the DC mode, the planar mode, the bilinear mode, etc. The intra prediction mode referring to surrounding blocks that have been encoded or decoded takes advantage of spatial association. Since textures have certain continuity with each other in space, the MPM may be used for predicting the intra prediction mode. That is to say, it is considered that the probability of using MPM is higher than the probability of not using MPM for the current block. Therefore, in the binarization, fewer codewords may be used for the MPM, thereby saving overhead and improving encoding and decoding efficiency.

In some embodiments, the Matrix-based Intra Prediction (MIP) may be used, which may be also written as Matrix weighted Intra Prediction, to perform the intra prediction. As shown in FIG. 12, in order to predict a block with a width of W and a height of H, H reconstructed samples in the left column of the current block and W reconstructed samples in a top row of the current block are required to be used as inputs in the MIP. Prediction blocks are generated in the MIP by the following three operations: the reference sample averaging, the matrix vector multiplication, and the interpolation. The matrix vector multiplication is the core of the MIP. The MIP may be considered as a process of generating prediction blocks by using input samples (reference samples) in a manner of the matrix vector multiplication. Many matrices are provided in the MIP, and the difference between the prediction methods is reflected in the difference between the matrices. For the same input samples, different results may be obtained by using different matrices. The processes of the reference sample averaging and the interpolation are designs for the compromise between performance and complexity. For a block having a large size, an effect similar to downsampling may be achieved by the reference sample averaging, so that the input may be adapted to a small matrix, and the interpolation achieves an upsampling effect. In this way, it is not necessary to provide matrices of MIP for blocks having various sizes, but only one matrix or several matrices having specific sizes may be provided. With the increasing demand for compression performance and the improvement of hardware capabilities, MIP with higher complexity may appear in the next generation standard.

The MIP is somewhat similar to the planar mode, but obviously, the MIP is more complex and flexible than the planar mode.

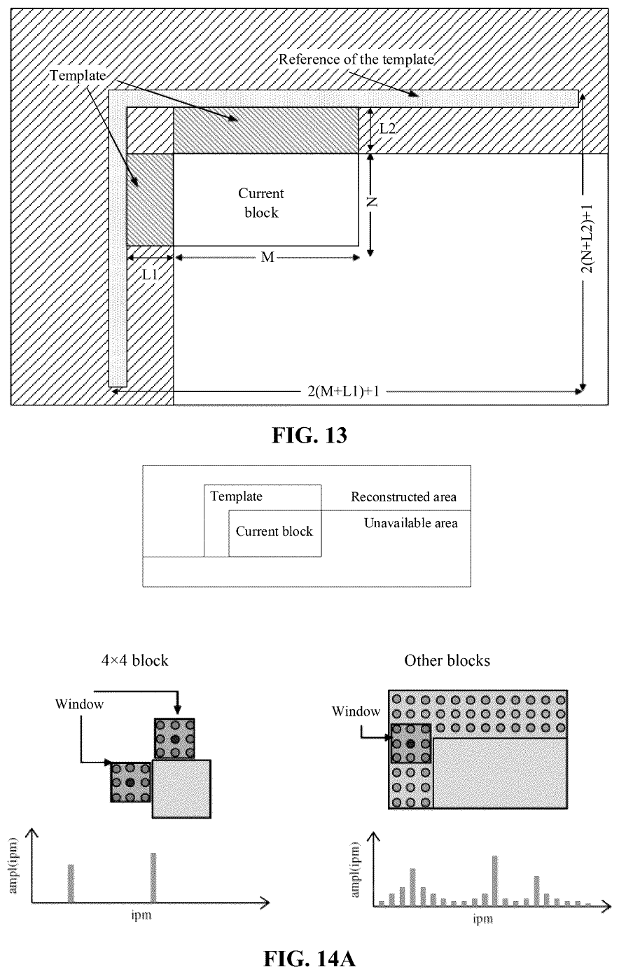

In some embodiments, an intra prediction technology utilizing Template-based Intra Mode Derivation (TIMD) may be used. Exemplarily, as shown in FIG. 13, a left area and top area of the current block are used as a template. Except for the boundary case, when the current block is encoded or decoded, reconstructed values for the left area and top area of the current block may be theoretically obtained, which is the basis of numerous template adaptation methods. In the TIMD, the left area and top area of the current block shown in FIG. 13 is taken as the template, and samples of the left area and top area of the template are taken as reference samples of the template. The decoder may use a certain intra prediction mode to predict on the template, and compare the prediction values with the reconstructed values to obtain a cost of the intra prediction mode on the template, such as, Sum of Absolute Differences (SAD), Sum of Absolute Transformed Differences (SATD), Sum of Squared Errors (SSE), etc. Since the template is adjacent to the current block, they are associated, so that performance of a prediction mode on the current block may be estimated by performance of the prediction mode on the template. In the TIMD, some candidate intra prediction modes are predicted on the template to obtain their costs on the template, and one or two intra prediction modes with the smallest cost may be selected as the intra prediction value of the current block.

It is found in the study that if the difference between costs of two intra prediction modes on the template is not large, a weighted averaging may be performed on prediction values obtained by the two intra prediction modes to improve the compression performance. The weights of the prediction values obtained by the two prediction modes are associated with the costs described above, and in some embodiments, this weights are inversely proportional to the costs.

In general, in the TIMD, the intra prediction modes are screened by using the prediction effects of the intra prediction modes on the template, and the two intra prediction modes may be weighted according to the costs on the template. The advantage of TIMD is that if the current block selects the TIMD mode, it does not need to indicate which intra prediction mode is used, but the intra prediction mode to be used is derived by the decoder itself through the above process, which saves overhead to a certain extent.

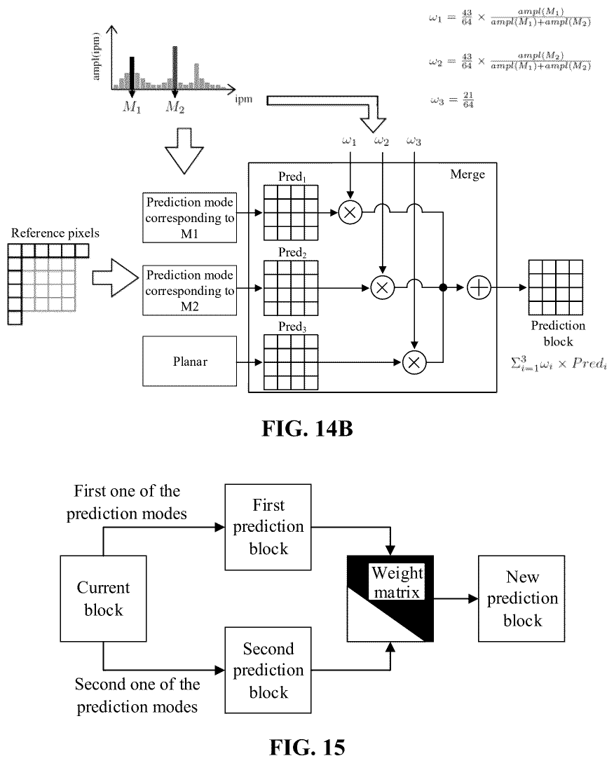

In some embodiments, an intra prediction technology utilizing Decoder-side Intra Mode Derivation (DIMD) may be used. In the DIMD, reconstructed samples for the left area and top area of the current block may also be used to derive the prediction mode, but instead of predicting on the template, the gradient of the reconstructed samples is analyzed. As shown in FIG. 14A, in the DIMD, the gradient of the window center point is analyzed, an intra prediction mode is adapted according to the gradient, and all the points to be checked are analyzed to obtain a result similar to the histogram in FIG. 14A. Of course, the so-called histogram is only to help understanding, and the specific implementation may be implemented in many simple forms. In some embodiments, in the DIMD, two intra prediction modes that are the highest in the histogram are selected, and the planar mode is added to obtain total 3 intra prediction modes, then prediction values obtained by the three intra prediction modes are weighted, and the weights are associated with the analysis results.

In an example, the prediction process of the DIMD is as shown in FIG. 14B, and the two intra prediction modes that are the highest in the histogram, i.e., the intra prediction modes respectively corresponding to M1 and M2, are selected, and the planar mode is added to obtain total 3 intra prediction modes. The weights @1, 2, and @3 respectively corresponding to the three intra prediction modes are determined, and the prediction values Pred1, Pred2, and Pred3 respectively corresponding to the three intra prediction modes are determined. Based on the weights respectively corresponding to the three intra prediction modes, the prediction values corresponding to the three intra prediction modes are weighted to obtain a final prediction block.

It may be seen from the foregoing that, in the DIMD, intra prediction modes are screened by using by using gradient analysis for the reconstructed samples, and two intra prediction modes and the planar mode may be weighted according to the analysis result. The advantage of DIMD is that if the current block selects the DIMD mode, it does not need to indicate which intra prediction mode is used, but the intra prediction mode to be used is derived by the decoder itself through the above process, which saves overhead to a certain extent.

There are many similarities between the TIMD and DIMD, even in some embodiments, their names are used interchangeably. They both support weighting the prediction values obtained by 2 or more intra prediction modes.

Two inter prediction blocks are combined by using a weight matrix in the GPM, which may be indeed extended to combine two arbitrary prediction blocks, such as, two inter prediction blocks, two intra prediction blocks, one inter prediction block and one intra prediction block. Even in screen content encoding, prediction blocks of Intra Block Copy (IBC) or palette may be used as one or two of the arbitrary prediction blocks.

In the present disclosure, intra, inter, IBC, and palette are referred to as different prediction manners. For the convenience of description, an expression of the prediction mode is used herein. The prediction mode may be understood as that the codec may generate information of a prediction block of the current block according to the prediction mode. For example, in the intra prediction, the prediction mode may be a certain intra prediction mode, such as, the DC mode, the planar mode, various angular intra prediction modes, etc. Of course, one or some pieces of auxiliary information may also be superimposed, such as, the optimization method for intra reference samples, the optimization method (such as filtering) after a preliminary prediction block is generated, etc. For example, in the inter prediction, the prediction mode may be a skip mode, a merge mode, or a Merge with Motion Vector Difference (MMVD) mode, or an Advanced Motion Vector Prediction (AMVP). The inter prediction may be unidirectional prediction, bi-directional prediction or multi-hypothesis prediction. If the inter prediction mode uses the unidirectional prediction, one prediction mode may be able to determine a piece of motion information, and a prediction block may be determined based on the piece of motion information. If the inter prediction mode uses the bi-directional prediction, one prediction mode may be able to determine two pieces of motion information, and a prediction block may be determined based on the two pieces of motion information.

In this way, the information required to be determined in the GPM may be expressed as one weight derivation mode and two prediction modes. The weight derivation mode is used for determining the weight matrix or weight, and each of the two prediction modes determines a prediction block or prediction value. The weight derivation mode is also referred to as a partitioning mode in some cases, which is referred to as the weight derivation mode in the present disclosure since it is a simulation partitioning.

Optionally, the two prediction modes may be from the same or different prediction manners, and the prediction manners include, but are not limited to, the intra prediction, the inter prediction, the IBC, and the palette.

A specific example is as follows. If the GPM is used for the current block, this example is used in inter-encoded blocks, and the merge mode in the intra prediction and the inter prediction are allowed to be used. As shown in Table 4, a syntax element intra_mode_idx is added to indicate which prediction mode is the intra prediction mode. For example, the intra_mode_idx being 0 indicates that both prediction modes are the inter prediction modes, i.e., mode0IsInter is 1 and mode0IsInter is 1; intra_mode_idx being 1 indicates that the first one of the prediction modes is the intra prediction mode and the second one of the prediction modes is the inter prediction mode, i.e., mode0IsInter is 0 and mode0IsInter is 1; intra_mode_idx being 2 indicates that the first one of the prediction modes is the inter prediction mode and the second one of the prediction modes is the intra prediction mode, i.e., mode0IsInter is 1 and mode0IsInter is 0; intra_mode_idx being 3 indicates that both prediction modes are the intra prediction modes, i.e., mode0IsInter is 0 and mode0IsInter is 0.

TABLE 4

| | |
|---|---|
| { | |
| merge_gpm_partition_idx[x0][y0] | ae(v) |
| intra_mode_idx[x0][y0] | ae(v) |
| if( mode0IsInter ) | |
| merge_gpm_idx0[x0][y0] | ae(v) |
| if( (!mode0IsInter && mode1IsInter) ∥ | |
| (MaxNumGpmMergeCand > 2 && mode0IsInter && | |
| mode1IsInter)) | |
| merge_gpm_idx1[x0][y0] | ae(v) |
| } | |

In some embodiments, as shown in FIG. 15, the decoding flow of the GPM may be expressed as: parsing the bitstream to determine whether the GPM technology is used for the current block; if the GPM technology is used for the current block, the weight derivation mode (or partitioning mode or weight matrix derivation mode), the first one of the prediction modes and the second one of the prediction modes are determined; a first prediction block is determined according to the first one of the prediction modes, a second prediction block is determined according to the second one of the prediction modes, and a weight matrix is determined according to the weight matrix derivation mode; and a prediction block of the current block is determined according to the first prediction block, the second prediction block and the weight matrix.

Template matching is introduced below.

The method of the template matching was firstly used in the inter prediction. In the template matching, some areas around the current block are used as the template by using the association between adjacent samples. When the current block is encoded or decoded, the left area and top area of the current block have been encoded or decoded according to the encoding sequence. Of course, in a case of the implementation of the existing hardware decoder, it may not be guaranteed that the left area and top area of the current block have been decoded when the decoding of the current block starts. Of course, herein the current block is an inter block. For example, in the HEVC, the surrounding reconstructed samples are not required for the inter-encoded block when a prediction block is generated, so the prediction processes of the inter blocks may be performed in parallel. However, for an intra-encoded block, the reconstructed samples on the left area and top area of the intra-encoded block must be required to be used as reference samples. Theoretically, the left area and top area are available, i.e., which may be implement by performing corresponding adjustments to the hardware design. Relatively speaking, the right area and bottom area are not available under the encoding sequence in the current standards, such as, the VVC.

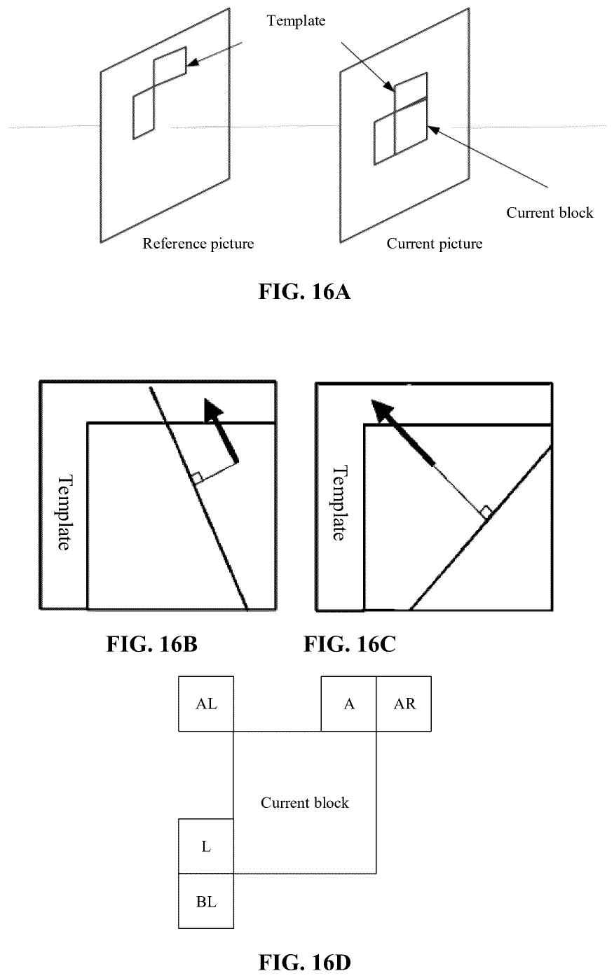

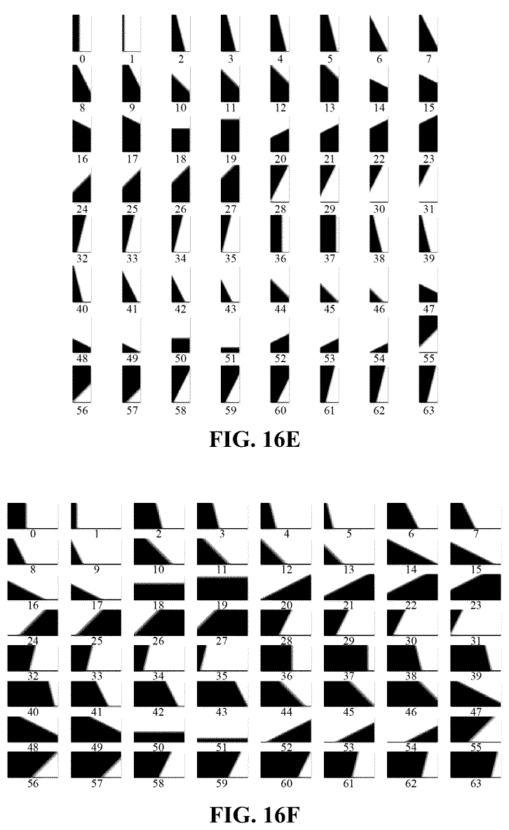

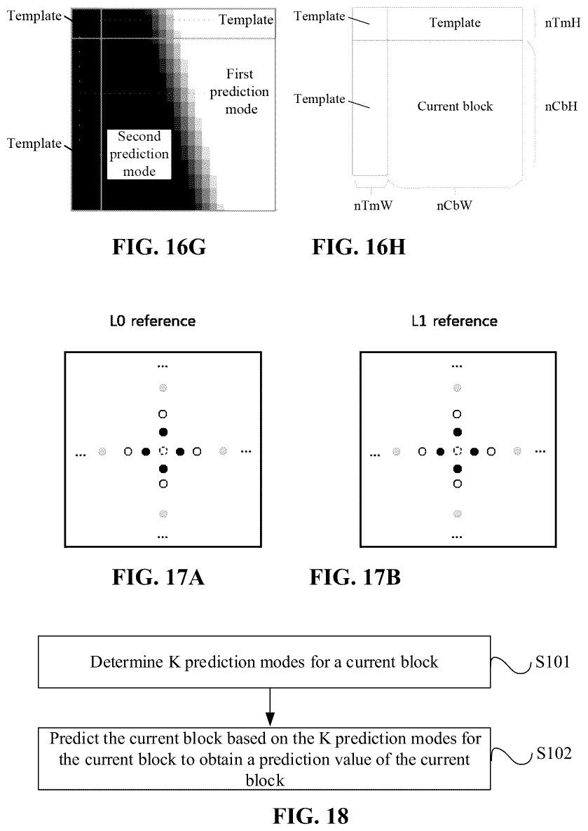

As shown in FIG. 16A, the rectangular areas on the left and top of the current block are set as the template, and the height of the left template portion is generally the same as the height of the current block, and the width of the top template portion is generally the same as the width of the current block. However, of course, the height of the left template portion may be different from the height of the current block, and the width of the top template portion may be different from the width of the current block. The optimal matching position of the template is found in the reference picture to determine the motion information or motion vector of the current block. This process may be roughly described as: starting from a starting position in a certain reference picture and search within a certain surrounding range. Search rules may be set in advance, such as, search range, search step, etc. Every time moving to a position, the matching degree between the template corresponding to the position and the template surrounding the current block is calculated. The matching degree may be measured by some distortion costs, such as, the sum of absolute difference (SAD), the sum of absolute transformed difference (SATD) where the generally used transform is the Hadamard transform, Mean-Square Error (MSE), etc. The smaller the value of SAD, SATD, MSE, etc. represents a higher matching degree. The cost is calculated by using the prediction block of the template corresponding to the position and the reconstructed block of the template surrounding the current block. In addition to the search at the integer-pixel positions, the search at the fractional-pixel positions may be performed, and the motion information of the current block may be determined according to the the position with the highest matching degree found during the search. By using the association between adjacent samples, the motion information appropriate for the template may also be the motion information appropriate for the current block. Of course, the template matching method may not be applicable to all blocks, so some methods may be used for determining whether the above template matching method is used for the current block. For example, a control switch is used for indicating whether the template matching method is used for the current block. This template matching method has a name of decoder side motion vector derivation (DMVD). Both the encoder and the decoder may use the template to search, to derive motion information or find better motion information on the basis of the original motion information. In the DMVD, specific motion vectors or motion vector differences are not required to be transmitted, but both the encoder and the decoder search according to the same rules to ensure the consistency of encoding and decoding. The compression performance can be improved by the template matching method, but the “searching” is also required in the decoder, which causes certain decoder complexity.

The template matching method being applied on inter prediction is described above, and the template matching method may also be used on intra prediction. For example, an intra prediction mode is determined by using the template. For the current block, the top area and left area within a certain range of the current block may also be used as the template, such as, the left rectangular area and the top rectangular area still as shown in the above figure. Reconstructed samples of the template are available when the current block is encoded or decoded. This process may be roughly described as: determining a set of candidate intra prediction modes for the current block, and the candidate intra prediction modes constituting a subset of all available intra prediction modes. Of course, the candidate intra prediction modes may be a complete set of all available intra prediction modes. which may be determined based on the balance between the performance and complexity. The set of candidate intra prediction modes may be determined according to MPM or some rules, such as, uniformly spaced selection, etc. A cost of each candidate intra prediction mode on the template is calculated, such as, the SAD, the SATD, the MSE, etc. A mode is used for predicting the template to make a prediction block, and a cost of the mode is calculated by using the prediction block and the reconstructed block of the template. A mode with small cost may be better matched with the template, and by using the similarity between adjacent samples, the intra prediction mode that performs well on the template may also be the intra prediction mode that performs well on the current block. One or several modes with low cost are selected. Of course, the above two steps may be repeated, for example, after one or several modes with low cost are selected, the set of candidate intra prediction modes is determined again, the costs are calculated for the newly determined set of candidate intra prediction modes, and then one or several modes with low cost are selected. The above process may also be understood as rough selection and fine selection. One finally selected intra prediction mode is determined as the intra prediction mode for the current block, or several finally selected intra prediction modes are selected as candidates for the intra prediction mode of the current block. Of course, the template matching method may only be used for ranking the candidate intra prediction modes in the set of the candidate intra prediction modes, such as, performing the ranking on the MPM list. That is to say, prediction blocks on the template are made by respectively using the modes in the MPM list and costs are determined, and the modes in the MPM list are sorted in ascending order of costs. Generally, earlier positions in the MPM list require fewer overhead of the bitstream, which can also achieve the purpose of improving the compression efficiency.

The template matching method may be used for determining the two prediction modes of the GPM. If the template matching method is used for the GPM, one control switch may be used for controlling whether the template matching is used for the two prediction modes for the current block for the current block, or two control switches may respectively be used for controlling whether the template matching is used for each of the two prediction modes.

The other aspect is how to use the template matching. For example, if the GPM is used in the merge mode, such as, the GPM in the VVC, then merge_gpm_idxX is used for determining a piece of motion information from the mergeCandList, where the capital X is 0 or 1. For the X-th piece of motion information, one method is that optimization is performed by using the template matching method on the basis of the above motion information. That is to say, a piece of motion information is determined from the mergeCandList according to merge_gpm_idxX, and if the template matching is used for the motion information, then the template matching method is used for performing the optimization on the basis of the motion information. Another method is that the merge_gpm_idxX is not used determining a piece of motion information from the mergeCandList, but searching is directly performed on the basis of a piece of default motion information, to determine a piece of motion information.

If the X-th prediction mode is an intra prediction mode, and the template matching method is used for the X-th prediction mode for the current block, then one intra prediction mode may be determined by using the template matching method, and an index of the intra prediction mode is not required to be indicated in the bitstream. Alternatively, the template matching method is used for determining a set of candidates or an MPM list, in this case, index of the intra prediction mode is required to be indicated in the bitstream.

In a GPM with intra-inter prediction method, the prediction value of the GPM is obtained by weighting an intra prediction value and an inter prediction value with the weights of the GPM mode. The derivation method for the prediction mode information (motion information) of the inter prediction is similar to the derivation method in the VVC standard, for the prediction mode of the intra prediction, a list of intra prediction mode candidates is required to be constructed for the corresponding part of the GPM mode, and the list may also be referred to as an MPM list. The encoder writes the index of selected the intra prediction mode for the current block into the bitstream, and the decoder uses the same method to construct the MPM list for the GPM mode during decoding, and determines the intra prediction mode according to the index of the intra prediction mode obtained by decoding. Exemplary, the corresponding portion of the GPM mode may be understood as the white portion or the black portion in the partitioning diagram of FIG. 4 or FIG. 5, which may be referred to as a first portion and a second portion later for convenience of expression. An example is that the first portion is the white portion and the second portion is a black portion. The first portion corresponds to the first one of the prediction modes and the second portion corresponds to the second one of the prediction modes. The first portion and second portion are more intuitive and easy to understand, but in practice, which may not appear in specific algorithms.

When the MPM list of intra prediction modes of the corresponding part of the weight derivation mode of the GPM is constructed, several preset types of intra prediction modes are sequentially added into the MPM list until the length of the list reaches 3. Optionally, the preset types of intra prediction modes include: an intra prediction mode parallel to the GPM partitioning line, an intra prediction mode derived by the DIMD, an intra prediction mode derived by the TIMD, intra prediction modes for neighbouring blocks, an intra prediction mode perpendicular to the GPM partitioning line, and the planar mode.

The intra prediction mode parallel to the GPM partitioning line is shown in FIG. 16B, and the intra prediction mode perpendicular to the GPM partitioning line is shown in FIG. 16C. At present, the specific implementation is that the partition angle index angleIdx of the GPM is determined according to the weight derivation mode of the GPM; a look-up table indicating correspondences between the angleIdx and the intra prediction modes is constructed; and the intra prediction mode parallel to the GPM partition line is determined from the look-up table according to the angleIdx. The intra prediction mode perpendicular to the GPM partitioning line is calculated by using the intra prediction mode parallel to the GPM partitioning line.

When the intra prediction modes of neighbouring blocks are used, intra prediction modes of up to five neighbouring blocks are used, and the positions of the five neighbouring blocks are shown in FIG. 16D. The coordinates of the top-left of the current block are denoted as (x0, y0), the width of the current block is denoted as width, the height of the current block is denoted as height, and the five neighbouring blocks are respectively: the neighbouring block AL determined by the coordinates (x0−1, y0−1), the neighbouring block A determined by (x0+width−1, y0−1), the neighbouring block AR determined by (x0+width, y0−1), the neighbouring block L determined by (x0−1, y0+height−1), and the neighbouring block BL determined by (x0−1, y0+height).

According to whether the intra prediction mode corresponds to the first portion or the second portion, and the angle index angleIdx corresponding to the weight derivation mode of the GPM, Table 5 is looked up to determine the range of available neighbouring blocks.

TABLE 5

| angleIdx | 0 | 2 | 3 | 4 | 5 | 8 | 11 | 12 | 13 | 14 |
|---|---|---|---|---|---|---|---|---|---|---|
| first portion | A | A | A | A | L + A | L + A | L + A | L + A | A | A |
| second portion | L + A | L + A | L + A | L | L | L | L | L + A | L + A | L + A |
| angleIdx | 16 | 18 | 19 | 20 | 21 | 24 | 27 | 28 | 29 | 30 |
| first portion | A | A | A | A | L + A | L + A | L + A | L + A | A | A |
| second portion | L + A | L + A | L + A | L | L | L | L | L + A | L + A | L + A |

In Table 5, A may be understood as a neighbouring block on the top of the current block, and L may be understood as a neighbouring block on the left of the current block. If A is obtained by looking up the Table 5, then the intra prediction mode of the neighbouring block A and the intra prediction mode of the neighbouring block AR may be used. If L is obtained by looking up the Table 5, then the intra prediction mode of the neighbouring block L and the intra prediction mode of the neighbouring block BL may be used. If L+A is obtained by looking up the Table 5, the intra prediction modes of the neighbouring blocks A, AR, L, and BL may be used. The prediction mode of the neighbouring block AL is always available. The checking sequence of the neighbouring blocks is L->A->BL->AR->AL.

It may be seen from the foregoing that, the GPM has three elements, one weight matrix and two prediction modes. The advantage of GPM is that more autonomous combinations may be achieved through the weight matrix. On the other hand, more information is required to be determined in the GPM, so more overhead is required to be paid in the bitstream. Take the GPM as an example, optionally, the GPM is used in the merge mode. The weight matrix, the first one of the prediction modes and the second one of the prediction modes are determined by using merge_gpm_partition_idx, merge_gpm_idx0, and merge_gpm_idx1 in the bitstream, respectively. There are multiple possible choices for each of the weight matrix and the two prediction modes. For example, there are 64 possible choices for the weight matrix in the VVC. Up to 6 possible choices are allowed for each of merge_gpm_idx0 and merge_gpm_idx1 in the VVC, of course, the VVC stipulates that the merge_gpm_idx0 is not duplicated with the merge_gpm_idx1. In this way, there are 65×6×5 possible choices for such a GPM. If the MMVD is used for the optimization for two pieces of motion information (prediction modes), more possible choices may be provided additionally. The number of the choices is quite huge. On the other hand, it may be found that the template matching method may also be used in the optimization for two pieces of motion information (prediction modes), which also provides more additional possible choices. Even in this method for optimizing two pieces of motion information (prediction modes) by the template matching, a block-level switch is required to indicate whether the template matching is used for the current block in view of the current state of technology evolution.

If two intra prediction modes are used in the GPM, each intra prediction mode may use 67 common intra prediction modes in the VVC, and the two intra prediction modes are different from each other, then there are 64×67×66 possible choices. Of course, in order to save overhead, each prediction mode may be limited to only use a subset of all common intra prediction modes, but there are still many possible choices.

If one intra prediction mode and one inter prediction mode are used in the GPM, the case of which may be inferred by analogy from the cases of the intra prediction mode and the inter prediction mode described above.

In some embodiments, the indication of the one weight derivation mode and two prediction modes of the GPM may be written in the bitstream or parsed from the bitstream by using their respective syntax elements. That is to say, the one weight derivation mode has its own one or more syntax elements, the first one of the prediction modes has its own one or more syntax elements, and the second one of the prediction modes has its own one or more syntax elements. Of course, the standard may limit that in some cases, the second one of the prediction modes cannot be the same as the first one of the prediction modes, or some optimization manners may be used for both two prediction modes (which may also be understood as being used for the current block), but the three are relatively independent from each other in writing syntax elements and parsing syntax elements. The relative independence may also be understood as having a certain association, but other possible choices after the limitation is removed are still independent.

For equiprobable events, the fixed-length coding is more appropriate. When event probabilities exhibit significant disparity, higher-probability events are assigned shorter codewords, while lower-probability events use longer codewords, which can improve the encoding efficiency. However, for two modes with different dimensions, i.e., the weight derivation mode and the prediction mode, probability estimations for them are separated from each other.

Since one weight derivation mode and two prediction modes together generate one prediction block, and this prediction block is used for the current block. The prediction block and the current block are related. Given a few examples as follows, for example, the current block includes edges of 2 objects in relative motion, which is an ideal scenario for the inter GPM. Then theoretically, the “partitioning” should occur at the edges of the objects, but in fact, there are limited possibilities for the “partitioning”, and it is impossible to cover any edge. Sometimes, a similar “partitioning” is selected, so there may be more than one similar “partitioning”, and which one similar “partitioning” to be selected depends on the combination of which “partitioning” and two prediction modes has the optimal result. Similarly, which prediction mode to be selected sometimes depends on which combination has the optimal result, because even in the part where this prediction mode is used, for natural video, this part is difficult to completely match with the current block, and the final selection may be the one having the highest encoding efficiency. Another case where the GPM is used more often is that the current block includes parts of an object that have relative motion, such as, distortion and deformation areas due to the swing of the arm, such “partitioning” is even more vague in this case, which may ultimately depend on which combination has the optimal result. Another scenario is the intra prediction. Because the texture of some parts of a natural picture is very complex, some parts have a gradual change from one texture to another texture, and some parts may not be expressed in a simple direction. In this scenario, intra GPM may provide more complex prediction blocks, and intra-encoded blocks usually have larger residuals compared to inter-encoded blocks under the same quantization. Which prediction mode is selected may ultimately depend on which combination has the optimal result.

“Combination” has been mentioned many times above, i.e., instead of selecting the weight derivation mode and the prediction mode in two or three dimensions, they may be combined and a combination of the weight derivation mode and the prediction mode may be selected, which is reflected in the syntax elements. That is to say, a syntax element of “combination” is used, according to the “combination”, the weight derivation mode and two prediction modes may be determined.

Exemplary, a syntax element called gpm_cand_idx may be set, as shown in Table 6.

TABLE 6

| | |
|---|---|
| if (conditions for using GPM for the current block are | |
| derived) { | |
| gpm_cand_idx[ x0 ][ y0 ] | ae(v) |
| } | |
| } | |

The gpm_cand_idx determines an index of the GPM candidate combination. The weight derivation mode and the two prediction modes are determined according to the gpm_cand_idx. An example is that: if the current block is an intra-encoded block (and is not applicable for the screen content encoding), then both two prediction modes are intra prediction modes. If the current block is an inter-encoded block, there may be more limitation on the application scenario. An example is that in this application scenario, two prediction modes may only be the inter prediction modes.

That is to say, the encoder may generate N candidate combinations being the same as N candidate combinations generated by the decoder. For example, each of the encoder and the decoder constructs a list of N candidate combinations, and each candidate combination may derive a combination of 1 weight derivation mode and 2 prediction modes. In the bitstream, the encoder only needs to write which candidate combination is finally selected, and the decoder parses to obtain which candidate combination is finally selected by the encoder. This list is referred to herein as a GPM combination candidate list or a candidate combination list.

In an example, in the GPM combination candidate list, the combinations are ranked roughly in descending order of their probability of being selected, then codewords shorter than the codewords of existing methods may be used for the candidate combinations that rank front. On the other hand, longer codewords are used for some combinations having low selection probability. In this way, the overall encoding efficiency is improved. Because there are three parts in the existing method, theoretically, the method of this scheme can achieve greater flexibility, and it is easier to approximate the most effective probability and codeword correspondence.

Of course, as mentioned foregoing, in some cases, the number of possible combinations in the GPM is quite large. Longer codewords are required in order to be able to characterize a large number of candidates. However, if some combinations having too low probability of occurrence may be excluded in advance, the cost of combinations having high probability of occurrence can be reduced. Of course, in the existing method, the cases where the probabilities of occurrences are too low may also be excluded according to each part, but the method of the combination is also more flexible. For example, if a kind of “partitioning” is expected to be excluded in the existing method, then all possibilities of this kind of “partitioning” are excluded.

Another benefit is that the syntax is simpler by using the method of the combination. Determination for various cases and the like are not required during parse.

For how to encode the gpm_cand_idx, as mentioned foregoing, the encoding is associated with probabilities of the candidates. An example is the usage of Exponential-Golomb coding. If the number of candidates is relatively small, i.e., it may be understood as that only a few modes having the highest probability may be selected, or the fixed-length code may be used. For example, there are only 16 candidates, and the bit-length encoding is used uniformly for the 16 candidates.

Different numbers of candidate combinations may be set for blocks having different sizes. For example, for smaller blocks, similar weight derivation modes or prediction modes have little difference in influence on the prediction result. However, for larger blocks, similar weight derivation modes or prediction modes have more obvious difference in influence on the prediction result. Therefore, one method is to set a small number of candidate combinations for the smaller block and a large number of candidate combinations for the larger block. The size of the block may be determined according to the width and height of the block or the number of pixels of the block. An example is to set the number of candidates to 8 for a block of which the number of pixels is less than (or less than or equal to) 256, and to set the number of candidates to 16 for a block of which the number of pixels is greater than or equal to (or greater than) 256.

A construction process of the GPM combination candidate list is introduced as follows.

In some embodiments, more related information may be used for analyzing the probabilities of occurrences of various combinations. For example, by using the mode information of surrounding blocks and reconstructed samples, etc.

One method is to construct the GPM combination candidate list with the help of the template.

In normal cases, the height of the top template is the same as the width of the left template, which may have a value of 1, 2, 4, etc. As an example, when the GPM combination candidate list is constructed with the help of the template, the calculation complexity may be appropriately reduced by using a top template having a height of 1 and/or a left template having a width of 1. It is to be noted that, herein, the height of the top template being 1 may be understood as that the top template of the current block includes a row of decoded or encoded samples of the top of the current block, and the width of the left template being 1 may be understood as that the left template of the current block includes a column of decoded or encoded samples of the left of the current block.

In the case of using the template, since the current block may use more related information, i.e., the reconstructed information surrounding the current block, the association between the above three elements may be better utilized. In other words, some cases of the current block are estimated by using the reconstructed information surrounding the current block.

One method is to use the GPM method to predict the template for each combination to obtain a prediction block of the template by this combination. Since the template has obtained the reconstructed value, the cost of prediction distortion may be calculated according to the prediction block of the template and the reconstructed block of the template by using this combination, such as the SAD, the SATD, the SSE, etc. Various combinations may be ranked according to the costs of prediction distortions, or a list that maintains only the top N combinations corresponding to the smallest costs of prediction distortions may be constructed. In this way, the GPM combination candidate list may be constructed.

In the above method, for a certain combination, the first prediction value of the template is generated by using the first one of the prediction modes, the second prediction value of the template is generated by using the second one of the prediction modes, to weights of pixel positions on the template by using the weight derivation mode, and then a prediction value of the template is determined according to the first prediction value and the second prediction value and the weights.

The decoder should use the GPM combination candidate list construction method being the same as the GPM combination candidate list construction method used by the encoder, to ensure the consistency of encoding and decoding. As mentioned foregoing, the number of all possible combinations of GPM may be quite large. The above method is an exhaustive method. In the specific implementation, a fast algorithm may be used for constructing the GPM combination candidate list, but the algorithm used by the encoder and decoder should be the same. For example, the hierarchical screening is performed on the various combinations, or some combinations having high probabilities that are inferred based on known information are checked in advance and some early termination conditions are set, etc.

In some embodiments, the blocks that are intra encoded and are blocks for which the screen content encoding is not applicable. Herein, this does not mean that this scheme cannot be used for the screen content encoded block, but only to explain this scheme with the simplest example, because only the intra prediction mode is required to be considered in the block that is intra encoded and not applicable for the screen content encoding, and the screen content encoding modes such as the IBC and the palette and various inter modes are not required to be considered. This scheme may be used in any case where the GPM is available, which has been described above.

Herein, it is assumed that there are 64 possible weight derivation modes in the GPM and 67 possible intra prediction modes in the GPM, which may be found from the standard of the VVC. However, the possible weights in the GPM are not limited to be only 64 kinds, or limited to be which 64 kinds. On the other hand, it needs to know that the reason why 64 kinds in the GPM is selected in the VVC is also a balance between improving the prediction effect and increasing the overhead in the bitstream. However, in this scheme, a fixed logic is no longer used for encoding the weight derivation mode, thus, this scheme theoretically may use more diverse weights and use the weights more flexibly. Similarly, intra prediction modes in the GPM are not limited to be only 67 kinds, or limited to be which 67 kinds. Theoretically, all possible intra prediction modes may be used in the GPM. For example, if the angular intra prediction modes are made finer and more angular intra prediction modes are generated, then the more angular intra prediction modes may be used in the GPM. For example, the matrix-based intra prediction (MIP) mode of the VVC may also be used in this scheme, but it is considered that there are many sub-modes of MIP that may be selected, and the MIP is not added into this embodiment for convenience of understanding. In addition, there are some wide-angle modes, which may also be used in this scheme, which is not described in this embodiment.

If the two intra prediction modes are not allowed to be the same, there are a total of 64*67*66 possible combinations in this embodiment. If an exhaustive method is used, all these possible combinations are used for predicting the template, and the distortion cost of each combination is calculated. It is not required to try for each intra prediction mode, because the MPM list of the current block may be obtained according to the prediction modes of the surrounding blocks. For example, in the VVC, an MPM list having a length of 6 may be obtained for the current block. In addition, in some subsequent technology evolutions, there is a secondary MPM scheme, which may derive an MPM list having a length of 22. In other words, the lengths of the first MPM list and the second MPM list add up to 22. In this scheme, it is possible to use the MPM to screen the intra prediction modes. Of course, an MPM list suitable for the GPM mode of the current block may also be constructed. For example, the prediction modes used by all blocks adjacent to the current block are added into the MPM list. For example, if the MPM list does not include special prediction modes such as the DC mode, the horizontal prediction mode or the vertical prediction mode, then one or more of the special prediction modes is added into the candidate intra prediction modes in this scheme. For example, an intra prediction mode associated with the partitioning line of the weight is added into the candidate intra prediction mode of this scheme. An example is that one or several angular intra prediction modes having prediction angles parallel or approximately parallel to the partitioning line are added into the candidate intra prediction modes in this scheme; and an example is that one or several angular intra prediction modes having prediction angles perpendicular or approximately perpendicular to the partitioning line are added into the candidate intra prediction modes in this scheme. Alternatively, the intra prediction mode candidate in this scheme may be determined according to the weight derivation mode. Alternatively, the intra prediction mode candidate in this scheme may be determined for each of the two intra prediction modes. In summary, at least one set/list of the GPM intra prediction mode candidates may be obtained. Of course, it is also possible to limit the total number of the prediction modes that can be used, to ensure the complexity of the decoding end, for example, the total number of the prediction modes that can be used is limited up to 6. The above methods may be used alone or in any combination.

For the weight derivation mode, of course, it is also possible to try every weight derivation mode. Of course, some weight derivation modes may be screened. One method is that because of the template to be used, a template is not used if the weight on the template derived by the weight derivation mode makes a certain prediction mode have little influence. For example, the mode 54 (the square block) in FIG. 4 above, it is conceivable that the second prediction mode has little influence on the template, or even it may be considered that it has no influence on the template at all. In this case, the second prediction mode has no influence at all. One may be that no such weight derivation mode is used for such block; and the other may be that such weight derivation mode is used for such block, but only the first prediction mode or the second prediction mode is fixedly used. It is necessary to know that the same weight derivation matrix of blocks having different shapes may have different influences for the two prediction modes. Reference may be made to FIG. 16E and FIG. 16F.

For the weight derivation mode, of course, some modes may be screened out to try. That is to say, a set of weight derivation modes may be used in this scheme, which is a subset of all weight derivation modes. For example, in the weight derivation mode, the same “partitioning” angle may correspond to multiple offsets, such as, the modes 10, 11, 12, and 13 in the above figure. These modes have the same “partitioning” angle, but have different offsets. Some modes corresponding to offsets may be removed in this scheme. Of course, some modes corresponding to “partitioning” angles may also be removed. In this way, the total number of possible combinations may be reduced. Moreover, difference between the possible combinations becomes more pronounced. Of course, different screening methods may be set for different block sizes. For example, fewer weight derivation modes are used for smaller blocks and more weight derivation modes are used for larger blocks. Different screening methods may also be set for different block shapes. One explanation of the block shape refers to the ratio of the width and the height.

Regarding how to implement this screening method, one method is to use a look up table. For example, the total number of possible weight derivation modes is 64, then a table with 64 elements is set, and a value of each element indicates whether to use its corresponding weight derivation mode. A specific example is as follows: an array of g_sgpm_splitDir is set, and the

```
g_sgpm_splitDir[64] = {
  1,1,1,0,1,0,1,0,
  1,0,1,0,1,0,1,0,
  1,0,1,1,1,0,1,0,
  1,0,1,0,1,0,1,0,
  0,0,0,0,1,1,0,1,
  0,0,1,0,0,1,0,0,
  1,0,1,1,0,1,0,0,
  1,0,0,1,0,0,1,0
  };
```

The g_sgpm_splitDir[x] having a value of 1 indicates that the weight derivation mode having the index of x may be used; and the g_sgpm_splitDir[x] having a value of 0 indicates that the weight derivation mode having the index of x may not be used. Different screening methods are used for different block sizes or block shapes, which may be implement by using multiple arrays or a two-dimensional array.

For each possible combination, the prediction value of the template may be obtained by using the possible combination. Since the template is predicted, the reference samples to be used in the intra prediction mode may be padded with samples in the top row and the left column of the template. Two prediction blocks are obtained by using two prediction modes respectively.

For the weights of the template, since the weights of the current block may be obtained according to the weight derivation mode, the weights of the template may be derived by the same method, but the positions where the same method is used are different, as illustrated in FIG. 16G.

An example of the derivation process of the template weights is shown below. A part of this example may be combined with a part of the derivation of predicted weights.

The inputs to this process are:
the width of the current block nCbW, and the height of the current block nCbH,
the width of left template nTmW, and the height of top template nTmH
the “partition” angle index variable of the GPM angleIdx,
the distance index variable of the GPM distanceIdx, and
the component index variable cIdx. Since only luma is used as an example in this example, cIdx is 0 in this example, which represents the luma component.

The output of this process is the template weight matrix wTemplate Value.

The variables nW, nH, shift1, offset1, displacementX, displacementY, partFlip and shiftHor are derived as follows:

$$n W = ( cIdx == 0 ) ? nCbW : nCbW ⋆ SubWidthC$$

$$nH = ( cIdx == 0 ) ? nCbH : nCbH ⋆ SubHeightC$$

$$shift 1 = Max ( 5 , 17 - BitDepth ) , where the BitDepth is a bit depth of the encoding and decoding ;$$

$$offset 1 = 1 << ( shift 1 - 1 )$$

$$displacementX = angleIdx$$

$$displacementY = ( angleIdx + 8 ) \% 32$$

$$partFlip = ( angleIdx >= 13 \&\& angleIdx <= 27 ) ? 0 : 1$$

$$shiftHor = ( angleIdx \% 16 == 8 \vert \vert ( angleIdx \% 16 != 0 \&\& nH >= nW ) ) ? 0 : 1$$

The variables offsetX and offsetY are derived as follows:
If shiftHor value is equal to 0:

$$offsetY = ( - nW ) >> 1$$

$$offsetY = ( ( - nH ) >> 1 ) + ( angleIdx < 16 ? ( distanceIdx ⋆ nH ) >> 3 : - ( ( distanceIdx ⋆ nH ) >> 3 ) )$$

otherwise (shiftHor is equal to 1):

$$offsetX = ( ( - nH ) >> 1 ) + ( angleIdx < 16 ? ( distanceIdx ⋆ nH ) >> 3 : - ( ( distanceIdx ⋆ nH ) >> 3 ) )$$

$$offsetY = ( - nW ) >> 1$$

The template weight matrix wTemplateValue[x][y] (where x=−nTmW . . . nCbW−1, y=−nTmH . . . nCbH−1, the case where both x and y are greater than or equal to 0 is removed, and it is noted that the coordinates of the top-left of the current block is (0, 0) in this example) is derived as follows.
The variables xL and yL are derived as follows:

$$x L = ( cIdx == 0 ) ? x : x ⋆ SubWidthC$$

$$yL = ( cIdx == 0 ) ? y : y ⋆ SubHeightC$$

Where disLut is determined according to Table 3.

$$weightIdx = ( ( ( xL + offsetX ) << 1 ) + 1 ) ⋆ disLut [ displacementX ] + ( ( ( yL + offsetY ) << 1 ) + 1 ⋆ disLut [ displacementY ]$$

$$weightIdxL = partFlip ? 32 + weightIdx : 32 - weightIdx$$

$$wTemplateValue [ x ] [ y ] = C lip 3 ( 0 , 8 , ( weightIdxL + 4 ) >> 3$$

In some embodiments, for the sake of simplicity of calculation, the template weights may also be set to only two possible values, i.e., 0 and 1.

An example would be as follows.

An example of the derivation process of template weights is shown below, similar to the foregoing description, except that weightIdxL=partFlip? 32+weightIdx: 32−weightIdx

$$wTemplateValue [ x ] [ y ] = C lip 3 ( 0 , 8 , ( weightIdxL + 4 ) >> 3 ) is replaced with$$

$$wTemplateValue [ x ] [ y ] = ( partFlip ? weightIdx : - weightIdx ) > 0 ? 1 : 0$$

Of course, some hierarchical screening ideas may also be used. For example, if a weight derivation mode may obtain a relatively small cost, then similar weight derivation modes are continued to be tried. On the contrary, if a weight derivation mode cannot obtain the relatively small cost, then similar weight derivation modes are not continued to be tried. For example, if an intra prediction mode may obtain the relatively small cost, then intra prediction modes similar to it are continued to be tried, and conversely, if an intra prediction mode cannot obtain the relatively small cost, then intra prediction modes similar to it are not continued to be tried. Of course, these screening methods may be limited to the case where the weight derivation mode is used in combination with the other two elements. For example, under a certain weight derivation mode, a certain intra prediction mode that is used as the first prediction mode cannot obtain a relatively small cost, and then the cases where intra prediction modes similar to the intra prediction mode used as the first prediction mode under the weight derivation mode are not tried.

A cost of a certain combination is obtained, various combinations are ranked in ascending order of costs, and finally N candidate combinations are selected. Alternatively, only a list of N candidate combinations is maintained. One possible case is that N is 8, 16 or 32, etc.

As mentioned above, for each combination, the template is predicted by the GPM method to obtain the prediction block of the template by the combination. Since the template has obtained the reconstructed value, the cost of prediction distortion may be calculated according to the prediction block of the template and the reconstructed block of the template by using this combination, such as the SAD, the SATD, the SSE, etc. A cost of a combination for the template is expected. When this cost is calculated, the fast algorithm may also be used. In this fast algorithm, it is not use the GPM method to firstly combine the prediction blocks obtained by the two prediction modes to obtain a GPM weighted prediction block, and then this GPM weighted prediction block and the reconstructed block of the template are not used for calculating the cost of prediction distortion.

As mentioned above, the weights on the template may be simplified to only two possibilities of 0 and 1, and then, for each pixel position, its sample value only comes from the prediction block of the first prediction mode or the prediction block of the second prediction mode. Therefore, for a prediction mode, it is possible to calculate the cost on the template when the prediction mode is used as the first prediction mode under a certain weight derivation mode, i.e., only the cost generated by a part of samples having a weight of 1 on the template when the prediction mode is used as the first prediction mode under the weight derivation mode is calculated. An example is to denote the cost as cost [pred_mode_idx][gpm_idx][0], where the pred_mode_idx represents the index of the prediction mode, the gpm_idx represents the index of the weight derivation mode, and 0 represents as the first prediction mode.

And for the prediction mode, it is possible to calculate the cost on the template when the prediction mode is used as the second prediction mode under a certain weight derivation mode, i.e., only the cost generated by a part of samples having the weight of 1 on the template when the prediction mode is used as the second prediction mode under the weight derivation mode is calculated. An example is to denote the cost as cost [pred_mode_idx][gpm_idx][1], where the pred_mode_idx represents the index of the prediction mode, the gpm_idx represents the index of the weight derivation mode, and 1 represents as the second prediction mode.

Then when the cost of a combination is calculated, the corresponding above two costs may be directly added. For example, as follows, the cost of prediction modes pred_mode_idx0 and pred_mode_idx1 under the weight derivation mode gpm_idx is required to be calculated, where pred_mode_idx0 represents as the first prediction mode and the pred_mode_idx1 represents as the second prediction mode. Then this cost is denoted as costTemp, then costTemp=cost [pred_mode_idx0][gpm_idx][0]+cost [pred_mode_idx1][gpm_idx][1]. If it is the cost of prediction modes pred_mode_idx0 and pred_mode_idx1 under the weight derivation mode gpm_idx is required to be calculated, where the pred_mode_idx1 is as the first prediction mode and the pred_mode_idx0 is as the second prediction mode, then this cost is denoted as costTemp, and costTemp=cost [pred_mode_idx1][gpm_idx][0]+cost [pred_mode_idx0][gpm_idx][1].

One advantage of this is that the weighting is firstly performed to combine into a prediction block and then the cost is calculated, which is simplified to directly calculating the costs of the two parts, and then adding the costs to obtain the cost of the combination. Since one prediction mode may be combined with multiple other prediction modes, and for the same weight derivation mode, the cost of the part of the prediction mode used as the first prediction mode and the second prediction mode is fixed, these costs, i.e., cost [pred_mode_idx][gpm_idx][0] and cost [pred_mode_idx][gpm_idx][1] in the above example, may be maintained and reused, thereby reducing the amount of calculation.

The merge mode with MVD (MMVD) is introduced as follows.

The MMVD is a special merge mode. In the ordinary merge technology, the Motion Vector Difference (MVD) is not required to be encoded or decoded. The MVD is required to be encoded or decoded in the ordinary inter mode. A special method is used for encoding the MVD in the MMVD. A characteristic that the MVDs are more distributed in a single horizontal direction or a single vertical direction, and a characteristic that there are more MVDs having small values and fewer MVDs with large values are utilized, as shown in FIG. 17A and FIG. 17B below.

The MMVDs may only represent the MVDs having specific values in some specific directions, but it cannot represent any MVD. The mmvd_direction_idx (i.e., a direction index of the MMVD) is used for representing the direction of the MVD. Of course, it may also be understood as whether x and y of the MVD are non-zero and the positive or negative of them. The mmvd_distance_idx is used for representing the absolute value MmvdDistance of x or y of the MVD that is non-zero.

In an example, the relationship between the mmvd_distance_idx[x0][y0] and the MmvdDistance [x0][y0] is shown in Table 7.

TABLE 7

| | MmvdDistance[ x0 ][ y0 ] | |
|---|---|---|
| mmvd_distance_{—} | ph_mmvd_fullpel_{—} | ph_mmvd_fullpel_{—} |
| idx[ x0 ][ y0] | only_flag = = 0 | only_flag = = 1 |
| 0 | 1 | 4 |
| 1 | 2 | 8 |
| 2 | 4 | 16 |
| 3 | 8 | 32 |
| 4 | 16 | 64 |
| 5 | 32 | 128 |
| 6 | 64 | 256 |
| 7 | 128 | 512 |

Where the ph_mmvd_fullpel_only_flag is a picture header flag, and two different combinations of MMVD may be set.

In an example, the relationship between the mmvd_direction_idx[x0][y0] and the MmvdSign[x0][y0] is shown in Table 8.

TABLE 8

| mmvd direction_{—} | MmvdSign[ x0 ][ | MmvdSign[ x0 ][ |
|---|---|---|
| idx[ x0 ][ y0 ] | y0 ][ 0 ] | y0 ][ 1 ] |
| 0 | +1 | 0 |
| 1 | −1 | 0 |
| 2 | 0 | +1 |
| 3 | 0 | −1 |

Exemplarily, the MVD of the MMVD is obtained as follows:

$$MmvdOffset [ x 0 ] [ y 0 ] [ 0 ] = ( MmvdDistance [ x 0 ] [ y 0 ] << 2 ) ⋆ MmvdSign [ x 0 ] [ y 0 ] [ 0 ] ,$$

$$MmvdOffset [ x 0 ] [ y 0 ] [ 1 ] = ( MmvdDistance [ x 0 ] [ y 0 ] << 2 ) ⋆ MmvdSign [ x 0 ] [ y 0 ] [ 1 ] .$$

At present, due to the consideration of the bandwidth, only two pieces of unidirectional motion information can be used for prediction in the GPM, which leads to the limited prediction effect of the GPM, and then affects the compression effect for the video.

In order to solve the above technical problem, in the embodiment of the present disclosure, when the current block is encoded or decoded, K prediction modes for the current block are determined, and at least one of the K prediction modes is a multi-directional prediction mode (such as, a bi-directional prediction mode), so that when the K prediction modes are used for predicting the current block, the prediction accuracy for the current block can be improved, and the encoding and decoding effects for the video can be improved.

Hereinafter, with reference to FIG. 18, a method for video decoding provided by the embodiment of the present disclosure may be described by taking the decoding end as an example.

FIG. 18 is a flowchart of a method for video decoding according to an embodiment of the present disclosure, and the embodiment of the present disclosure is applied to the video decoder shown in FIG. 1 and FIG. 3. As shown in FIG. 18, the method according to the embodiment of the present disclosure includes operation S101.

In operation S101, K prediction modes for a current block are determined.

At least one of the K prediction modes is an N-directional prediction mode, and each of the K and N is a positive integer greater than 1.

Optionally, K is a preset value or a default value. Optionally, the encoding end indicates the K to the decoding end. For example, the encoding end determines K prediction modes, and then writes K into the bitstream, so that the decoding end obtains K by decoding the bitstream. Optionally, K may be determined by the decoding end through other means, which is not limited in the embodiment of the present disclosure.

As can be seen from the foregoing, in the embodiment of the present disclosure, K prediction modes together generate one prediction block, and this prediction block is used for the current block. That is to say, the current block is predicted according to the K prediction modes to obtain K prediction values, and K prediction values are weighted to obtain the prediction value of the current block.

That is to say, when the current block is decoded, the decoding end needs to determine multiple candidate prediction modes; select K prediction modes from the multiple candidate prediction modes, and then predict the current block by using the K prediction modes to obtain the prediction value of the current block.

In some embodiments, before the decoding end determines the K prediction modes for the current block, the decoding end firstly needs to determine whether a weighted prediction processing is performed on the current block by using the K different prediction modes. If the decoding end determines that the weighted prediction processing is performed on the current block by using the K different prediction modes, the decoding end performs the above-described operation S101 to determine the K prediction modes for the current block. If the decoding end determines that the weighted prediction processing is not performed on the current block by using the K different prediction modes, the operation S101 is skipped.

In a possible implementation, the decoder may determine whether the weighted prediction processing is performed on the current block by using the K different prediction modes through determining a prediction mode parameter for the current block.

Optionally, in the embodiment of the present disclosure, the prediction mode parameter may indicate whether the GPM mode or the AWP mode may be used for the current block, i.e., whether K different prediction modes may be used for performing the prediction processing on the current block.

It is to be understood that, in the embodiment of the present disclosure, the prediction mode parameter may be understood as a flag bit indicating whether the GPM mode or the AWP mode is used. Specifically, the encoder may use a variable as the prediction mode parameter, so that the setting of the prediction mode parameter may be implemented by setting the value of the variable. Exemplarily, in the present disclosure, if the GPM mode or the AWP mode is used for the current block, the encoder may set the value of the prediction mode parameter to indicate that the GPM mode or the AWP mode is used for the current block. Specifically, the encoder may set the value of the variable to be 1. Exemplarily, in the present disclosure, if the GPM mode or the AWP mode is not used for the current block, the encoder may set the value of the prediction mode parameter to indicate that the GPM mode or the AWP mode is not used for the current block. Specifically, the encoder may set the value of the variable to be 0. Furthermore, in the embodiment of the present disclosure, after the encoder completes the setting of the prediction mode parameter, the encoder writes the prediction mode parameter into the bitstream and transmits the bitstream to the decoder, so that the decoder may obtain the prediction mode parameter after parsing the bitstream.

Based on this, the decoding end decodes the bitstream to obtain the prediction mode parameter, and then determines whether the GPM mode or the AWP mode is used for the current block according to the prediction mode parameter. If the GPM mode or the AWP mode is used for the current block, i.e., when K different prediction modes are used for the prediction processing, K prediction modes for the current block are determined.

In some embodiments, in the embodiment of the present disclosure, a condition may be used for limiting whether the GPM mode or the AWP mode is used for the current block. That is to say, when it is determined that the current block satisfies a preset condition, it is determined that the weighted prediction is performed on the current block by using the K prediction modes, and then K prediction modes for the current block are determined.

Exemplarily, when the GPM mode or the AWP mode is applied, the size of the current block may be limited.

It is to be understood that, in proposed prediction method in the embodiment of the present disclosure, since K different prediction modes are required to be used for generating K prediction values, and then the K prediction values are weighted to obtain the prediction value of the current block, in order to reduce the complexity and consider the balance between the compression performance and complexity, in the embodiment of the present disclosure, the GPM mode or the AWP mode may be limited to be not used for blocks having some sizes. Therefore, in the present disclosure, the decoder may firstly determine the size parameter of the current block, and then determine whether the GPM mode or the AWP mode is used for the current block according to the size parameter.

In the embodiment of the present disclosure, the size parameter of the current block may include the height and width of the current block, and thus, the decoder may determine whether the GPM mode or the AWP mode is used for the current block according to the height and width of the current block.

Exemplarily, in the present disclosure, if the width is greater than a threshold 1 and the height is greater than a threshold 2, then it is determined that the GPM mode or the AWP mode may be used for the current block. It may be seen that one possible limitation is that the GPM mode or AWP mode is used only in the case where the width of the block is greater than (or greater than or equal to) the threshold 1 and the height of the block is greater than (or greater than or equal to) the threshold 2. The value of each of the threshold 1 and the threshold 2 may be 4, 8, 16, 32, 128, 256, etc., and the threshold 1 may be equal to the threshold 2.

Exemplarily, in the present disclosure, if the width is less than the threshold 3 and the height is greater than the threshold 4, it is determined that the GPM mode or the AWP mode may be used for the current block. It may be seen that one possible limitation is that the GPM mode or AWP mode is used only in the case where the width of the block is less than (or less than or equal to) the threshold 3 and the height of the block is greater than (or more than or equal to) the threshold 4. The value of each of the threshold 3 and the threshold 4 may be 4, 8, 16, 32, 128, 256, etc., and the threshold 3 may be equal to the threshold 4.

Furthermore, in the embodiment of the present disclosure, the size of the block for which the GPM mode or the AWP mode may be used may be limited by the limitation of the sample parameter.

Exemplarily, in the present disclosure, the decoder may firstly determine the sample parameter of the current block, and then further determine whether the GPM mode or the AWP mode may be used for the current block according to the sample parameter and a threshold 5. It may be seen that one possible limitation is that the GPM mode or AWP mode may be used only in the case where the number of pixels of the block is greater than (or greater than or equal to) the threshold 5. Herein, the value of the threshold 5 may be 4, 8, 16, 32, 128, 256, 1024, etc.

That is to say, in the present disclosure, the GPM mode or the AWP mode may be used for the current block only under the condition that the size parameter of the current block satisfies a size requirement.

Exemplarily, in the present disclosure, there may be a picture-level flag to determine whether the present disclosure is used for the current picture to be decoded. For example, it is possible to configure the present disclosure to be used for an intra picture (such as the I picture), and configure the present disclosure to be not used for an inter picture (such as the B picture or the P picture). Alternatively, it is possible to configure the present disclosure to be not used for the intra picture and configure the present disclosure to be used for the inter picture. Alternatively, it is possible to configure the present disclosure to be used for some intra pictures, and configure the present disclosure to be not used for some inter pictures. The intra prediction may also be used for the inter picture, therefore, the present disclosure may be used for the inter pictures.

In some embodiments, there may also be a flag whose level is finer than the picture-level to determine whether the present disclosure is used for the current block.

Based on the above method, when the decoding end determines that the current block is predicted by using K prediction modes, the decoding end determines the K prediction modes for the current block.

In the embodiment of the present disclosure, in order to improve the prediction effect of the K prediction modes on the current block, at least one of the K prediction modes is the N-directional prediction mode, where N is a positive integer greater than 1. Thus, the N-directional prediction mode may also be understood as a multi-directional prediction mode.

It is to be noted that the N-directional prediction mode according to the embodiment of the present disclosure may also be understood as an N reference picture prediction mode, i.e., a mode where the prediction is performed based on N reference pictures. For example, the i-th prediction mode among K prediction modes for the current block is the N-directional prediction mode, and N=2, i.e., two reference pictures are included, then, one prediction value of the current block may be obtained based on the first one of the reference pictures, the other prediction value of the current block based on the second one of the reference pictures, the two prediction values are processed (i.e. the addition or the weighted addition) to obtain a prediction value of the current block in the i-th prediction mode. The N reference pictures may be N forward decoded pictures of the current picture, or N backward decoded pictures of the current picture. Alternatively, the N reference pictures may include at least one forward decoded picture of the current picture and at least one backward decoded picture of the current picture.

For example, the K prediction modes for the current block include a first prediction mode and a second prediction mode.

In an example, the first prediction mode is the N-directional prediction mode. For example, the first prediction mode is a bi-directional prediction mode (i.e., a mode where the prediction is performed based on two reference pictures), a 3-directional prediction mode (i.e., a mode where the prediction is performed based on three reference pictures), or a 4-directional prediction mode (i.e., a mode where the prediction is performed based on four reference pictures). The second prediction mode is the unidirectional prediction mode.

In another example, the second prediction mode is the N-directional prediction mode, for example, the second prediction mode is a bi-directional prediction mode (i.e., a mode where the prediction is performed based on two reference pictures), a 3-directional prediction mode (i.e., a mode where the prediction is performed based on three reference pictures), or a 4-directional prediction mode (i.e., a mode where the prediction is performed based on four reference pictures). The first prediction mode is the unidirectional prediction mode.

In another example, both the first prediction mode and the second prediction mode are the N-directional prediction modes. For example, both the first prediction mode and the second prediction mode are the bi-directional prediction mode, the 3-directional prediction mode, the 4-directional prediction mode, etc. It is to be noted that when both the first prediction mode and the second prediction mode are the N-directional prediction mode, the number of and/or selection method of reference pictures corresponding to the first prediction mode may be the same as or different from the number of and/or selection method of reference pictures corresponding to the second prediction mode, which is not limited in the embodiment of the present disclosure. For example, the first prediction mode is the bi-directional prediction mode, i.e., the first prediction mode corresponds to two reference pictures, and the second prediction mode is the 3-directional prediction mode, i.e., the second prediction mode corresponds to three reference pictures. For another example, both the first prediction mode and the second prediction mode are the bi-directional prediction modes, but the selection method of reference pictures corresponding to the first prediction mode may be the same as or different from the selection method of reference pictures corresponding to the second prediction mode. Exemplarily, the reference pictures corresponding to the first prediction mode are two forward decoded pictures of the current picture, the reference pictures corresponding to the second prediction mode are two backward decoded pictures of the current picture; or the reference pictures corresponding to each of the first prediction mode and the second prediction mode are two forward decoded pictures of the current picture.

Hereinafter, a specific manner of the decoding end determining the K prediction modes for the current block is described.

In a case 1, when the current block is preset, the decoding end obtains the prediction value of the current block based on the K prediction modes, without considering the weight derivation mode. In this case, the above operation S101 includes the following operations S101-A1 and S101-A2.

In operation S101-A1, a candidate prediction mode list is determined, and the candidate prediction mode list includes multiple candidate prediction modes.

In operation S101-A2, K prediction modes are selected from the candidate prediction mode list.

In the case 1, the decoding end firstly determines the candidate prediction mode list, and then selects K prediction modes from the constructed candidate prediction mode list. Exemplarily, the decoding end uses each K candidate prediction modes among the multiple candidate prediction modes in the candidate prediction mode list as one combination to obtain multiple combinations. For each of the multiple combinations, the template of the current block is predicted by using the K candidate prediction modes included in the combination, and a template prediction cost corresponding to the combination is obtained. Thus, based on the template prediction cost, a combination having the smallest template prediction cost is selected from the multiple combinations, and K candidate prediction modes included in the combination having the smallest template prediction cost are used as the K prediction modes for the current block.

Taking K=2 as an example, in an example, a first candidate prediction mode list corresponding to the first prediction mode is constructed, and a second candidate prediction mode list corresponding to the second prediction mode is constructed. If the first prediction mode is the N-directional prediction mode, each candidate prediction mode in the first candidate prediction mode list is also the N-directional prediction mode, and if the second prediction mode is the N-directional prediction mode, each candidate prediction mode in the second candidate prediction mode list is also the N-directional prediction mode. Next, a candidate prediction mode 11 is selected from the first candidate prediction mode list, a candidate prediction mode 21 is selected from the second candidate prediction mode list, a template of the current block is predicted by using the candidate prediction mode 11 and the candidate prediction mode 21 to obtain a prediction values of the template, and a template prediction cost corresponding to the combination of the candidate prediction mode 11 and the candidate prediction mode 21 is obtained based on the prediction values of the template and the reconstructed value of the template. Similarly, a candidate prediction mode 12 is selected from the first candidate prediction mode list, a candidate prediction mode 22 is selected from the second candidate prediction mode list, and the template of the current block is predicted by using the candidate prediction mode 12 and the candidate prediction mode 22 to obtain the prediction values of the template, and the template prediction cost corresponding to the combination of the candidate prediction mode 12 and the candidate prediction mode 22 is obtained based on the prediction values of the template and the reconstructed value of the template. By analogy, a template prediction cost corresponding to a combination of each candidate prediction mode in the first candidate prediction mode list and each candidate prediction mode in the second candidate prediction mode list may be determined. Furthermore, based on the template prediction costs, two candidate prediction modes corresponding to the smallest template prediction cost are obtained, and the two candidate prediction modes are determined as the first prediction mode and the second prediction mode of the current block.

In a case 2, when the current block is preset, the decoding end obtains the prediction value of the current block based on the weight derivation mode and the K prediction modes. In this case, the operation S101 includes the following operations S101-B1 to S101-B3.

In operation S101-B1, M candidate weight derivation modes are determined.

In operation S101-B2, a candidate prediction mode list is determined.

In operation S101-B3, the K prediction modes for the current block are determined based on the M candidate weight derivation modes and the candidate prediction mode list.

Hereinafter, a specific manner of determining M candidate weight derivation modes is described.

In a possible implementation, there are 56 weight derivation modes in the AWP and 64 weight derivation modes in the GPM. The M candidate weight derivation modes include at least one of the 56 weight derivation modes in the AWP or include at least one of the 64 weight derivation modes in the GPM.

In a possible implementation, some weight derivation modes in the AWP or GPM may be screened out as the M candidate weight derivation modes. That is to say, the M candidate weight derivation modes in the embodiment of the present disclosure are a subset of all weight derivation modes in the AWP or the GPM. For example, in the weight derivation mode, the same “partitioning” angle may correspond to multiple offsets, such as, the modes 10, 11, 12, and 13 in FIG. 4 or FIG. 5. These modes have the same “partitioning”, but have different offsets. Some modes corresponding to offsets may be removed in the embodiment of the present disclosure. Of course, some modes corresponding to “partitioning” angles may also be removed. In this way, the total number of possible combinations may be reduced. Moreover, difference between the possible combinations becomes more pronounced. Of course, different screening methods may be set for different block sizes. For example, fewer weight derivation modes are used for smaller blocks and more weight derivation modes are used for larger blocks. Different screening methods may also be set for different block shapes. One explanation of the block shape refers to the ratio of the width and the height.

In this implementation, the encoding end and the decoding end screens out M candidate weight derivation modes in the same manner. In an example, the manner of obtaining the M candidate weight derivation modes by screening is defaulted by both the encoding end and the decoding end. In another example, the encoding end may indicates the manner of obtaining the M candidate weight derivation modes by screening to the decoding end, so that the decoding end obtain the same M candidate weight derivation modes by screening through the manner being the same as the encoding end.

In some embodiments, M candidate weight derivation modes are obtained by excluding weight derivation modes corresponding to preset partitioning angles and/or preset offsets from multiple preset weight derivation modes. Since the same partitioning angle in the weight derivation mode may correspond to multiple offsets, such as the weight derivation modes 10, 11, 12, and 13 as shown in FIG. 4, these derivation modes have the same partitioning angle but have different offsets. Therefore, some weight derivation modes corresponding to the preset offsets may be removed, and/or some weight derivation modes corresponding to the preset partitioning angle may also be removed.

In some embodiments, different blocks may correspond to different screening conditions, so that when M candidate weight derivation modes corresponding to the current block are determined, the screening conditions corresponding to the current block are firstly determined, and M candidate weight derivation modes are selected from the multiple preset weight derivation modes according to the screening conditions corresponding to the current block.

In some embodiments, the screening conditions corresponding to the current block includes screening conditions corresponding to the size of the current block and/or screening conditions corresponding to the shape of the current block. When the prediction is performed, for smaller blocks, similar weight derivation modes have little difference in influence on the prediction result; but for larger blocks, similar weight derivation modes have more obvious difference in influence on the prediction result. Based on this, in the embodiment of the present disclosure, different M values are set for blocks having different sizes, i.e., a larger M value is set for a larger block, and a smaller M value is set for a smaller block.

In a possible implementation, the encoding end indicates M candidate weight derivation modes to the decoding side.

In some embodiments, the screening conditions include an array. The array including M elements, the M elements correspond to M weight derivation modes in one-to-one manner, and an element corresponding to each weight derivation mode is used for indicating whether the weight derivation mode is available.

Elements in the array may be one-bit values or two-bit values.

For example, taking the GPM as an example, there are 64 possible weight derivation modes in total. The encoding end sets a look up table including 64 elements. The value of each element indicates whether to use its corresponding weight derivation mode.

In an example, taking the elements in the array being one-bit values as an example, a specific example is as follows: set an array g_sgpm_splitDir:

g_sgpm_splitDir[64] = {
1,1,1,0,1,0,1,0,
1,0,1,0,1,0,1,0,
1,0,1,1,1,0,1,0,
1,0,1,0,1,0,1,0,
0,0,0,0,1,1,0,1,
0,0,1,0,0,1,0,0,
1,0,1,1,0,1,0,0,
1,0,0,1,0,0,1,0
};

where, the g_sgpm_splitDir[x] having a value of 1 indicates that the weight derivation mode having the index of x may be used; and the g_sgpm_splitDir[x] having a value of 0 indicates that the weight derivation mode having the index of x may not be used. In this example, the decoder determines 26 candidate weight derivation modes through the array.

In another example, the M candidate weight derivation modes may be indicated by using an array, and the array includes only indices of available weight derivation modes. For example, the array g_sgpm_splitDir[26]={0, 1, 6, 8, 10, 12, 14, 16, 18, 19, 20, 22, 24, 26, 28, 30, 36, 37, 42, 45, 48, 50, 51, 53, 56, 59} may be used for indicating 26 candidate weight derivation modes. Based on the indices of the weight derivation modes included in the array, the decoding end determines the weight derivation modes corresponding to the indices as the candidate weight derivation modes, and then obtains 26 candidate weight derivation modes.

In some embodiments, when the screening conditions corresponding to the current block includes the screening condition corresponding to the size of the current block and the screening condition corresponding to the shape of the current block, and for the same weight derivation mode, if both the screening condition corresponding to the size of the current block and the screening condition corresponding to the shape of the current block indicate that the weight derivation mode is available, then the weight derivation mode is determined as one of the M candidate weight derivation modes; and if at least one of the screening condition corresponding to the size of the current block and the screening condition corresponding to the shape of the current block indicates that the weight derivation mode is not available, then the weight derivation mode is not used for constructing the M candidate weight derivation modes.

In some embodiments, the screening conditions corresponding to different block sizes may be implemented separately from the screening conditions corresponding to different block shapes by using multiple arrays.

In some embodiments, the screening conditions corresponding to different block sizes and the screening conditions corresponding to different block shapes may be implemented by using a two-dimensional array. That is to say, the two-dimensional array includes both the screening conditions corresponding to the block size and the screening conditions corresponding to the block shape.

Exemplarily, screening conditions for a block having size A and shape B is shown below, and the screening conditions are represented by the two-dimensional array:

g_sgpm_splitDir[64] = {
(1, 1), (1, 1), (1, 1), (1, 0), (1, 0), (0, 0), (1, 0), (1, 1),
(1, 1), (0, 0), (1, 1), (1, 0), (1, 0), (0, 0), (1, 0), (1, 1),
(0, 1), (0, 0), (1, 1), (0, 0), (1, 0), (0, 0), (1, 0), (0, 0),
(1, 1), (0, 0), (0, 1), (1, 0), (1, 0), (1, 0), (1, 0), (0, 0),
(0, 0), (0, 0), (1, 1), (0, 0), (1, 1), (1, 1), (1, 0), (0, 1),
(0, 0), (0, 0), (1, 1), (0, 0), (1, 0), (0, 0), (1, 0), (0, 0),
(1, 0), (0, 0), (1, 1), (1, 0), (1, 0), (1, 0), (0, 0), (0, 0),
(1, 1), (0, 0), (1, 1), (0, 0), (0, 0), (1, 0), (1, 1), (0, 0)
};

where all values of the g_sgpm_splitDir[x] being 1 indicates that the weight derivation mode having the index x is available, and one of the values of the g_sgpm_splitDir[x] being 0 indicates that the weight derivation mode having the index x is not available. For example, the g_sgpm_splitDir[4]=(1, 0) indicates that the weight derivation mode 4 is available for the block having the size A but is not available for the block having the shape B. Therefore, when the size of the block is A and the shape of the block is B, the weight derivation mode is not available.

It is to be noted that, although the GPM including 64 weight derivation modes is taken as an example, the weight derivation modes in the embodiment of the present disclosure include, but are not limited to, 64 weight derivation modes included in the GPM and 56 weight derivation modes included in the AMP.

Hereinafter, a process for determining the candidate prediction mode list is described.

It is to be noted that the candidate prediction mode list according to the embodiment of the present disclosure includes the N-directional prediction mode, such as, the bi-directional prediction mode (i.e., a mode where the prediction is performed based on two reference pictures), a 3-directional prediction mode (i.e., a mode where the prediction is performed based on three reference pictures), or a 4-directional prediction mode (i.e., a mode where the prediction is performed based on four reference pictures), and furthermore, it is ensured that at least one of the K prediction modes for the current block determined based on the candidate prediction mode list is the N-directional prediction mode.

In some embodiments, the determination process of the candidate prediction mode list described above is independent of M candidate weight derivation modes. That is to say, it is to be understood that the M candidate weight derivation modes correspond to one candidate prediction mode list, which can reduce the complexity of determining the candidate prediction mode list, and thus improve the decoding efficiency. It is to be noted that, in this embodiment, since the candidate prediction mode list is independent of the M candidate weight derivation modes, there is no strict sequence of execution between the S101-B1 and the S101-B2. That is to say, the S101-B1 may be performed after the S101-B2 is performed, may be performed before the S101-B2 is performed, or maybe performed simultaneously with the S101-B2, which is not limited in the embodiment of the present disclosure.

In some embodiments, for each first candidate weight derivation mode among the M candidate weight derivation modes, a candidate prediction mode list corresponding to the first candidate weight derivation mode is determined.

In an example, the first candidate weight derivation mode is any one of the M candidate weight derivation modes. That is to say, in this example, it is necessary to determine at least one candidate prediction mode list for each of the M candidate weight derivation modes. As may be seen from the above, one weight derivation mode corresponds to K prediction modes, and the candidate prediction mode list is used for determining the prediction modes. Therefore, in a possible implementation of this example, one candidate prediction mode list is determined for at least one of the K prediction modes corresponding to each of the M candidate weight derivation modes.

In another example, if the first candidate weight derivation mode is one category of candidate weight derivation modes among the M candidate weight derivation modes, then in the embodiment of the present disclosure, the M candidate weight derivation modes are required to categorized, and at least one candidate prediction mode list is constructed for each category of candidate weight derivation modes.

In the embodiment of the present disclosure, the manners of determining the candidate prediction mode lists corresponding to all first candidate weight derivation modes among the M candidate weight derivation modes are the same as each other. For convenience of description, the determination of the candidate prediction mode list corresponding to one first candidate weight derivation mode is taken as an example to describe in the embodiment of the present disclosure.

Hereinafter, a specific manner of determining the candidate prediction mode list corresponding to the first candidate weight derivation mode is described.

In some embodiments, the first candidate weight derivation mode corresponds to a candidate prediction mode list.

In some embodiments, when each of the K prediction modes corresponds to one candidate prediction mode list, then for the i-th prediction mode among the K prediction modes, the decoding end determines the candidate prediction mode corresponding to the i-th prediction mode, where i is a positive integer less than or equal to K.

In this embodiment, each of the K prediction modes corresponds to one candidate prediction mode list, and thus, for the first candidate weight derivation mode, the decoding end determines one candidate prediction mode list for each of the K prediction modes corresponding to the first candidate weight derivation mode. For example, the K prediction modes include a first one of the prediction modes and a second one of the prediction modes corresponding to the first candidate weight derivation mode; and furthermore, the decoding end determines one candidate prediction mode list for the first one of the prediction modes and determines one candidate prediction mode for the second one of the prediction modes.

In this embodiment, the processes of determining candidate prediction mode lists corresponding to all of the K prediction modes is the same as each other. For convenience of description, determining the candidate prediction mode list corresponding to the i-th prediction mode among the K prediction modes is taken as an example to describe in the embodiment of the present disclosure.

The specific types of candidate prediction modes included in the candidate prediction mode list corresponding to the i-th prediction mode are not limited in the embodiment of present disclosure.

In some embodiments, when the candidate prediction mode list corresponding to the i-th prediction mode is constructed, the following 7 types of prediction modes are sequentially added into the candidate prediction mode list until the list has a length reaching a preset value (such as, 3).
1. A prediction mode having a prediction angle parallel to a partitioning line of the first candidate weight derivation mode.
2. A first candidate prediction mode determined based on the template of the current block, in some embodiments, the first candidate prediction mode is also referred to as a TIMD-derived prediction mode.
3. A second candidate prediction mode determined based on a gradient of reconstructed samples in the template of the current block, in some embodiments, the second candidate prediction mode is also referred to as a DIMD-derived prediction mode.
4. Prediction modes of neighbouring blocks of the current block.
5. A prediction mode having a prediction angle perpendicular to the partitioning line of the first candidate weight derivation mode.
6. The planar mode.
7. The N-directional prediction mode.

The specific process of determining the candidate prediction mode list is described in the above embodiment.

After the decoding end determines the candidate prediction mode list based on the above operations, the decoding end performs operation S101-B3.

Hereinafter, the process of determining the K prediction modes based on the M candidate weight derivation modes and the candidate prediction mode list in operation S101-B3 is described.

In the embodiment of the present disclosure, the decoding end selects one candidate weight derivation mode from the M candidate weight derivation modes as the weight derivation mode for the current block, and determines K prediction modes for the current block from at least one candidate prediction mode included in the candidate prediction mode list. Finally, the current block is predicted by using the weight derivation mode for the current block and K prediction modes for the current block, to obtain the prediction value of the current block.

It is to be noted that the weight derivation mode for the current block and the K prediction modes for the current block are used together for determining the prediction value of the current block.

The specific manner where the decoding end determines the weight derivation mode for the current block and the K prediction modes for the current block based on the M candidate weight derivation modes and the candidate prediction mode list is not limited in the embodiment of the present disclosure.

In some embodiments, when the candidate prediction mode list is a candidate prediction mode list corresponding to the K prediction modes for the current block, i.e., all K prediction modes for the current block are selected from the candidate prediction mode list. In this case, the decoding end combines the M candidate weight derivation modes with the candidate prediction modes included in the candidate prediction mode list. For example, each of the M candidate weight derivation modes is combined with any K candidate prediction modes in the candidate prediction mode list, to obtain multiple combinations each including one candidate weight derivation mode and K candidate prediction modes. Furthermore, the template of the current block (such as, a top template of the current block, a left template of the current block, or top and left templates of the current block) is predicted by using the candidate weight derivation mode and the K candidate prediction modes included in each combination, the cost of each combination is determined, and one combination is determined from the multiple combinations based on the costs. For example, a combination having the smallest cost is selected from the multiple combinations, the candidate weight derivation mode included in the combination having the smallest cost is determined as the weight derivation mode for the current block, and the K prediction modes included in the combination having the smallest cost are determined as the K prediction modes for the current block.

In some embodiments, if the candidate prediction mode list is a candidate prediction mode list corresponding to one of the K prediction modes for the current block. For example, K=2, and the candidate prediction mode list is a candidate prediction mode list corresponding to the first one of the prediction modes. In this case, the decoding end determines an optional prediction mode set corresponding to the second one of the prediction modes. Furthermore, for each of the M candidate weight derivation modes, the decoding end selects one candidate prediction mode from the candidate prediction mode list corresponding to the first one of the prediction modes as one possibility of the first one of the prediction modes; selects one prediction mode from the optional prediction mode set corresponding to the second one of the prediction modes as one possibility of the second one of the prediction modes; and obtains a combination of the candidate weight derivation mode, the one possibility of the first one of the prediction modes and the one possibility of the second one of the prediction modes. There are multiple combinations. Each combination includes one candidate weight derivation mode and two candidate prediction modes. Furthermore, the template of the current block is predicted by using the candidate weight derivation mode and the two candidate prediction modes included in each combination; the cost of each combination is determined; and one combination is determined from the multiple combinations based on the costs. For example, the combination having the smallest cost is selected from the multiple combinations, the candidate weight derivation mode included in the combination having the smallest cost is determined as the weight derivation mode of the current block, and K prediction modes included in the combination having the smallest cost are determined as K prediction modes for the current block.

In some embodiments, if the candidate prediction mode list includes a candidate prediction mode list corresponding to each of the K prediction modes for the current block. For example, it is assumed that K=2, i.e., the decoding end determines the candidate prediction mode list corresponding to the first one of the prediction modes and the candidate prediction mode list corresponding to the second one of the prediction modes. In this way, the decoding end selects one candidate weight derivation mode from the M candidate weight derivation modes; selects one candidate prediction mode from the candidate prediction mode list corresponding to the first one of the prediction modes; and selects one candidate prediction mode from the candidate prediction mode list corresponding to the second one of the prediction modes. In this case, the selected one candidate weight derivation mode and the selected two candidate prediction modes form a combination. With reference to the above method, multiple combinations may be obtained. Each combination includes one candidate weight derivation mode and two candidate prediction modes. Furthermore, the template of the current block is predicted by using the candidate weight derivation mode and the two candidate prediction modes included in each combination; the cost of each combination is determined; and one combination is determined from the multiple combinations based on the costs. For example, the combination having the smallest cost is selected from the multiple combinations, the candidate weight derivation mode included in the combination having the smallest cost is determined as the weight derivation mode of the current block, and K prediction modes included in the combination having the smallest cost are determined as K prediction modes for the current block.

Based on the above description, one weight derivation mode and the K prediction modes may be used together for the current block as one combination. In order to save codewords and reduce the encoding cost, in some embodiments, the weight derivation mode and the K prediction modes corresponding to the current block are used as one combination, i.e., the first combination indicated by using the first index. Compared with indicating the weight derivation mode and the K prediction modes respectively, the method in the embodiment of the present disclosure uses fewer codewords, thereby reducing the encoding cost.

Based on this, the above operation S101-B3 includes the following operations S101-B31 to S101-B33.

In operation S101-B31, the bitstream is decoded to obtain the first index, the first index is used for indicating the first combination, and the first combination includes one weight derivation mode for the current block and K prediction modes for the current block.

In operation S101-B32, the candidate combination list is determined based on the M candidate weight derivation modes and the candidate prediction mode list, the candidate combination list includes at least one candidate combination, and the at least one candidate combination includes one weight derivation mode and K prediction modes.

In operation S101-B33, The first combination is determined from the candidate combination list based on the first index.

A form of the specific syntax element of the first index is not limited in the embodiment of the present disclosure.

In a possible implementation, if the current block is predicted by using the GPM technology, the gpm_cand_idx is used for representing the first index.

Since the first index is used for indicating the first combination, in some embodiments, the first index may also be referred to as a first combination index or an index of the first combination.

In an example, the syntax after the first index is added into the bitstream is as shown in Table 9.

TABLE 9

| | |
|---|---|
| If (conditions for using GPM for the current | |
| block are derived) { | |
| gpm_cand_idx[ x0 ][ y0 ] | ae(v) |
| } | |
| } | |

where the gpm_cand_idx is the first index.

Exemplarily, the candidate combination list is shown in Table 10.

TABLE 10

| index | candidate combinations |
|---|---|
| 0 | candidate combination 1 (including one weight derivation mode |
| | and K prediction modes) |
| 1 | candidate combination 2 (including one weight derivation mode |
| | and K prediction modes) |
| . . . | . . . |
| i-1 | candidate combination i (including one weight derivation mode |
| | and K prediction modes) |
| . . . | . . . |

As shown in Table 10, the candidate combination list includes multiple candidate combinations, and any two candidate combinations among the multiple candidate combinations are not completely the same as each other. That is to say, at least one of the weight derivation mode and the K prediction modes included in the any two candidate combinations are different from each other. For example, the weight derivation mode of the candidate combination 1 is different from the weight derivation mode of the candidate combination 2; or the weight derivation modes of the candidate combination 1 is the same as the weight derivation mode of the candidate combination 2, but at least one of the K prediction modes of the candidate combination 1 is different from the any one of the K prediction modes of the candidate combination 2; or the weight derivation mode of the candidate combination 1 is different from the weight derivation mode of the candidate combination 2, and at least one of the K prediction modes of the candidate combination 1 is different from the any one of the K prediction modes of the candidate combination 2.

Exemplarily, in the above Table 10, the ranking number of the candidate combination in the candidate combination list is used as an index, and alternatively, the index of the candidate combination in the candidate combination list may be reflected in other manners, which is not limited in the embodiment of the present disclosure.

In this embodiment, the decoding end decodes the bitstream to obtain the first index; determines the candidate combination list as shown in Table 10; looks up in the candidate combination list according to the first index to obtain the weight derivation mode and K prediction modes for the current block included in the first combination indicated by the first index.

For example, the first index is index 1, and in the candidate combination list shown in Table 10, the candidate combination corresponding to the index 1 is the candidate combination 2, i.e., the first combination indicated by the first index is the candidate combination 2. In this way, the decoding end determines the weight derivation mode and the K prediction modes included in the candidate combination 2 as the weight derivation mode for the current block and the K prediction modes for the current block included in the first combination; and predicts the current block by using the weight derivation mode for the current block and the K prediction modes for the current block, to obtain the prediction value of the current block.

In manner 2, the encoding end and the decoding end may respectively determine the same candidate combination list. For example, each of the encoding end and the decoding end determines a list including X candidate combinations, and each candidate combination includes 1 weight derivation mode and K prediction modes. In the bitstream, the encoding end only needs to write one finally selected candidate combination, such as the first combination, and the decoding end parses to obtain the first combination finally selected by the encoding end. Specifically, the decoding end decodes the bitstream to obtain the first index, and determines the first combination from the candidate combination list determined by the decoding end through the first index.

Hereinafter, the specific process of determining the candidate combination list based on the M candidate weight derivation mode and the candidate prediction mode list in operation S101-S32 is described.

The specific manner of determining the candidate combination list based on the M candidate weight derivation mode and the candidate prediction mode list in operation S101-B32 is not limited in the embodiment of the present disclosure.

In some embodiments, M candidate weight derivation modes are arbitrarily combined with multiple candidate prediction modes included in the candidate prediction mode list, and each combination includes one weight derivation mode and two prediction modes. In this way, multiple combinations may be obtained, and the probabilities of occurrences of different combinations may be analyzed by using the information related to the current block, and the candidate combination list may be constructed according to the probabilities of occurrences of all combinations. Optionally, the information related to the current block includes mode information of surrounding blocks of the current block, reconstructed samples of the current block, etc.

In some embodiments, the operation S101-B32 includes the following operations S101-B321 and S101-B322.

In operation S101-B321, T second combinations are obtained based on M candidate weight derivation modes and the candidate prediction mode list.

In operation S101-B322, the candidate combination list is obtained based on the T second combinations.

Any one of the T second combinations includes one weight derivation mode and K prediction modes, and the weight derivation modes and K prediction modes included in any two of the T second combinations are not completely the same as each other, where T is a positive integer greater than 1.

The manner of obtaining the T second combinations based on M candidate weight derivation modes and the candidate prediction mode list in S101-B321 described above is not limited in the embodiment of the present disclosure.

In some embodiments, if the candidate prediction mode list includes a candidate prediction mode list corresponding to each of the K prediction modes for the current block. For example, it is assumed that K=2, i.e., the decoding end determines the candidate prediction mode list corresponding to the first one of the prediction modes and the candidate prediction mode of the second one of the prediction modes. In this way, the decoding end selects one candidate weight derivation mode from the M candidate weight derivation modes; selects one candidate prediction mode from the candidate prediction mode list corresponding to the first one of the prediction modes; and selects one candidate prediction mode from the candidate prediction mode list corresponding to the second one of the prediction modes. In this case, the selected one candidate weight derivation mode and the selected two candidate prediction modes form one second combination. With reference to the above method, T second combinations may be obtained, and each second combination includes one candidate weight derivation mode and two candidate prediction modes.

The implementation of obtaining the candidate combination list based on the T second combinations in operation S101-B322 includes, but is not limited to, the manner 1 and the manner 2.

In the manner 1, T second combinations are ranked according to a preset rule to obtain the candidate combination list.

In the manner 2, for any one of the T second combinations, when the template of the current block is predicted by using the weight derivation mode and the K prediction modes in the second combination, a cost corresponding to the second combination is determined; the candidate combination list is determined according to the costs corresponding to all of the T second combinations.

In the manner 2, for each of the T second combinations, the template of the current block is predicted by using the weight derivation mode and the K prediction modes included in the second combination; and prediction values of the template corresponding to the second combination is obtained. Specifically, for each of the T second combinations, K prediction modes in the second combination are used for predicting the template of the current block to obtain K prediction values. Furthermore, based on the weight derivation mode in the second combination, template weights corresponding to the second combination is determined, and then K prediction values of the template are weighted based on the template weights to obtain the prediction values of the template corresponding to the second combination.

Since the template of the current block is a reconstructed area, the decoding end may obtain reconstructed values of the template, and thus, for each of the T second combinations, the cost corresponding to the second combination may be determined according to the prediction values of the template and the reconstructed values of the template that correspond to the second combination. The manner of determining the cost corresponding to the second combination includes, but is not limited to, the SAD, the SATD, the SEE, etc. Furthermore, the candidate combination list is constructed based on the costs corresponding to all of the T second combinations.

In some embodiments, a fast cost calculation method may be used for determining the costs corresponding to all second combinations. It may be seen from the forgoing, the prediction values of the template corresponding to the second combination includes the prediction value of the template corresponding to each of the K prediction modes included in the second combination. In this case, the cost corresponding to each of the K prediction modes in the second combination may be determined according to the prediction value of the template corresponding to each of the K prediction modes and the reconstructed values of the template in the second combination; the cost corresponding to the second combination is determined according to the costs corresponding to the K prediction modes in the second combination. For example, the sum of the costs corresponding to K prediction modes in the second combination is determined as the cost corresponding to the second combination.

In the embodiment of the present disclosure, taking K=2 as an example, the weights on the template may be simplified to only two possibilities of 0 and 1, and then, for each pixel position, its sample value only comes from the prediction block of the first one of the prediction modes or the prediction block of the second one of the prediction modes. Therefore, for a prediction mode, it is possible to calculate the cost on the template when the prediction mode is used as the first one of the prediction modes of a certain weight derivation mode, i.e., only the cost generated by a part of samples having a weight of 1 on the template when the prediction mode is used as the first one of the prediction modes under the weight derivation mode is calculated. An example is to denote the cost as cost [pred_mode_idx][gpm_idx][0], where the pred_mode_idx represents the index of the prediction mode, the gpm_idx represents the index of the weight derivation mode, and 0 represents as the first prediction mode.

And it is possible to calculate the cost on the template when the prediction mode is used as the second one of the prediction modes under a certain weight derivation mode, i.e., only the cost generated by a part of samples having a weight of 1 on the template when the prediction mode is used as the second one of the prediction modes under the weight derivation mode is calculated. An example is to denote the cost as cost [pred_mode_idx][gpm_idx][1], where the pred_mode_idx represents the index of the prediction mode, the gpm_idx represents the index of the weight derivation mode, and I represents as the second one of the prediction modes.

Then when the cost of a combination is calculated, the corresponding above two costs may be directly added. For example, as follows, the cost of prediction modes pred_mode_idx0 and pred_mode_idx1 under the weight derivation mode gpm_idx is required to be calculated, where pred_mode_idx0 represents as the first one of the prediction modes and the pred_mode_idx1 represents as the second one of the prediction modes. Then this cost is denoted as costTemp, then costTemp=cost [pred_mode_idx0][gpm_idx][0]+cost [pred_mode_idx1][gpm_idx][1]. If it is the cost of prediction modes pred_mode_idx0 and pred_mode_idx1 under the weight derivation mode gpm_idx is required to be calculated, where the pred_mode_idx1 is as the first one of the prediction modes and the pred_mode_idx0 is as the second one of the prediction modes, then this cost is denoted as costTemp, and costTemp=cost [pred_mode_idx1][gpm_idx][0]+cost [pred_mode_idx0][gpm_idx][1].

One advantage of this is that the weighting is firstly performed to combine into a prediction block and then the cost is calculated, which is simplified to directly calculating the costs of the two parts, and then adding the costs to obtained the cost of the combination. Since one prediction mode may be combined with multiple other prediction modes, and for the same weight derivation mode, the cost of the part of the prediction mode used as the first one of the prediction modes and the second one of the prediction modes is fixed, these costs, i.e., cost [pred_mode_idx][gpm_idx][0] and cost [pred_mode_idx][gpm_idx][1] in the above example, may be maintained and reused, thereby reducing the amount of calculation.

According to the above method, the costs corresponding to all of the T second combinations may be determined, and then the candidate combination list may be constructed based on the costs corresponding to all of the T second combinations.

In a first example, the T second combinations are ranked according to the costs corresponding to all of the T second combinations; and the ranked T second combinations are determined as the candidate combination list. The generated candidate combination list in first example includes T first candidate combinations.

In a second example, C second combinations are selected from T second combinations according to the costs corresponding to the second combinations, and a list composed of the C second combinations is determined as the candidate combination list. Optionally, the C second combinations are the first C second combinations corresponding to the smallest costs among the T second combinations. For example, C second combinations corresponding to the smallest costs are selected from the T second combinations based on the costs corresponding to all of the T second combinations, to construct the candidate combination list. In this case, the candidate combination list includes C candidate combinations. Optionally, the C candidate combinations in the candidate combination list are ranked in an ascending order of the costs, i.e., the costs corresponding to the C candidate combinations in the candidate combination list increases sequentially according to the ranking.

The decoding end determines the candidate combination list based on the above operations; selects the first combination corresponding to the first index from the candidate combination list; determines the weight derivation mode included in the first combination as the weight derivation mode for the current block; and determines K prediction modes included in the first combination as the K prediction modes for the current block.

Based on the above operations, the decoding end determines K prediction modes for the current block, and then performs the following operation S102.

In operation S102, the current block is predicted based on the K prediction modes for the current block to obtain a prediction value of the current block.

In the embodiment of the present disclosure, at least one of the K prediction modes for the current block determined by the decoding end is the N-directional prediction mode, so that when the current block is predicted based on the K prediction modes, the prediction accuracy can be improved.

The specific types of the K prediction modes for the current block are not limited in the embodiment of the present disclosure.

In some embodiments, each of the K prediction modes is the inter prediction mode.

In some embodiments, a part of the K prediction modes are the intra prediction mode, and a part of the K prediction modes are the inter prediction mode.

In some embodiments, the N-directional prediction mode in the embodiment of the present disclosure is the inter prediction mode, such as, bi-directional motion information or multi-directional motion information, etc.

It is to be noted that, in the embodiment of the present disclosure, when the N-directional prediction mode is used for the current block, a prediction value of the current block is finally obtained. For example, the K prediction modes include a first one of the prediction modes and a second one of the prediction modes, where the first one of the prediction modes is the N-directional prediction mode, the decoding end predicts the current block by using the N-directional prediction mode to obtain a prediction value 1 of the current block; predicts the current block by using the second one of the prediction modes to obtain a prediction value 2 of the current block; and then processes the prediction value 1 and the prediction value 2 to obtain the prediction value of the current block.

A specific manner where the decoding end predicts the current block based on K prediction modes to obtain the prediction value of the current block is not limited in the embodiment of the present disclosure.

In some embodiments, if the N-directional prediction mode is N-directional motion information, then operation S102 includes following operations S102-A to S102-D.

In operation S102-A, for an i-th prediction mode among the K prediction modes, if the i-th prediction mode is the N-directional prediction mode, determining N pieces of first motion information corresponding to the i-th prediction mode, where i is a positive integer less than or equal to K.

In operation S102-B, an i-th prediction value of the current block is obtained based on the N pieces of first motion information.

In operation S102-C, the current block is predicted by using prediction modes other than the i-th prediction mode among the K prediction modes, to obtain other prediction values of the current block.

In operation S102-D, the prediction value of the current block is obtained based on the i-th prediction value and the other prediction values.

In this embodiment, when the i-th prediction mode among the K prediction modes for the current block is the N-directional prediction mode, the decoding end firstly determines N pieces of first motion information corresponding to the i-th prediction mode, where the first motion information may be understood as an initial value of each piece of motion information in the N-directional motion information, or may be referred to as the initial motion information. Based on the N pieces of first motion information, the i-th prediction value of the current block is obtained. Furthermore, the current block is predicted by using prediction modes other than the i-th prediction mode among the K prediction modes, to obtain other prediction values of the current block; and finally, the prediction value of the current block is obtained based on the i-th prediction value and the other prediction values.

For example, it is assumed that the K prediction modes include a first one of the prediction modes and a second one of the prediction modes. In an example, when the first one of the prediction modes is the N-directional prediction mode and the second one of the prediction modes is a non-N-directional prediction mode, N pieces of first motion information corresponding to the first one of the prediction modes are determined, and a prediction value 1 of the current block is obtained based on the N pieces of first motion information. Then, the second one of the prediction modes is used to predict the current block to obtain the prediction value 2 of the current block; and then the prediction value of the current block is obtained based on the prediction value 1 and the prediction value 2. In another example, in an example, when the first one of the prediction modes is the non-N-directional prediction mode and the second one of the prediction modes is the N-directional prediction mode, the current block is predicted by using the first one of the prediction modes to obtain a prediction value 1 of the current block. Furthermore, N pieces of first motion information corresponding to the second one of the prediction modes are determined, and a prediction value 2 of the current block is obtained based on the N pieces of first motion information. Furthermore, the prediction value of the current block is obtained based on the prediction value 1 and the prediction value 2. In another example, when the first one of the prediction modes is the N-directional prediction mode and the second one of the prediction modes is also the N-directional prediction mode, N pieces of first motion information corresponding to the first one of the prediction modes are determined, and a prediction value 1 of the current block is obtained based on the N pieces of first motion information; N pieces of first motion information corresponding to the second one of the prediction modes are determined, and a prediction value 2 of the current block is obtained based on the N pieces of first motion information; and the prediction value of the current block is further obtained based on the prediction value 1 and the prediction value 2.

Hereinafter, a specific process where the decoding end determines the N pieces of first motion information corresponding to the i-th prediction mode is described.

In the embodiment of the present disclosure, each piece of motion information in the N-directional motion information includes one reference picture and one motion vector, and one reference block of the current block in the reference picture may be obtained based on the motion vector. In this way, N reference blocks of the current block may be determined by the N-directional motion information, and then the prediction value of the current block in the i-th prediction mode may be obtained based on the N reference blocks.

In some embodiments, the encoding end writes the index of the reference picture corresponding to each piece of motion information in the N-directional motion information and the index of the motion vector into the bitstream. In this way, the decoding end may obtain the index of the reference picture corresponding to the motion information and the index of the motion vector by decoding the bitstream, and then obtain the reference picture corresponding to the motion information based on the index of the reference picture and obtain the motion vector corresponding to the motion information based on the index of the motion vector. Specifically, the decoding end constructs a reference picture list and obtains the reference picture corresponding to the motion information from the constructed reference picture list based on the index of the reference picture; and the decoding end constructs a motion information candidate list and obtains the motion vector corresponding to the motion information from the constructed motion information candidate list based on the index of the motion vector.

As can be seen from foregoing, before the N pieces of first motion information is determined, the decoding end firstly needs to construct the reference picture list and the motion information candidate list.

In some embodiments, the decoding end constructs one reference picture list for the N-directional motion information.

In some embodiments, the decoding end constructs one reference picture list for each piece of motion information in the N-directional motion information. For example, since the N-directional motion information includes the motion information 1 and the motion information 2, the decoding end constructs a reference picture list RPL0 for the motion information 1 and constructs a reference picture list RPL1 for the motion information 2. In an example, the reference pictures in at least one of the reference picture list RPL0 and the reference picture list RPL1 are preset or default. In another example, the encoding end sends identification information (such as, a picture order count) of a reference picture included in at least one of the reference picture list RPL0 and the reference picture list RPL1 to the decoding end, so that the decoding end may construct at least one of the reference picture list RPL0 and the reference picture list RPL1 based on the identification information of the reference picture.

The construction process of the motion information candidate list is described below.

In some embodiments, the decoding end constructs one motion information candidate list for the N-directional motion information.

In some embodiments, the decoding end constructs one motion information candidate list for each piece of motion information in the N-directional motion information.

In some embodiments, the motion information candidate list may be a merge candidate list. Exemplarily, the merge candidate list includes multiple candidate motion vectors.

For example, it is assumed that the K prediction modes include a first one of the prediction modes and a second one of the prediction modes, and it is assumed that both the first one of the prediction modes and the second one of the prediction modes are the inter prediction modes. In this case, the K prediction modes may be understood as K pieces of motion information, such as the motion information 1 and the motion information 2, and at least one of the motion information 1 and the motion information 2 is the N-directional motion information. It is assumed that the motion information 1 is the bi-directional motion information, the decoding end decodes the bitstream to obtain a reference picture index and a motion vector index corresponding to each piece of motion information in the bi-directional motion information. In the bi-directional motion information, it is assumed that the reference picture index corresponding to the first one piece of motion information is refIdxL0, the motion vector index corresponding to the first one piece of motion information is mvIdxL0, the reference picture index corresponding to the second one piece of motion information is refIdxL1, and the motion vector index corresponding to the second one piece of motion information is mvIdxL1. In this way, the decoding end determines the reference picture list RPL0 corresponding to the first one piece of motion information based on the above method; and then obtains the reference picture refL0 corresponding to the first one piece of motion information from the reference picture list RPL0 based on the reference picture index refIdxL0. Furthermore, the decoding end determines a motion information candidate list (such as, a merge candidate list) based on the above method; obtains the motion vector mvL0 corresponding to the first one piece of motion information from the motion information candidate list based on the motion vector index mvIdxL0; and determines the motion vector mvL0 and the reference picture refL0 that correspond to the first motion information as the first motion information or the initial motion information corresponding to the first one piece of motion information. Similarly, the decoding end determines the reference picture list RPL1 corresponding to the second one piece of motion information based on the above method; and then obtains the reference picture refL1 corresponding to the second one piece of motion information from the reference picture list RPL1 based on the reference picture index refIdxL1. Furthermore, the decoding end obtains the motion vector mvL1 corresponding to the second one piece of motion information from the motion information candidate list based on the motion vector index mvIdxL1; and determines the motion vector mvL1 and the reference picture refL1 that correspond to the second one piece of motion information as the first motion information or the initial motion information corresponding to the second one piece of motion information. In this way, two pieces of the first motion information corresponding to the first one of the prediction modes may be obtained. Similarly, if the second one of the prediction modes is also the bi-directional prediction mode, two pieces of the first motion information corresponding to the second one of the prediction modes may be obtained based on the above method.

As may be seen from the above, each of the N pieces of first motion information includes reference picture information and motion vector information that correspond to the motion information, and the reference picture information may be the reference picture index, a POC of the reference picture, etc. The motion vector information may be an initial value of the first motion vector that also referred to as an initial motion vector or a motion vector.

In the above embodiment, the decoding end determining the first motion vector from the motion information candidate list based on the index of the motion vector is taken as an example to describe. In some embodiments, the first motion vector may be directly encoded into the bitstream at the encoding end, so that the first motion vector may be directly decoded from the bitstream at the decoding end.

In the embodiment of the present disclosure, after the decoding end determines the N pieces of first motion information corresponding to the i-th prediction mode based on the above operations, the decoding end obtains the i-th prediction value of the current block based on the N pieces of first motion information.

The specific manner of obtaining the i-th prediction value of the current block based on the N pieces of first motion information in operation S102-B is not limited in the embodiment of the present disclosure.

In some embodiments, the decoding end directly predicts the current block by using the N pieces of first motion information to obtain the i-th prediction value of the current block. Specifically, for each of the N pieces of first motion information, the decoding end obtains a reference picture corresponding to the first motion information based on the reference picture information included in the first motion information; and obtains a reference block of the current block in the reference picture based on the first motion vector included in the first motion information. In this way, the decoding end obtains one reference block of the current block for each of the N first motion information pieces; and then obtains N reference blocks of the current block. Based on the N reference blocks, the i-th prediction value (or i-th prediction block) of the current block may be obtained.

In some embodiments, it may be seen from the above that each of the N pieces of first motion information includes one first motion vector, so that the N pieces of first motion information correspond to N first motion vectors. In this case, the operation S102-B includes operations S102-B1 and S102-B2.

In operation S102-B1, at least one first motion vector of the N first motion vectors is improved to obtain at least one second motion vector.

In operation S102-B2: the i-th prediction value of the current block is obtained based on the at least one second motion vector.

In this embodiment, in order to further improve the prediction accuracy for the current block by the N-directional prediction mode, at least one first motion vector of the N first motion vectors corresponding to the N-directional prediction mode is improved to obtain at least one second motion vector. For example, the first motion vector mvL0 and/or the first motion vector mvL1 is improved. The second motion vector may be understood as the improved first motion vector. In this way, the i-th prediction value of the current block may be obtained based on the at least one second motion vector obtained by improving the at least one first motion vector.

In an example, if the decoding end improves all of the N first motion vectors, then N second motion vectors may be obtained; N reference blocks may be obtained based on the N second motion vectors; and the i-th prediction value of the current block may be obtained based on the N reference blocks.

In another example, if the decoding end improves a part of the first motion vectors of the N first motion vectors but does not improve the other part of the first motion vectors, then the decoding end obtains a part of the reference blocks of the current block based on a part of the second motion vectors obtained by improving; obtains the other part of the reference blocks of the current block based on the unimproved part of the first motion vectors, i.e., a total of N reference blocks of the current block is obtained; and then obtains the i-th prediction value of the current block based on the N reference blocks.

In the embodiment of the present disclosure, the specific manners of improving the first motion vector to obtain the second motion vector include, but are not limited to, the following first manner and second manner.

In the first manner, the first motion vector is improved by using a motion vector difference. In this case, the operation S102-B1 includes the following operations S102-B1-A1 to S102-B1-A3.

In operation S102-B1-A1, motion vector difference information is determined.

In operation S102-B1-A2, a first motion vector difference is obtained based on the motion vector difference information.

In operation S102-B1-A3, the at least one first motion vector of the N first motion vectors is improved based on the first motion vector difference, to obtain the at least one second motion vector.

In the first manner, when the decoding end determines that at least one first motion vector of the N first motion vectors is improved by using the motion vector difference, the decoding end firstly determines the motion vector difference information; then obtains the the motion vector difference by using the motion vector difference information; and then improves the at least one first motion vector by using the first motion vector difference to obtain at least one second motion vector.

The specific content of the motion vector difference information is not limited in the embodiment of the present disclosure, and the motion vector difference information may be any information used for deriving the first motion vector difference.

In some embodiments, the motion vector difference information includes a direction index mmvd_direction_idx and a distance index mmvd_distance_idx. In an example, the direction index mmvd_direction_idx and the distance index mmvd_distance_idx are preset values (or default values). In another example, the encoding end writes the determined direction index mmvd_direction_idx and the distance index mmvd_distance_idx into the bitstream, so that the decoder decodes the bitstream to obtain the direction index mmvd_direction_idx and the distance index mmvd_distance_idx. Correspondingly, the operation that the first motion vector difference is obtained based on the motion vector difference information in S102-B1-A2 includes: the first motion vector difference is obtained based on the direction index mmvd_direction_idx and the distance index mmvd_distance_idx.

For example, the direction of the motion vector difference in the embodiment of the present disclosure includes: a unilateral horizontal direction, a unilateral vertical direction, a direction of top-left 45 degrees, a direction of bottom-left at 45 degrees, a direction of top-right at 45 degrees, a direction of bottom-right at 45 degrees, etc.

In some embodiments, before the decoding end decodes the bitstream to obtain the direction index mmvd_direction_idx and the distance index mmvd_distance_idx, the decoding end firstly determines whether the i-th prediction mode is improved by using the motion vector difference. Specifically, the bitstream is decoded to obtain first information, where the first information indicates whether the i-th prediction mode is improved by using the motion vector difference. If the first information indicates that the i-th prediction mode is improved by using the motion vector difference, the bitstream is decoded to obtain the direction index and the distance index.

In an example, a specific process of obtaining the first motion vector difference based on the direction index mmvd_direction_idx and the distance index mmvd_distance_idx may be that: firstly, the decoding end obtains the distance information MmvdDistance from Table 7 based on the direction index mmvd_direction_idx; obtains the direction information MmvdSign from Table 8 based on the direction index mmvd_direction_idx; and then obtains the first motion vector difference based on the MmvdDistance and MmvdSign.

In some embodiments, the operation of improving the first motion vector includes: the two components x, y, are respectively improved. Exemplarily, the decoding end obtains the first motion vector difference based on the following formula (1):

$$MmvdOffset [ x 0 ] [ y 0 ] [ 0 ] = ( MmvdDistance [ x 0 ] [ y 0 ] << 2 ) ⋆ MmvdSign [ x 0 ] [ y 0 ] [ 0 ] , \qquad ( 1 )$$

$$MmvdOffset [ x 0 ] [ y 0 ] [ 1 ] = ( MmvdDistance [ x 0 ] [ y 0 ] << 2 ) ⋆ MmvdSign [ x 0 ] [ y 0 ] [ 1 ] ,$$

where the MmvdOffset[x0][y0][0] represents a first motion vector difference in the x direction, MmvdOffset[x0][y0][1] represents a first motion vector difference in the y direction, MmvdDistance [x0][y0] represents a distance in the x direction, MmvdDistance [x0][y0] represents a distance in the y direction, MmvdSign [x0][y0][0] represents a Mmvd symbol in the x direction, and MmvdSign [x0][y0][1] represents a Mmvd symbol in the y direction.

After the decoding end determines the first motion vector difference based on the above operations, the decoding end improves at least one first motion vector of the N first motion vectors based on the first motion vector difference to obtain at least one second motion vector.

In the embodiment of the present disclosure, the implementations of the operation S102-B1-A3 include, but are not limited to, the following manner 1 to manner 3.

In the manner 1, the decoding end improves all of the N first motion vectors based on the first motion vector difference to obtain N second motion vectors.

For example, it is assumed that the N first motion vectors include a first one of the N first motion vectors and a second one of the N first motion vectors, the first one of the N first motion vectors is improved by using the first motion vector difference to obtain a first one of second motion vectors, and the second one of the N first motion vectors is improved by using the first motion vector difference to obtain a second one of the second motion vectors.

The specific manner of improving the first motion vector by using the first motion vector difference is not limited in the embodiment of the present disclosure. For example, the first motion vector is directly compensated by using the first motion vector difference to obtain the second motion vector. For another example, preset processing is performed on the first motion vector difference, and the first motion vector is compensated by the processed first motion vector difference to obtain the second motion vector.

In an example, the first motion vector difference is added to the first motion vector to obtain the second motion vector.

For example, if the N first motion vectors include a first one of the N first motion vectors mvL0 and a second one of the N first motion vectors mvL1, the decoding end obtains the second motion vector by using the following formula (2):

$$mvL {0}^{′} = mvL 0 + MmvdOffset , \qquad ( 2 )$$

$$mvL {1}^{′} = mvL 1 + MmvdOffset ,$$

where the MmvdOffset is the first motion vector difference, the mvL0′ is a first one of the second motion vectors obtained by improving the first one of the N first motion vectors mvL0, and mvL1′ is a second one of the second motion vectors obtained by improving the one of the N second first motion vectors mvL1.

In some embodiments, the improvement of each of the mvL0 and the mvL1 is to respectively improve the component x and component y. In this case, the second motion vector may be obtained based on the following formula (3):

$$mvL {0}^{′} = mvL 0 [ 0 ] + MmvdOffset [ 0 ] , \qquad ( 3 )$$

$$mvL {0}^{′} = mvL 0 [ 1 ] + MmvdOffset [ 1 ] ,$$

$$mvL {1}^{′} = mvL 1 [ 0 ] + MmvdOffset [ 0 ] ,$$

$$mvL {1}^{′} = mvL 1 [ 1 ] + MmvdOffset [ 1 ] ,$$

where 0 represents the x direction, 1 represents the y direction, MmvdOffset[0] represents the first motion vector difference in the x direction, and MmvdOffset[1] represents the first motion vector difference in the y direction. As shown in the above formula (3), the first one of the N first motion vectors mvL0 [0] in the x direction is improved by using the first motion vector difference MmvdOffset[0] in the x direction to obtain the first one of the second motion vectors mvL0′ [0] in the x direction; the first one of the N first motion vectors mvL0 [1] in the y direction is improved by using the first motion vector difference MmvdOffset[1] in the y direction to obtain the first one of the second motion vectors mvL0′ [1] in the y direction; the second one of the N first motion vectors mvL1 [0] in the x direction is improved by using the first motion vector difference MmvdOffset[0] in the x direction to obtain the second one of the second motion vectors mvL1′ [0] in the x direction; and the second one of the N first motion vectors mvL1 [1] in the y direction is improved by using the first motion vector difference MmvdOffset[1] in the y direction to obtain the second one of the second motion vectors mvL1′ [1] in the y direction.

In the manner 2, the decoding end improves a part of the N first motion vectors by using the first motion vector difference, and improves the other part of the N first motion vectors by using the second motion vector difference. In this case, the operation S102-B1-A3 includes the following operations S102-B1-A3-11 to S102-B1-A3-13.

In operation S102-B1-A3-11, the first one of the N first motion vectors is improved based on the first motion vector difference to obtain a first one of second motion vectors.

In operation S102-B1-A3-12, a second motion vector difference is determined based on the first motion vector difference.

In operation S102-B1-A3-13, the second one of the N first motion vectors is improved based on the second motion vector difference to obtain a second one of the second motion vectors.

In the manner 2, for convenience of description, it is assumed that the N first motion vectors include the first one of the N first motion vectors and the second one of the N first motion vectors, so that the decoding end directly compensates the first one of the N first motion vectors based on the first motion vector difference to obtain the first one of second motion vectors. Moreover, the second motion vector difference is obtained by using the first motion vector difference; and the second one of the N first motion vectors is compensated by using the second motion vector difference, to obtain the second one of second motion vectors. It is to be noted that, the N first motion vectors including two first motion vectors is taken as an example in the manner 2, but the specific number of the N first motion vectors is not limited in the embodiment of the present disclosure. That is to say, when N is a positive integer larger than 2, the N first motion vectors may be improved by the manner 2.

In the manner 2, a specific manner of improving the first one of the N first motion vectors based on the first motion vector difference to obtain the first one of the second motion vectors may be referred to the related description in the manner 1. For example, the first motion vector difference is added to the first one of the N first motion vectors to obtain the first one of the second motion vectors. Specifically, the detailed description of the above formula (2) and formula (3) may be referred to, which is not repeated herein.

Hereinafter, a specific process of determining the second motion vector difference based on the first motion vector difference in operation S102-B1-A3-12 may be described.

In a possible implementation, the first motion vector difference is processed based on a deviation between the first one of the N first motion vectors and the second one of the N first motion vectors to obtain the second motion vector difference. For example, the deviation between the first one of the N first motion vectors and the second one of the N first motion vectors is added to the first motion vector difference to obtain the second motion vector difference.

In a possible implementation, the operation S102-B1-A3-12 includes the following operations S102-B1-A3-121 and S102-B1-A3-122.

In operation S102-B1-A3-121, a picture order count of a first reference picture corresponding to the first one of the N first motion vectors, a picture order count of a current picture, and a picture order count of a second reference picture corresponding to the second one of the N first motion vectors are determined.

In operation S102-B1-A3-122, the second motion vector difference is determined based on the picture order count of the first reference picture, the picture order count of the current picture, the picture order count of the second reference picture and the first motion vector difference.

As may be seen from the above, since each of the N pieces of first motion information corresponds to one reference picture and one motion vector, for each piece of motion information, the reference picture corresponding to the motion information is used as the reference picture corresponding to the first motion vector corresponding to the motion information. For convenience of description, in the embodiment of the present disclosure, the reference picture corresponding to the first one of the N first motion vectors is recorded as a first reference picture, and a reference picture corresponding to a second one of the N first motion vectors is recorded as a second reference picture.

In this implementation, the decoding end determines the picture order count of the first reference picture corresponding to the first one of the N first motion vectors, the picture order count of the current picture, and the picture order count of the second reference picture corresponding to the second one of the N first motion vectors; and further determines the second motion vector difference based on the picture order count of the first reference picture, the picture order count of the current picture, the picture order count of the second reference picture, and the first motion vector difference.

The specific manner of determining the second motion vector difference based on the picture order count of the first reference picture, the picture order count of the current picture, the picture order count of the second reference picture, and the first motion vector difference is not limited in the embodiment of the present disclosure.

In an example, the first motion vector difference is mapped based on an association between the picture order count of the first reference picture, the picture order count of the current picture, and the picture order count of the second reference picture, to obtain the second motion vector difference.

In another example, the decoding end determines a first difference value between the picture order count of the second reference picture and the picture order count of the current picture; determines a second difference value between the picture order count of the first reference picture and the picture order count of the current picture; and obtains the second motion vector difference based on the first difference value, the second difference value, and the first motion vector difference.

For example, a difference between the first difference value and the second difference value is determined, and the difference is added to the first motion vector difference to obtain the second motion vector difference.

For another example, a ratio between the first difference value and the second difference value is determined; and a product of the ratio and the first motion vector difference is determined as the second motion vector difference. Exemplarily, the second motion vector difference is obtained based on the following formula (4):

$${MmvdOffset}^{′} = ( poc 1 - pocC ) / ( poc 0 - poc C ) ⋆ MmvdOffset , \qquad ( 4 )$$

where the MmvdOffset′ is the second motion vector difference, the poc1 is the picture order count of the second reference picture, the pocC is the picture order count of the current picture, the poc0 is the picture order count of the first reference picture, the poc1−pocC is the first difference value, the poc0−pocC is the second difference value, the (poc1−pocC)/(poc0−pocC) is the ratio between the first difference value and the second difference value, and the MmvdOffset is the first motion vector difference.

After the second motion vector difference is obtained based on the above operations, the second one of the N first motion vectors is improved based on the second motion vector difference to obtain the second one of the second motion vectors. The manner where the decoding end improves the second one of the N first motion vectors by using the second motion vector difference is basically the same as the manner where the decoding end improves the first one of the N first motion vectors by using the first motion vector difference.

For example, the second motion vector difference is added to the second one of the N first motion vectors to obtain the second one of the second motion vectors.

In this first manner, in addition to improving the N first motion vectors by using the manner 1 or the manner 2 described above, the decoding end may also improve the N first motion vectors by using the following manner 3.

In the manner 3, the decoding end improves a part of the N first motion vectors by using the first motion vector difference, and improves the other part of the N first motion vectors in a manner of matching search. In this case, the operation S102-B1-A3 includes the following operations S102-B1-A3-21 to S102-B1-A3-22.

In operation S102-B1-A3-21, the first one of the N first motion vectors is improved based on the first motion vector difference to obtain a first one of second motion vectors.

In operation S102-B1-A3-22, a matching search is performed, based on the second one of the N first motion vectors, within a preset search range of a reference picture corresponding to the second one of the N first motion vectors, to obtain the second one of the second motion vectors.

In the manner 3, for convenience of description, it is assumed that the N first motion vectors include the first one of the N first motion vectors and the second one of the N first motion vectors, so that the decoding end directly compensates the first one of the N first motion vectors based on the first motion vector difference to obtain the first one of second motion vectors. Moreover, based on the second one of the N first motion vectors, the matching search is performed within the preset search range of the reference picture corresponding to the second one of the N first motion vectors, to obtain the second one of the second motion vectors. For example, through the search within a small rage, a motion vector corresponding to a reference block having the highest matching degree with a reference block in a first reference picture corresponding to the first one of the N first motion vectors is searched, and used as the second one of the second motion vectors. It is to be noted that, the N first motion vectors including two first motion vectors is taken as an example in the manner 3, but the specific number of the N first motion vectors is not limited in the embodiment of the present disclosure. That is to say, when N is a positive integer larger than 2, the N first motion vectors may be improved by the manner 3.

In the manner 3, a specific manner of improving the first one of the N first motion vectors based on the first motion vector difference to obtain the first one of the second motion vectors may be referred to the related description in the manner 1. For example, the first motion vector difference is added to the first one of the N first motion vectors to obtain the first one of the second motion vectors. Specifically, the detailed description of the above formula (2) and formula (3) may be referred to, which is not repeated herein.

Hereinafter, a specific process where the matching search is performed, based on the second one of the N first motion vectors, within a preset search range of a reference picture corresponding to the second one of the N first motion vectors, to obtain the second one of the second motion vectors in operation S102-B1-A3-22 is described.

As may be seen from the above, the reference picture corresponding to the second one of the N first motion vectors is recorded as the second reference picture, so that the decoding end performs the search within a preset search range of the second reference picture based on the second one of the N first motion vectors to obtain multiple reference blocks; selects one reference block from the multiple reference blocks; and determines a motion vector corresponding to the reference block as the second one of the second motion vectors.

The specific manner were the matching search is performed, based on the second one of the N first motion vectors, within a preset search range of a reference picture corresponding to the second one of the N first motion vectors, to obtain the second one of the second motion vectors is not limited in the embodiment of the present disclosure.

In some embodiments, the decoding end performs whole-block search, i.e., the decoding end searches for multiple reference blocks corresponding to the current block from the second reference picture; selects one reference block from the multiple reference blocks; and determines the motion vector corresponding to the reference block as the second one of the second motion vectors. For example, based on the first one of the second motion vectors, one reference block of the current block in the first reference picture (i.e., the reference picture corresponding to the first one of the N first motion vectors) is determined and denoted as the reference block 1; each of multiple reference blocks searched from the second reference picture is matched with the reference block 1, to obtain one reference block having the highest matching degree (or the smallest matching cost) with the reference block 1, and a motion vector corresponding to the reference block is determined as the second one of the second motion vectors.

In some embodiments, the decoding end may perform sub-block search, i.e., each of sub-blocks of the current block is separately improved. In this case, the operation S102-B1-A3-22 includes the following operations S102-B1-A3-221 and S102-B1-A3-222.

In operation S102-B1-A3-221, the current block is partitioned into at least one first sub-block.

In operation S102-B1-A3-222, for any one of the at least one first sub-block, the matching search is performed within the preset search range of the reference picture corresponding to the second one of the N first motion vectors to obtain the second one of the second motion vectors corresponding to the first sub-block.

It is to be noted that, in this embodiment, if the at least one first sub-block includes one first sub-block, and the first sub-block has a size being the same as the size of the current block, then the decoding end performs the whole-block search in a unit of the current block. In this embodiment, if the first sub-block has a size smaller than the size of the current block, then the decoding end performs the search in a part of area in the current block to obtain an second motion vector subjected to the improvement of the part of area, and then predicts and optimizes a picture of the part of area based on the second motion vector subjected to the improvement, to improve a picture decoding effect for the part of area.

The size and shape of at least one first sub-block partitioned from the current block is not limited in the embodiment of the present disclosure. Exemplarily, the size of the first sub-block is 4×4, 8×8, 16×16, etc. In some embodiments, the decoding end may partition the whole current block into one or more first sub-blocks, i.e., there is no area that is not partitioned in the current block. In some embodiments, the decoding end partitions a part of area in the current block into at least one first sub-block, and the decoding end does not partition the other area in the current block.

The manners where the decoding end performs the matching search on each of the at least one first sub-block obtained by the partitioning to obtain the second one of the second motion vectors corresponding to the first sub-block are the same as each other. For convenience of description, one first sub-block is taken as an example to describe.

The specific manner where the matching search is performed within the preset search range of the reference picture corresponding to the second one of the N first motion vectors to obtain the second one of the second motion vectors corresponding to the first sub-block in the operation S102-B1-A3-222 is not limited in the embodiment of the present disclosure.

In some embodiments, the second one of the N first motion vectors is used as a search start point, the decoding end performs the matching search within the preset search range of the second reference picture, to obtain multiple first reference sub-blocks corresponding to the first sub-block. Furthermore, one first reference sub-block is selected from the multiple first reference sub-blocks, and a motion vector corresponding to the first reference sub-block is determined as a second one of the second motion vectors corresponding to the first sub-block. Exemplarily, a manner of selecting the first reference sub-block from the multiple first reference sub-blocks may be that: the multiple first reference sub-blocks are matched with each other to obtain a first reference sub-block corresponding to the smallest matching cost, and a motion vector corresponding to the first reference sub-block as the second one of the second motion vectors corresponding to the first sub-block.

In some embodiments, the operation S102-B1-A3-222 includes the following operations S102-B1-A3-2221 to S102-B1-A3-2224.

In operation S102-B1-A3-2221, a search starting point corresponding to the second one of the N first motion vectors is determined, and search is performed, by using the search starting point as a starting point, within the preset search range of the reference picture corresponding to the second one of the N first motion vectors to obtain multiple first reference sub-blocks corresponding to the first sub-block.

In operation S102-B1-A3-2222, a second reference sub-block corresponding to the first sub-block is determined, based on the first one of the second motion vectors, from a reference picture corresponding to the first one of the N first motion vectors.

In operation S102-B1-A3-2223, matching costs between the multiple first reference sub-blocks and the second reference sub-block are determined, and a first reference sub-block corresponding to a smallest matching cost is selected from the multiple first reference sub-blocks.

In operation S102-B1-A3-2224, the second one of the second motion vectors corresponding to the first sub-block is obtained based on a motion vector corresponding to the first reference sub-block corresponding to the smallest matching cost.

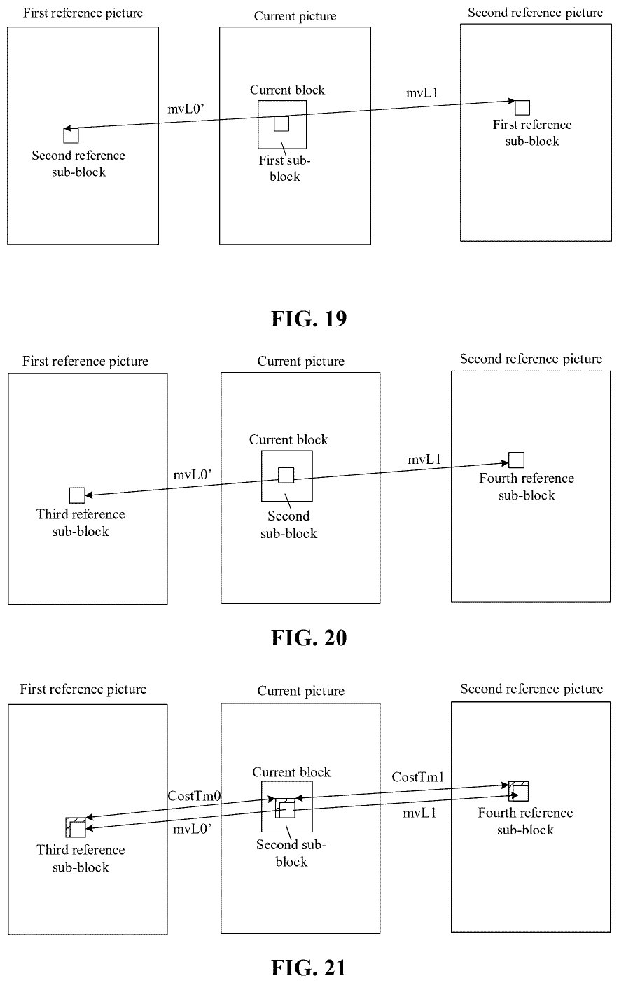

As may be seen from the above, the reference picture corresponding to the first one of the N first motion vectors is denoted as the first reference picture, and the reference picture corresponding to the second one of the N first motion vectors is denoted as the second reference picture. In this way, for each of the at least one first sub-block of the current block, as shown in FIG. 19, the decoding end determines multiple first reference sub-blocks corresponding to the first sub-block from the second reference picture based on the second one of the N first motion vectors mvL1; and determines a second reference sub-block corresponding to the first sub-block from the first reference picture based on the first one of the second motion vectors mvL0′. For each of the multiple first reference sub-blocks, a matching cost between the first reference sub-block and the second reference sub-block is determined, for example, the SAD, the SATD or the SSE, etc. between the first reference sub-block and the second reference sub-block is calculated. In this way, matching costs between different first reference sub-blocks and second reference sub-block may be calculated; a first reference sub-block corresponding to the smallest matching cost may be selected from the multiple first reference sub-blocks based on the matching costs; and a second one of the second motion vectors corresponding to the first sub-block may be obtained based on a motion vector corresponding to the first reference sub-block corresponding to the smallest matching cost.

Hereinafter, the specific process of determining the search starting point corresponding to the second one of the N first motion vectors is described.

In an example 1, the second one of the N first motion vectors is directly used as the search starting point. That is to say, the decoding end performing the search within the preset search range of the second reference picture by using the second one of the N first motion vectors as the search starting point, to obtain the multiple first reference sub-blocks corresponding to the first sub-block.

In an example 2, the second one of the N first motion vectors is improved based on the first motion vector difference to obtain an improved second one of the N first motion vectors; and the improved second one of the N first motion vectors is used as the search starting point. The manner of improving the second one of the N first motion vectors based on the first motion vector difference is substantially the same as the manner of improving the first one of the N first motion vectors based on the first motion vector difference. For example, the first motion vector difference is added to the second one of the N first motion vectors to obtain the improved second one of the N first motion vectors. In this way, the decoding end performs the search within the preset search range of the second reference picture by using the improved second one of the N first motion vectors as the search starting point, to obtain the multiple first reference sub-blocks corresponding to the first sub-block.

In an example 3, a second motion vector difference is determined based on the first motion vector difference; the second one of the N first motion vectors is improved based on the second motion vector difference to obtain an improved second one of the N first motion vectors; and the improved second one of the N first motion vectors is used as the search starting point. The specific process of determining the second motion vector difference based on the first motion vector difference refers to the description of the above-described embodiment, which is not repeatedly described herein. The process of improving the second one of the N first motion vectors based on the second motion vector difference may be the same as that in the above-described embodiment. For example, the second motion vector difference is added to the second first motion vector to obtain the improved second one of the N first motion vectors. In this way, the decoding end performs the search within the preset search range of the second reference picture by using the improved second one of the N first motion vectors as the search starting point, to obtain the multiple first reference sub-blocks corresponding to the first sub-block.

The operation that the second reference sub-block corresponding to the first sub-block is determined, based on the first one of the second motion vectors, from the reference picture corresponding to the first one of the N first motion vectors in S102-B1-A3-2222 includes at least the following manners.

In one manner, in a unit of the first sub-block, the second reference sub-block corresponding to the first sub-block is directly determined from the first reference picture based on the first one of the second motion vectors. That is to say, in this manner, for the first sub-block 1, the second reference sub-block corresponding to the first sub-block 1 is searched in the first reference picture; for the first sub-block 2, the second reference sub-block corresponding to the first sub-block 2 is searched in the first reference picture, and so on.

In the other manner, a reference block corresponding to the current block is firstly determined, and a second reference sub-block corresponding to each first sub-block is determined from the reference block. Specifically, the decoding end determines the reference block corresponding to the current block from the first reference picture based on the first one of the second motion vectors. Furthermore, for each first sub-block of the current block, the second reference sub-block corresponding to each first sub-block is determined from the reference blocks corresponding to the current block.

It is to be noted that, in some embodiments, after every time one first reference sub-block is searched, the decoding end may match the first reference sub-block with the second reference sub-block to obtain a matching cost between the first reference sub-block and the second reference sub-block. In some embodiments, the decoding end may firstly perform the search to obtain multiple first reference sub-blocks; and then perform one-to-one matching between each of the multiple first reference sub-blocks with the second reference sub-block to obtain a matching cost between each of the first reference sub-blocks and the second reference sub-block.

Hereinafter, a process of determining the matching cost between the first reference sub-block and the second reference sub-block is described.

The specific process of determining the matching cost between the first reference sub-block and the second reference sub-block is not limited in the embodiment of the present disclosure.

In some embodiments, since both the first reference sub-block and the second reference sub-block are picture blocks in the decoded reference picture, a sample value of each sample of the first reference sub-block and the second reference sub-block is known. Based on this, the decoding end may compare the sample value of each sample of the first reference sub-block with the sample value of the corresponding sample of the second reference sub-block, to obtain the matching cost between the first reference sub-block and the second reference sub-block. For example, a difference value between the sample value of the sample 1 of the first reference sub-block and the sample value of the sample 1 of the second reference sub-block is determined, a difference value between the sample value of the sample 2 of the first reference sub-block and the sample value of the sample 2 of the second reference sub-block is determined, and so on. Difference values between the samples in the first reference sub-block and the samples in the second reference sub-block are determined; and matching cost between the first reference sub-block and the second reference sub-block is obtained based on the difference values between the samples. For example, the sum of the difference values between the samples in the first reference sub-block and the samples in the second reference sub-block is determined as the matching cost between the first reference sub-block and the second reference sub-block.

In some embodiments, when the embodiment of the present disclosure is applied to the GPM, the matching cost between the first reference sub-block and the second reference sub-block may be determined by the following operations 1 to 3, i.e., as described in the foregoing.

In operation 1, a weight derivation mode for the current block is determined.

In operation 2, a weight corresponding to the i-th prediction mode is determined based on the weight derivation mode.

In operation 3, for any one of the multiple first reference sub-blocks, a matching cost between the first reference sub-block and the second reference sub-block is obtained based on the weight corresponding to the i-th prediction mode and the first reference sub-block and the second reference sub-block.

In this embodiment, the i-th prediction mode is the N-directional prediction mode, and the prediction block predicted by the N-directional prediction mode is used in the GPM. That is to say, for a prediction block having the size being the same as the size of the current block, a part of the prediction block (i.e., the part having a non-zero weight) will work, and the other part of the prediction block (i.e., the part having a weight of 0) will not work. Therefore, when the matching cost is calculated for the N-directional prediction, a mask similar to the GPM prediction may be used for the manner of calculating the matching cost. Specifically, the weight derivation mode for the current block is determined, and a specific manner of determining the weight derivation mode for the current block may refer to the description of the above-described embodiment. For example, the weight derivation mode for the current block and the K prediction modes are determined as a combination. Furthermore, the weight corresponding to the i-th prediction mode may be determined based on the weight derivation mode for the current block. For example, if the weight derivation mode for the current block is mode 45 in FIG. 4, if the i-th prediction mode is the first one of the prediction modes for the current block, areas where the weight corresponding to the i-th prediction mode is not 0 is the white area and the gray area; and if the i-th prediction mode is the second one of the prediction modes for the current block, areas where the weight corresponding to the i-th prediction mode is not 0 is the black area and the gray area. In this way, the matching cost between the first reference sub-block and the second reference sub-block may be obtained based on the weight corresponding to the i-th prediction mode.

The specific manners where the matching cost between the first reference sub-block and the second reference sub-block is obtained based on the weight corresponding to the i-th prediction mode and the first reference sub-block and the second reference sub-block in the operation 3 include, but are not limited to, the following several implementations.

In a possible implementation, based on the weight corresponding to the i-th prediction mode, only the areas where the weight corresponding to the i-th prediction mode is not zero in the first reference sub-block and the second reference sub-block are processed to obtain the matching cost between the first reference sub-block and the second reference sub-block.

In another possible implementation, the decoding end obtains a first differential value based on the first reference sub-block and the second reference sub-block; and multiplies the weight corresponding to the i-th prediction mode with the first differential value, to obtain the matching cost between the first reference sub-block and the second reference sub-block. The manner of obtaining the first differential value based on the first reference sub-block and the second reference sub-block may be that: a difference value between the first reference sub-block and the second reference sub-block is determined as the first differential value, or an absolute value of a difference value between the first reference sub-block and the second reference sub-block is determined as the first differential value, or may be that: the difference value between the first reference sub-block and the second reference sub-block is determined, and preset processing is performed on the difference value to obtain the first differential value.

In an example, the matching cost SADwithMask1 between the first reference sub-block and the second reference sub-block may be obtained according to the following formula (10):

$$SADwithMask 1 = \sum wValue [ x ] [ y ] ⋆ abs ( RefValue 0 [ x ] [ y ] - RefValue 1 [ x ] [ y ] ) ) , \qquad ( 10 )$$

where the wValue is a weight corresponding to the i-th prediction mode at the position (x, y) position, the RefValue0[x][y] is a value corresponding to the second reference sub-block at the position (x, y), and the RefValue1[x][y] is a value corresponding to the first reference sub-block at the position (x, y).

In some embodiments, the manner of calculating the wValue may also be simplified, for example, the w Value for calculating the SADwithMask1 is simplified to have a value of only 0 and 1, to facilitate calculation.

Based on the above operations, the decoding end may determine the matching cost between each of the multiple first reference sub-blocks and the second reference sub-block, select one first reference sub-block corresponding to the smallest matching cost from the multiple first reference sub-blocks based on the matching costs, and further obtain a second one of the second motion vectors corresponding to the first sub-block based on the motion vector corresponding to the first reference sub-block corresponding to the smallest matching cost.

In a possible implementation, the decoding end may directly determine the motion vector corresponding to the first reference sub-block corresponding to the smallest matching cost as the second one of the second motion vectors corresponding to the first sub-block.

In another possible implementation, a fractional-pixel search may be performed for higher precision, such as ½ pixel precision, ¼ pixel precision, 1/16 pixel precision, etc. Specifically, the fractional-pixel search is performed within a surrounding area of the first reference sub-block corresponding to the smallest matching cost to obtain a motion vector of a first fractional-pixel; and the second one of the second motion vectors corresponding to the first sub-block is obtained based on the motion vector of the first fractional-pixel and the motion vector corresponding to the first reference sub-block corresponding to the smallest matching cost.

The specific process of determining the second one of the second motion vectors corresponding to one first sub-block is described above, and the above manner may be adopted for each first sub-block of the current block to determine the second one of the second motion vectors corresponding to each first sub-block; and then a prediction value of each first sub-block in the i-th prediction mode is obtained based on the first one of the second motion vectors and the second one of the second motion vectors that correspond to each first sub-block.

The specific process of improving at least one first motion vector of the N first motion vectors based on the motion vector difference in the first manner is described above. As may be seen from the above, the improvement of at least one first motion vector of the N first motion vectors based on the motion vector difference may be performed in any one of the manner 1 to manner 3. In some embodiments, if the current block is partitioned into multiple first sub-blocks, some of the first sub-blocks may be improved by the above-described manne1, some of the first sub-blocks may be improved by the above-described manne2, and some of the sub-blocks may be improved by the above-described manne3. That is to say, the first sub-block of the current block may be improved in at least two of the manner 1, manner 2, and manner 3.

In addition to improving the at least one first motion vector of the N first motion vectors by using the method described in the first manner, the decoding end may improve the first motion vector by using the method in the following second manner.

In the second manner, the operation S102-B1 includes the following operation S102-B1-B.

In operation S102-B1-B, based on the at least one first motion vector, a matching search is performed within a preset search range of a reference picture corresponding to the at least one first motion vector, to obtain the at least one second motion vector.

In the second manner, the manner of search is used for each of the at least one first motion vector of the N first motion vectors, to obtain the second motion vector of the first motion vector to be improved.

For example, it is assumed that the first one of the N first motion vectors and the second one of the N first motion vectors are improved, then the first one of the N first motion vectors and the second one of the N first motion vectors may be improved through bilateral matching. For example, the decoding end simultaneously searches both the first one of the N first motion vectors and the second one of the N first motion vectors, and one reference block is obtained for each searched MV; the matching cost (such as, the SAD, the SATD or the SSE) between two reference blocks is calculated. It is to be noted that when the bi-directional matching search is performed, two MVs may move simultaneously, or one MV may be fixed and the other MV moves, and then the one MV move and the other MV may be fixed in reverse. Under a preset search rule, two MVs corresponding to the smallest matching cost are found and used as optimized MVs, i.e., used as the first one of the second motion vectors and the second one of the second motion vectors.

The specific manner where based on the at least one first motion vector, a matching search is performed within a preset search range of a reference picture corresponding to the at least one first motion vector, to obtain the at least one second motion vector is not limited in the embodiment of the present disclosure.

In some embodiments, the decoding end performs whole-block search, i.e., the decoding end searches for multiple reference blocks corresponding to the current block from the reference picture; selects one reference block from the multiple reference blocks; and determines the motion vector corresponding to the reference block as one second motion vectors. For example, a reference block 1 is searched from the first reference picture based on a first one of the N first motion vectors, a reference block 2 is searched from the second reference picture based on a second one of the N first motion vectors; a matching cost between the reference block 1 and the reference block 2 is calculated; two reference blocks having the highest matching degree (i.e., the smallest matching cost) may be obtained; and the motion vectors corresponding to the two reference blocks are determined as the first one of the second motion vectors and a second one of the second motion vectors.

In some embodiments, the decoding end may perform sub-block search, i.e., each of sub-blocks of the current block is separately improved. In this case, the operation S102-B1-B includes the following operations S102-B1-B1 to S102-B1-B4.

In operation S102-B1-B1, the current block is partitioned into at least one second sub-block.

In operation S102-B1-B2, for any one of the at least one second sub-block, the matching search is performed within a preset search range of a reference picture corresponding to the first one of the at least one first motion vector, to obtain multiple third reference sub-blocks corresponding to the second sub-block, and the matching search is performed within a preset search range of a reference picture corresponding to the second one of the at least one first motion vector, to obtain multiple fourth reference sub-blocks corresponding to the second sub-block.

In operation S102-B1-B3, matching costs between the multiple third reference sub-blocks and the multiple fourth reference sub-blocks are determined, and a third reference sub-block and a fourth reference sub-block corresponding to a smallest matching cost are selected from the multiple third reference sub-blocks and the multiple fourth reference sub-blocks.

In operation S102-B1-B4, a first one of second motion vectors corresponding to the second sub-block is obtained based on a motion vector corresponding to the third reference sub-block corresponding to the smallest matching cost, and a second one of the second motion vectors corresponding to the second sub-block is obtained based on a motion vector corresponding to the fourth reference sub-block corresponding to the smallest matching cost.

In this embodiment, for convenience of description, it is assumed that at least one first motion vector to be improved of the N first motion vectors includes a first one of the N first motion vectors and a second one of the N first motion vectors. In this case, the decoding end improves the first one of the N first motion vectors and the second one of the N first motion vectors by searching to obtain two second motion vectors. It is to b noted that although the first motion vectors to be improved being two first motion vectors is taken as an example to describe in the present embodiment, the specific number of the first motion vectors to be improved of the N first motion vectors is not limited in the present embodiment. That is to say, if the number of first motion vectors to be improved is more than two, the manner of search in the embodiment of the present disclosure may also be used for improving the multiple first motion vectors.

In this embodiment, the current block may be partitioned into at least one second sub-block, and each second sub-block is separately improved.

It is to be noted that, in this embodiment, if the at least one second sub-block includes one second sub-block, and the second sub-block has a size being same as the size of the current block, then the decoding end performs the whole-block search in a unit of the current block. In this embodiment, if the second sub- has a size smaller than the size of the current block, then the decoding end performs the search in a part of area in the current block to obtain an second motion vector subjected to the improvement of the part of area, and then predicts and optimizes a picture of the part of area based on the second motion vector subjected to the improvement, to improve a picture decoding effect for the part of area.

The size and shape of at least one second sub-block partitioned from the current block is not limited in the embodiment of the present disclosure. Exemplarily, the size of the second sub-block is 4×4, 8×8, 16×16, etc. In some embodiments, the decoding end may partition the whole current block into one or more second sub-blocks, i.e., there is no area that is not partitioned in the current block. In some embodiments, the decoding end partitions a part of area in the current block into at least one second sub-block, and the decoding end does not partition the other area in the current block.

The manners where the decoding end performs the matching search on all second sub-blocks of the at least one second sub-block obtained by the partitioning to obtain the second motion vectors corresponding to the second sub-blocks are the same as each other. For convenience of description, one second sub-block is taken as an example to describe.

Specifically, as shown in FIG. 20, the decoding end searches in the first reference picture by using the first one of the at least one first motion vector as the search starting point to obtains of the multiple third reference sub-blocks corresponding to the second sub-block; searches in the second reference picture by using the second one of the at least one first motion vector as the search starting point to obtain the multiple fourth reference sub-blocks corresponding to the second sub-block. Then, the matching cost between each pair of the third reference sub-block and the fourth reference sub-block of the multiple third reference sub-blocks and the multiple fourth reference sub-blocks is calculated; and a pair of the third reference sub-block and the fourth reference sub-block corresponding to the smallest matching cost is obtained. In this way, the first one of the second motion vectors corresponding to the second sub-block may be obtained based on the motion vector corresponding to the third reference sub-block corresponding to the smallest matching cost, and the second one of the second motion vectors corresponding to the second sub-block may be obtained based on the motion vector corresponding to the fourth reference sub-block corresponding to the smallest matching cost.

It is to be noted that, in some embodiments, after one third reference sub-block and one fourth reference sub-block are searched, the decoding end may match the third reference sub-block with the fourth reference sub-block to obtain a matching cost between the third reference sub-block and the fourth reference sub-block. In some embodiments, the decoding end may firstly obtain multiple third reference sub-blocks and multiple fourth reference sub-blocks by searching, and then perform one-to-one matching between each of the multiple third reference sub-blocks and each of the multiple fourth reference sub-blocks, to obtain the matching cost between each third reference sub-block and each fourth reference sub-block.

Hereinafter, a process of determining the matching cost between the third reference sub-block and the fourth reference sub-block is described.

The specific process of determining the matching cost between the third reference sub-block and the fourth reference sub-block is not limited in the embodiment of the present disclosure.

In some embodiments, the operation S102-B1-B3 includes the operations S102-B1-B31 and S102-B1-B32.

In operation S102-B1-B31, for any one of the multiple third reference sub-blocks and any one of the multiple fourth reference blocks, a first matching cost between the third reference sub-block and the fourth reference sub-block is determined.

In operation S102-B1-B32, a matching cost between the third reference sub-block and the fourth reference sub-block is obtained based on the first matching cost.

In this embodiment, for any one of the multiple third reference sub-blocks and any one of the multiple fourth reference blocks, the first matching cost between the third reference sub-block and the fourth reference sub-block is determined. Furthermore, the matching cost between the third reference sub-block and the fourth reference sub-block is determined based on the first matching cost. For example, the first matching cost is determined as the matching cost between the third reference sub-block and the fourth reference sub-block.

Herein, the manner of determining the first matching cost between the third reference sub-block and the fourth reference sub-block in operation S102-B1-B31 may be the same as the manner of determining the matching cost between the first reference sub-block and the second reference sub-block.

In some embodiments, since both the third reference sub-block and the fourth reference sub-block are picture blocks in the decoded reference picture, a sample value of each sample of the third reference sub-block and the fourth reference sub-block is known. Based on this, the decoding end may compare the sample value of each sample of the third reference sub-block with the sample value of the corresponding sample of the fourth reference sub-block, to obtain the matching cost between the third reference sub-block and the fourth reference sub-block. For example, a difference value between the sample value of the sample 1 of the third reference sub-block and the sample value of the sample 1 of the fourth reference sub-block is determined, a difference value between the sample value of the sample 2 of the third reference sub-block and the sample value of the sample 2 of the fourth reference sub-block is determined, and so on. Difference values between the samples in the third reference sub-block and the samples in the fourth reference sub-block are determined; and matching cost between the third reference sub-block and the fourth reference sub-block is obtained based on the difference values between the samples. For example, the sum of the difference values between the samples in the third reference sub-block and the samples in the fourth reference sub-block is determined as the matching cost between the third reference sub-block and the fourth reference sub-block.

In some embodiments, when the embodiment of the present disclosure is applied to the GPM, the matching cost between the third reference sub-block and the fourth reference sub-block may be determined by the following operations S102-B1-B311 to S102-B1-B313. That is to say, the first matching cost between the third reference sub-block and the fourth reference sub-block in the above S102-B1-B31 may include operations S102-B1-B311 to S102-B1-B313.

In operation S102-B1-B311, a weight derivation mode for the current block is determined.

In operation S102-B1-B312, a weight corresponding to the i-th prediction mode is determined based on the weight derivation mode.

In operation S102-B1-B313, the first matching cost between the third reference sub-block and the fourth reference sub-block is obtained based on the weight corresponding to the i-th prediction mode and the third reference sub-block and the fourth reference sub-block.

In this embodiment, the i-th prediction mode is the N-directional prediction mode, and the prediction block predicted by the N-directional prediction mode is used in the GPM. That is to say, for a prediction block having the size being the same as the size of the current block, a part of the prediction block (i.e., the part having a non-zero weight) will work, and the other part of the prediction block (i.e., the part having a weight of 0) will not work. Therefore, when the matching cost is calculated for the N-directional prediction, a mask similar to the GPM prediction may be used for the manner of calculating the matching cost.

The specific manners of determining the weight derivation mode for the current block and determining the weight corresponding to the i-th prediction mode based on the weight derivation mode may be referred to the related descriptions of operation 1 and operation 2, which is not repeated herein.

The specific manners where the first matching cost between the third reference sub-block and the fourth reference sub-block is obtained based on the weight corresponding to the i-th prediction mode and the third reference sub-block and the fourth reference sub-block in operation S102-B1-B313 include, but are not limited to, the following several implementations.

In a possible implementation, based on the weight corresponding to the i-th prediction mode, only the areas where the weight corresponding to the i-th prediction mode is not zero in the third reference sub-block and the fourth reference sub-block are processed to obtain the matching cost between the third reference sub-block and the fourth reference sub-block.

In another possible implementation, the decoding end obtains a second differential value based on the third reference sub-block and the fourth reference sub-block; and multiplies the weight corresponding to the i-th prediction mode with the second differential value, to obtain the first matching cost between the third reference sub-block and the fourth reference sub-block. The manner of obtaining the second differential value based on the third reference sub-block and the fourth reference sub-block may be that: a difference value between the third reference sub-block and the fourth reference sub-block is determined as the second differential value, or an absolute value of the difference value between the third reference sub-block and the fourth reference sub-block is determined as the second differential value, or may be that: the difference value between the third reference sub-block and the fourth reference sub-block is determined, and preset processing is performed on the difference value to obtain the second differential value.

In an example, the first matching cost SADwithMask2 between the third reference sub-block and the fourth reference sub-block may be obtained according to the following formula (11):

$$SADwithMask 2 = \sum wValue [ x ] [ y ] ⋆ abs ( RefValue 0 [ x ] [ y ] - RefValue 1 [ x ] [ y ] ) ) , \qquad ( 11 )$$

where the wValue is a weight corresponding to the i-th prediction mode at the position (x, y) position, the RefValue0[x][y] is a value corresponding to the third reference sub-block at the position (x, y), and the RefValue1[x][y] is a value corresponding to the first reference sub-block at the position.

In some embodiments, the manner of calculating the wValue may also be simplified, for example, the w Value for calculating the SADwithMask1 is simplified to have a value of only 0 and 1, to facilitate calculation.

Based on the above operations, the decoding end may determine the first matching cost between each of the multiple third reference sub-blocks and each of the multiple fourth reference sub-blocks; and obtain the matching cost between the third sub-block and the fourth reference sub-block based on the first matching costs.

In an example, operation S102-B1-B32 includes: the decoding end may directly determine the first matching cost as the matching cost between the third reference sub-block and the fourth reference sub-block.

In another example, the operation S102-B1-B32 includes following operations S102-B1-B321 to S102-B1-B323.

In operation S102-B1-B321, a second matching cost between a template of the third reference sub-block and a template of the second sub-block is determined.

In operation S102-B1-B322, a third matching cost between a template of the fourth reference sub-block and the template of the second sub-block is determined.

In operation S102-B1-B323, the matching cost between the third reference sub-block and the fourth reference sub-block is obtained based on the first matching cost, the second matching cost, and the third matching cost.

In this example, the motion vector is improved by using the template matching. For example, the decoding end improves the motion vector of the current block by using the template matching and the above-described manner of the matching search, to improve the precision of the motion vector of the current block. Furthermore, when the current block is predicted based on the high-precision motion vector, the prediction accuracy for the current block can be improved, and thus the decoding effect can be improved.

The size and position of the template used for calculation is not limited in the embodiment of the present disclosure. In some embodiments, the template used for calculation may be a top template, or a left template, or top and left templates.

As shown in FIG. 21, in the template matching, the template area of the reference block is compared with the template area of the current block. For example, the template of the third reference sub-block is compared with the template of the second sub-block to obtain the second matching cost CostTm0 between the template of the third reference sub-block and the template of the second sub-block; the template of the fourth reference sub-block is compared with the template of the second sub-block to obtain the third matching cost CostTm1 between the template of the fourth reference sub-block and the template of the second sub-block.

The manner of determining the second matching cost between the template of the third reference sub-block and the template of the second sub-block may be that: a third differential value between the template of the third reference sub-block and the template of the second sub-block is determined. For example, an absolute value of the difference value between the template of the third reference sub-block and the template of the second sub-block is determined as the third differential value between the template of the third reference sub-block and the template of the second sub-block; and then, the weight of the template is determined, and a product of the weight of the template and the third differential value is determined as the second matching cost CostTm0 between the template of the third reference sub-block and the template of the second sub-block. Similarly, the manner of determining the third matching cost between the template of the fourth reference sub-block and the template of the second sub-block may be that: a fourth differential value between the template of the fourth reference sub-block and the template of the second sub-block is determined, for example, an absolute value of the difference value between the template of the fourth reference sub-block and the template of the second sub-block is determined as the fourth differential value between the template of the fourth reference sub-block and the template of the second sub-block; and then, the weight of the template is determined, and a product of the weight of the template and the fourth differential value is determined as the third matching cost CostTm1 between the template of the fourth reference sub-block and the template of the second sub-block. Herein, the manner of determining the weight of the template may refer to the description of the above-described embodiments, which will not be repeatedly described herein.

After the decoding end determines the second matching cost between the template of the third reference sub-block and the template of the second sub-block and the third matching cost between the template of the fourth reference sub-block and the template of the second sub-block, the decoding end obtains the matching cost between the third reference sub-block and the fourth reference sub-block based on the first matching cost, the second matching cost and the third matching cost.

For example, the first matching cost is added to the second matching cost and the third matching cost, to obtain the matching cost between the third reference sub-block and the fourth reference sub-block.

Exemplarily, the matching cost between the third reference sub-block and the fourth reference sub-block may be determined based on the following formula (11):

$$CostAll = CostBi + CostTm 0 + CostTm 1 , \qquad ( 11 )$$

where the CostAll is the matching cost between the third reference sub-block and the fourth reference sub-block, the CostBi is the first matching cost between the third reference sub-block and the fourth reference sub-block, the CostTm0 is the second matching cost between the third reference sub-block and the second sub-block, and the CostTm1 is the third matching cost between the fourth reference sub-block and the second sub-block.

For another example, weighted summation is performed on the first matching cost, the second matching cost and the third matching cost, to obtain the matching cost between the third reference sub-block and the fourth reference sub-block. In this example, each of the first matching cost, the second matching cost, and the third matching cost corresponds to one weight. Optionally, the weights corresponding to the first matching cost, the second matching cost, and the third matching cost may be preset values, respectively.

For another example, a first weighting factor corresponding to the first matching cost is determined; a second weighting factor corresponding to the second matching cost and the third matching cost is determined; the first matching cost, the second matching cost, and the third matching cost are weighted based on the first weighting factor and the second weighting factor, to obtain the matching cost between the third reference sub-block and the fourth reference sub-block.

In this example, the first matching cost corresponds to one weight denoted as the first weighting factor; the second matching cost and the third matching cost collectively correspond to one weight denoted as the second weighting factor. Optionally, the first weighting factor and the second weighting factor may be preset values.

In an example, the matching cost between the third reference sub-block and the fourth reference sub-block may be determined based on the following formula (11):

$$CostAll = CostBi ⋆ WeightBi + ( CostTm 0 + CostTm 1 ) ⋆ WeightTm , \qquad ( 11 )$$

where the WeightBi is the first weighting factor, and the WeightTm is the second weighting factor.

Based on the above operations, the decoding end determines a matching point between each of the multiple third reference sub-blocks and each of the multiple fourth reference sub-blocks. In this way, the third reference sub-block and the fourth reference sub-block corresponding to the smallest matching cost may be selected from the multiple third reference sub-blocks and the multiple fourth reference sub-blocks; and then the first one of the second motion vectors may be obtained based on the motion vector of the third reference sub-block corresponding to the smallest matching cost, and the second one of the second motion vectors may be obtained based on the motion vector of the fourth reference sub-block corresponding to the smallest matching cost.

In a possible implementation, the decoding end may directly determine the motion vector corresponding to the third reference sub-block corresponding to the smallest matching cost as the first one of the second motion vectors corresponding to the second sub-block, and determine the motion vector corresponding to the fourth reference sub-block corresponding to the smallest matching cost as the second one of the second motion vectors corresponding to the second sub-block.

In another possible implementation, a fractional-pixel search may be performed for higher precision, such as ½ pixel precision, ¼ pixel precision, 1/16 pixel precision, etc. Specifically, the fractional-pixel search is performed within a surrounding area of the third reference sub-block corresponding to the smallest matching cost to obtain a motion vector of a second fractional-pixel; and the first one of the second motion vectors corresponding to the second sub-block is obtained based on the motion vector of the second fractional-pixel and the matching cost. Similarity, the fractional-pixel search is performed within a surrounding area of the fourth reference sub-block corresponding to the smallest matching cost to obtain a motion vector of a third fractional-pixel; and the second one of the second motion vectors corresponding to the second sub-block is obtained based on the motion vector of the third fractional-pixel and the motion vector corresponding to the fourth reference sub-block corresponding to the smallest matching cost.

The specific process of determining two second motion vectors corresponding to one second sub-block is described above, and the above manner may be adopted for each second sub-block of the current block to determine two second motion vectors corresponding to each second sub-block; and then a prediction value of each second sub-block in the i-th prediction mode is obtained based on the first one of the second motion vectors and the second one of the second motion vectors that correspond to each second sub-block.

The process of determining the prediction value of the current block in the i-th prediction mode when the i-th prediction mode among the K prediction modes is the N-directional prediction mode is described above.

If other prediction modes other than the i-th prediction mode among the K prediction modes are also the N-directional prediction modes, prediction values of the current block in the other prediction modes may be determined by referring to the above operations.

If the K prediction modes include other prediction modes in addition to the N-directional prediction mode, for example, the K prediction modes include the unidirectional prediction mode, then the current block is predicted by using the unidirectional prediction mode, and the prediction value of the current block in the unidirectional prediction mode is obtained.

In the embodiment of the present disclosure, the manner of predicting the current block based on the K prediction modes to obtain the prediction value of the current block includes, but is not limited to, the following case 1 and case 2.

In the case 1, when the decoding end predicts the current block based on K prediction modes, without considering the weight derivation mode. For example, the decoding end predicts the current block by using the K prediction modes for the current block, respectively, to obtain K prediction values of the current block, and processes the K prediction values to obtain the prediction value of the current block. Specifically, an average value, a sum value, a weighted summation value, etc. of the i-th prediction value of the current block determined above and other prediction values is used as the prediction value of the current block.

In the case 2, the decoding end predicts the current block based on the K prediction modes for the current block and the weight derivation mode for the current block. In this case, the operation S102-D includes the following operations S102-D1 and S102-D2,

In operation S102-D1, weights of the prediction values are determined based on the weight derivation mode.

In operation S102-D2, the i-th prediction value and the other prediction values are weighted based on the weights of the prediction values to obtain the prediction value of the current block.

In this case 2, when the prediction value of the current block is determined, the weight derivation mode is considered, and the weights of the prediction values are further determined based on the weight derivation mode. In this way, the decoding end may weight the i-th prediction value and the other prediction values based on the weights of the prediction values to obtain the prediction value of the current block.

The specific process of determining the weights of the prediction values based on the weight derivation mode is not limited in the embodiment of the present disclosure.

In some embodiments, if the weight gradient parameter (also referred to as a blending parameter) is not considered when the weights of the prediction values are determined, then the weights of the prediction values of the current block are directly determined based on the weight derivation mode for the current block.

In some embodiments, when the weights of the prediction values are determined, the weight gradient parameter is considered. In this case, the weight gradient parameter may be determined, and then the weights of the prediction values may be obtained according to the weight gradient parameter and the weight derivation mode for the current block.

Exemplarily, the value of the weight gradient parameter blendingCoeff may be derived by the weight gradient index gpm_blending_idx.

In this way, the K prediction values (such as, the i-th prediction value and other prediction values) may be weighted based on the weights of the prediction values determined above to obtain the prediction value of the current block.

In some embodiments, the prediction process is performed in a unit of sample; correspondingly, the weight of the prediction value is also the weight corresponding to the sample. In this case, when the current block is predicted, a certain sample A in the current block is predicted by using each of the K prediction modes for the current block to obtain K prediction values in the K prediction modes for the current block with respect to the sample A; and the weights of the prediction values of the sample A is determined according to the weight derivation mode for the current block and the weight gradient parameter. Furthermore, the K prediction values are weighted by using the weights of the prediction values of the sample A to obtain the prediction values of the sample A. the above operations are performed on each sample in the current block, and the prediction values of each sample in the current block may be obtained, and the prediction values of each sample in the current block constitutes the prediction value of the current block. Taking K=2 as an example, a first one of the prediction modes is used for predicting a certain sample A in the current block to obtain a first prediction value of the sample A, a second one of the prediction modes is used for predicting the sample A to obtain a second prediction value of the sample A, and the first prediction value and the second prediction value are weighted according to weights of prediction values corresponding to the sample A to obtain the prediction value of the sample A.

In some embodiments, if K is greater than 2, the weights of prediction values corresponding to two prediction modes among the K prediction modes for the current block may be determined according to the weight derivation mode for the current block, and the weights of prediction values corresponding to other prediction modes among the K prediction modes for the current block may be preset values. For example, K=3, the first weight of the prediction values corresponding to the first one of the prediction modes and the second one of the prediction modes is derived according to the weight derivation mode, and the weight of the prediction value corresponding to the third prediction mode is a preset value. In some embodiments, if the weight of the total prediction values corresponding to the K prediction modes for the current block is a fixed value, such as, 8, then a weight of a prediction value corresponding to each of the K prediction modes for the current block may be determined according to a preset weight ratio. It is assumed that the weight of the prediction value corresponding to the third one of the prediction modes accounts for ¼ of the weight of the all prediction values, the weight of the prediction value of the third one of the prediction modes may be determined to be 2, and the remaining ¾ of the weight of the all prediction values is allocated to the first one of the prediction modes and the second one of the prediction modes. For example, if the weight of the prediction value corresponding to the first one of the prediction modes derived according to the weight derivation mode for the current block is 3, then it is determined that the weight of the prediction value corresponding to the first one of the prediction modes is (¾)*3, and the weight of the prediction value corresponding to the second one of the prediction modes is (¾)*5.

According to the above method, the prediction value of the current block is determined. Moreover, the bitstream is decoded to obtain the quantization coefficient of the current block, inverse quantization and inverse transform is performed on the quantization coefficient of the current block to obtain the residual value of the current block, and the prediction value of the current block is added to the residual value of the current block to obtain the reconstructed value of the current block.

In the method for video decoding provided by the embodiment of the present disclosure, when the decoding end decodes the current block, the decoding end determines K prediction modes for the current block, and at least one prediction mode of the K prediction modes is a multi-directional prediction mode (for example, a bi-directional prediction mode), so that when the K prediction modes are used for predicting the current block, the prediction accuracy for the current block can be improved, and the decoding effect for the video can be improved.

The method for video decoding of the present disclosure is described above by taking the decoding end as an example, and hereinafter, the encoding end is taken as an example to describe.

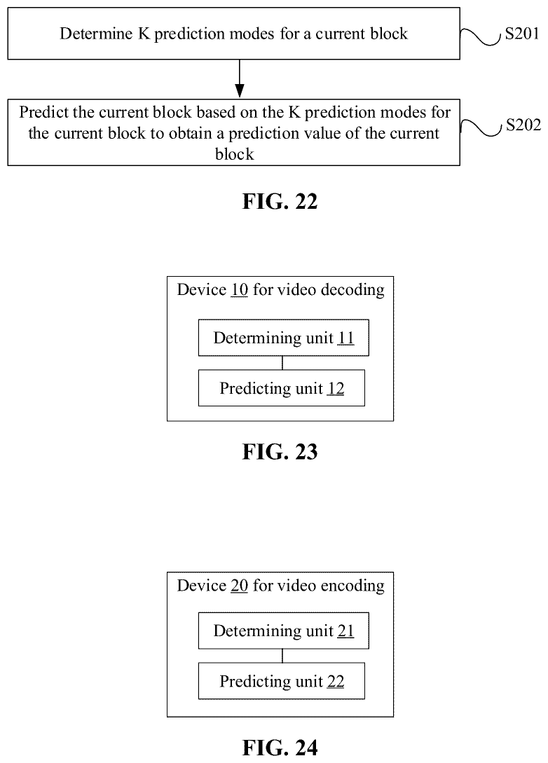

FIG. 22 is a flowchart of a method for video decoding according to an embodiment of the present disclosure, and the embodiment of the present disclosure is applied to the video encoder shown in FIG. 1 and FIG. 2. As shown in FIG. 22, the method according to the embodiment of the present disclosure includes operation S201.

In operation S201, K prediction modes for a current block are determined.

At least one of the K prediction modes is an N-directional prediction mode, and each of the K and N is a positive integer greater than 1.

As can be seen from the foregoing, in the embodiment of the present disclosure, K prediction modes together generate one prediction block, and this prediction block is used for the current block. That is to say, the current block is predicted according to the K prediction modes to obtain K prediction values, and K prediction values are weighted to obtain the prediction value of the current block.

That is to say, when the current block is encoded, the encoding end needs to determine multiple candidate prediction modes; select K prediction modes from the multiple candidate prediction modes; and then predict the current block by using the K prediction modes to obtain the prediction value of the current block

In some embodiments, before the encoding end determines the K prediction modes for the current block, the encoding end firstly needs to determine whether a weighted prediction processing is performed on the current block by using the K different prediction modes. If the encoding end determines that the weighted prediction processing is performed on the current block by using the K different prediction modes, the encoding end performs the above-described operation S201 to determine the K prediction modes for the current block. If the encoding end determines that the weighted prediction processing is not performed on the current block by using the K different prediction modes, the operation S201 is skipped.

In a possible implementation, the encoder may determine whether the weighted prediction processing is performed on the current block by using the K different prediction modes through determining a prediction mode parameter for the current block. Specifically, the description for the decoding end described above may be referred to, which is not repeated herein.

In some embodiments, in the embodiment of the present disclosure, a condition may be used for limiting whether the GPM mode or the AWP mode is used for the current block. That is to say, when it is determined that the current block satisfies a preset condition, it is determined that the weighted prediction is performed on the current block by using the K prediction modes, and then K prediction modes for the current block are determined.

Exemplarily, when the GPM mode or the AWP mode is applied, the size of the current block may be limited.

In the embodiment of the present disclosure, the size parameter of the current block may include the height and width of the current block, and thus, the encoder may determine whether the GPM mode or the AWP mode is used for the current block according to the height and width of the current block.

Furthermore, in the embodiment of the present disclosure, the size of the block for which the GPM mode or the AWP mode may be used may be limited by the limitation of the sample parameter.

That is to say, in the present disclosure, the GPM mode or the AWP mode may be used for the current block only under the condition that the size parameter of the current block satisfies a size requirement.

Exemplarily, in the present disclosure, there may be a picture-level flag to determine whether the present disclosure is used for the current picture to be encoded. For example, it is possible to configure the present disclosure to be used for an intra picture (such as the I picture), and configure the present disclosure to be not used for an inter picture (such as the B picture or the P picture). Alternatively, it is possible to configure the present disclosure to be not used for the intra picture and configure the present disclosure to be used for the inter picture. Alternatively, it is possible to configure the present disclosure to be used for some intra pictures, and configure the present disclosure to be not used for some inter pictures. The intra prediction may also be used for the inter picture, therefore, the present disclosure may be used for the inter pictures.

In some embodiments, there may also be a flag whose level is finer than the picture-level to determine whether the present disclosure is used for the current block.

Based on the above method, when the encoding end determines that the current block is predicted by using K prediction modes, the encoding end determines the K prediction modes for the current block.

In the embodiment of the present disclosure, in order to improve the prediction effect of the K prediction modes on the current block, at least one of the K prediction modes is the N-directional prediction mode, where N is a positive integer greater than 1. Thus, the N-directional prediction mode may also be understood as a multi-directional prediction mode.

It is to be noted that the N-directional prediction mode according to the embodiment of the present disclosure may also be understood as an N reference picture prediction mode, i.e., a mode where the prediction is performed based on N reference pictures. For example, the i-th prediction mode among K prediction modes for the current block is the N-directional prediction mode, and N=2, i.e., two reference pictures are included, then, one prediction value of the current block may be obtained based on the first one of the reference pictures, the other prediction value of the current block based on the second one of the reference pictures, the two prediction values are processed (i.e. the addition or the weighted addition) to obtain a prediction value of the current block in the i-th prediction mode. The N reference pictures may be N forward encoded pictures of the current picture, or N backward encoded pictures of the current picture. Alternatively, the N reference pictures may include at least one forward encoded picture of the current picture and at least one backward encoded picture of the current picture.

For example, the K prediction modes for the current block include a first prediction mode and a second prediction mode.

In an example, the first prediction mode is the N-directional prediction mode. For example, the first prediction mode is a bi-directional prediction mode (i.e., a mode where the prediction is performed based on two reference pictures), a 3-directional prediction mode (i.e., a mode where the prediction is performed based on three reference pictures), or a 4-directional prediction mode (i.e., a mode where the prediction is performed based on four reference pictures).

The second prediction mode is the unidirectional prediction mode.

In another example, the second prediction mode is the N-directional prediction mode, for example, the first prediction mode is a bi-directional prediction mode (i.e., a mode where the prediction is performed based on two reference pictures), a 3-directional prediction mode (i.e., a mode where the prediction is performed based on three reference pictures), or a 4-directional prediction mode (i.e., a mode where the prediction is performed based on four reference pictures). The first prediction mode is the unidirectional prediction mode.

In another example, both the first prediction mode and the second prediction mode are the N-directional prediction modes. For example, both the first prediction mode and the second prediction mode are the bi-directional prediction mode, the 3-directional prediction mode, or the 4-directional prediction mode, etc. It is to be noted that when both the first prediction mode and the second prediction mode are the N-directional prediction mode, the number of and/or selection method of reference pictures corresponding to the first prediction mode may be the same as or different from the number of and/or selection method of reference pictures corresponding to the second prediction mode, which is not limited in the embodiment of the present disclosure. For example, the first prediction mode is the bi-directional prediction mode, i.e., the first prediction mode corresponds to two reference pictures, and the second prediction mode is the 3-directional prediction mode, i.e., the second prediction mode corresponds to three reference pictures. For another example, both the first prediction mode and the second prediction mode are the bi-directional prediction modes, but the selection method of reference pictures corresponding to the first prediction mode may be the same as or different from the selection method of reference pictures corresponding to the second prediction mode. Exemplarily, the reference pictures corresponding to the first prediction mode are two forward encoded pictures of the current picture, the reference pictures corresponding to the second prediction mode are two backward encoded pictures of the current picture; or the reference pictures corresponding to each of the first prediction mode and the second prediction mode are two forward encoded pictures of the current picture.

Hereinafter, a specific manner of the encoder determining the K prediction modes for the current block is described.

In a case 1, when the current block is preset, the encoding end obtains the prediction value of the current block based on the K prediction modes, without considering the weight derivation mode. In this case, the operation S201 includes the following operations S201-A1 and S201-A2.

In operation S201-A1, a candidate prediction mode list is determined, and the candidate prediction mode list includes multiple candidate prediction modes.

In operation S201-A2: K prediction modes are selected from the candidate prediction mode list.

In the case 1, the encoding end firstly determines the candidate prediction mode list, and then selects K prediction modes from the constructed candidate prediction mode list. Exemplarily, the encoding end uses each K candidate prediction modes among the multiple candidate prediction modes in the candidate prediction mode list as one combination to obtain multiple combinations. For each of the multiple combinations, the template of the current block is predicted by using the K candidate prediction modes included in the combination, and a template prediction cost corresponding to the combination is obtained. Thus, based on the template prediction cost, a combination having the smallest template prediction cost is selected from the multiple combinations, and K candidate prediction modes included in the combination having the smallest template prediction cost are used as the K prediction modes for the current block.

In a case 2, when the current block is preset, the encoding end obtains the prediction value of the current block based on the weight derivation mode and the K prediction modes. In this case, the operation S201 includes the following operations S201-B1 to S201-B3.

In operation S201-B1, M candidate weight derivation modes are determined.

In operation S201-B2, a candidate prediction mode list is determined.

In operation S201-B3, the K prediction modes for the current block are determined based on the M candidate weight derivation modes and the candidate prediction mode list.

The specific manner of determining M candidate weight derivation modes may refer to the description of the above embodiments, which is repeated herein. In a possible implementation, some weight derivation modes in the AWP or GPM may be screened out as the M candidate weight derivation modes.

Hereinafter, a process for determining the candidate prediction mode list is described.

It is to be noted that the candidate prediction mode list according to the embodiment of the present disclosure includes the N-directional prediction mode, such as, the bi-directional prediction mode, a 3-directional prediction mode, or a 4-directional prediction mode, and furthermore, it is ensured that at least one of the K prediction modes for the current block determined based on the candidate prediction mode list is the N-directional prediction mode.

In some embodiments, the determination process of the candidate prediction mode list described above is independent of M candidate weight derivation modes. That is to say, it is to be understood that the M candidate weight derivation modes correspond to one candidate prediction mode list, which can reduce the complexity of determining the candidate prediction mode list, and thus improve the encoding efficiency. It is to be noted that, in this embodiment, since the candidate prediction mode list is independent of the M candidate weight derivation modes, there is no strict sequence of execution between the S201-B1 and the S201-B2. That is to say, the S201-B1 may be performed after the S201-B2 is performed, may be performed before the S201-B2 is performed, or maybe performed simultaneously with the S201-B2, which is not limited in the embodiment of the present disclosure.

In some embodiments, for each first candidate weight derivation mode among the M candidate weight derivation modes, a candidate prediction mode list corresponding to the first candidate weight derivation mode is determined.

In an example, the first candidate weight derivation mode is any one of the M candidate weight derivation modes. That is to say, in this example, it is necessary to determine at least one candidate prediction mode list for each of the M candidate weight derivation modes. As may be seen from the above, one weight derivation mode corresponds to K prediction modes, and the candidate prediction mode list is used for determining the prediction modes. Therefore, in a possible implementation of this example, one candidate prediction mode list is determined for at least one of the K prediction modes corresponding to each of the M candidate weight derivation modes.

In another example, if the first candidate weight derivation mode is one category of candidate weight derivation modes among the M candidate weight derivation modes, then in the embodiment of the present disclosure, the M candidate weight derivation modes are required to categorized, and at least one candidate prediction mode list is constructed for each category of candidate weight derivation modes.

In the embodiment of the present disclosure, the manners of determining the candidate prediction mode lists corresponding to all first candidate weight derivation modes among the M candidate weight derivation modes are the same as each other. For convenience of description, the determination of the candidate prediction mode list corresponding to one first candidate weight derivation mode is taken as an example to describe in the embodiment of the present disclosure.

Hereinafter, a specific manner of determining the candidate prediction mode list corresponding to the first candidate weight derivation mode is described.

In some embodiments, the first candidate weight derivation mode corresponds to a candidate prediction mode list.

In some embodiments, when each of the K prediction modes corresponds to one candidate prediction mode list, then for the i-th prediction mode among the K prediction modes, the encoding end determines the candidate prediction mode list corresponding to the i-th prediction mode, where i is a positive integer less than or equal to K.

The specific types of candidate prediction modes included in the candidate prediction mode list corresponding to the i-th prediction mode are not limited in the embodiment of present disclosure.

In some embodiments, when the candidate prediction mode list corresponding to the i-th prediction mode is constructed, the following 7 types of prediction modes are sequentially added into the candidate prediction mode list until the list has a length reaching a preset value (such as, 3).
1. A prediction mode having a prediction angle parallel to a partitioning line of the first candidate weight derivation mode.
2. A first candidate prediction mode determined based on the template of the current block, in some embodiments, the first candidate prediction mode is also referred to as a TIMD-derived prediction mode.
3. A second candidate prediction mode determined based on a gradient of reconstructed samples in the template of the current block, in some embodiments, the second candidate prediction mode is also referred to as a DIMD-derived prediction mode.
4. Prediction modes of neighbouring blocks of the current block.
5. A prediction mode having a prediction angle perpendicular to the partitioning line of the first candidate weight derivation mode.
6. The planar mode.
7. The N-directional prediction mode.

After the encoding end determines the candidate prediction mode list based on the above operations, the encoding end performs operation S201-B3.

Hereinafter, the process of determining the K prediction modes based on the M candidate weight derivation modes and the candidate prediction mode list in operation S201-B3 is described.

In the embodiment of the present disclosure, the encoding end selects one candidate weight derivation mode from the M candidate weight derivation modes as the weight derivation mode for the current block, and determines K prediction modes for the current block from at least one candidate prediction mode included in the candidate prediction mode list. Finally, the current block is predicted by using the weight derivation mode for the current block and K prediction modes for the current block, to obtain the prediction value of the current block.

It is to be noted that the weight derivation mode for the current block and the K prediction modes for the current block are used together for determining the prediction value of the current block.

The specific manner where the encoding end determines the weight derivation mode for the current block and the K prediction modes for the current block based on the M candidate weight derivation modes and the candidate prediction mode list is not limited in the embodiment of the present disclosure.

In some embodiments, when the candidate prediction mode list is a candidate prediction mode list corresponding to the K prediction modes for the current block, i.e., all K prediction modes for the current block are selected from the candidate prediction mode list. In this case, the encoding end combines the M candidate weight derivation modes with the candidate prediction modes included in the candidate prediction mode list. For example, each of the M candidate weight derivation modes is combined with any K candidate prediction modes in the candidate prediction mode list, to obtain multiple combinations each including one candidate weight derivation mode and K candidate prediction modes. Furthermore, the template of the current block (such as, a top template of the current block, a left template of the current block, or top and left templates of the current block) is predicted by using the candidate weight derivation mode and the K candidate prediction modes included in each combination, the cost of each combination is determined, and one combination is determined from the multiple combinations based on the costs. For example, a combination having the smallest cost is selected from the multiple combinations, the candidate weight derivation mode included in the combination having the smallest cost is determined as the weight derivation mode for the current block, and the K prediction modes included in the combination having the smallest cost are determined as the K prediction modes for the current block.

In some embodiments, if the candidate prediction mode list is a candidate prediction mode list corresponding to one of the K prediction modes for the current block. For example, K=2, and the candidate prediction mode list is a candidate prediction mode list corresponding to the first one of the prediction modes. In this case, the encoding end determines an optional prediction mode set corresponding to the second one of the prediction modes. Furthermore, for each of the M candidate weight derivation modes, the encoding end selects one candidate prediction mode from the candidate prediction mode list corresponding to the first one of the prediction modes as one possibility of the first one of the prediction modes; selects one prediction mode from the optional prediction mode set corresponding to the second one of the prediction modes as one possibility of the second one of the prediction modes; and obtains a combination of the candidate weight derivation mode, the one possibility of the first one of the prediction modes and the one possibility of the second one of the prediction modes. There are multiple combinations. Each combination includes one candidate weight derivation mode and two candidate prediction modes. Furthermore, the template of the current block is predicted by using the candidate weight derivation mode and the two candidate prediction modes included in each combination; the cost of each combination is determined; and one combination is determined from the multiple combinations based on the costs. For example, the combination having the smallest cost is selected from the multiple combinations, the candidate weight derivation mode included in the combination having the smallest cost is determined as the weight derivation mode of the current block, and K prediction modes included in the combination having the smallest cost are determined as K prediction modes for the current block.

Based on the above description, one weight derivation mode and the K prediction modes may be used together for the current block as one combination. In order to save codewords and reduce the encoding cost, in some embodiments, the weight derivation mode and the K prediction modes corresponding to the current block are used as one combination, i.e., the first combination indicated by using the first index. Compared with indicating the weight derivation mode and the K prediction modes respectively, the method in the embodiment of the present disclosure uses fewer codewords, thereby reducing the encoding cost.

In the manner 2, the encoding end determines the candidate combination list. For example, the encoding end determines a list including X candidate combinations, and each candidate combination includes 1 weight derivation mode and K prediction modes. The encoding end finally selects one candidate combination, such as the first combination, and the encoding end writes a first index of the first combination into the bitstream.

Hereinafter, the specific process of determining the candidate combination list based on the M candidate weight derivation mode and the candidate prediction mode list in operation S201-S32 is described.

The specific manner of determining the candidate combination list based on the M candidate weight derivation mode and the candidate prediction mode list in operation S201-B32 is not limited in the embodiment of the present disclosure.

In some embodiments, the operation S201-B32 includes the following operations S201-B321 and S201-B322.

In operation S201-B321, T second combinations are obtained based on M candidate weight derivation modes and the candidate prediction mode list.

In operation S201-B322, the candidate combination list is obtained based on the T second combinations.

Any one of the T second combinations includes one weight derivation mode and K prediction modes, and the weight derivation modes and K prediction modes included in any two of the T second combinations are not completely the same as each other, where T is a positive integer greater than 1.

The implementation of obtaining the candidate combination list based on the T second combinations in operation S201-B322 includes, but is not limited to, the manner 1 and the manner 2.

In the manner 1, T second combinations are ranked according to a preset rule to obtain the candidate combination list.

In the manner 2, for any one of the T second combinations, when the template of the current block is predicted by using the weight derivation mode and the K prediction modes in the second combination, a cost corresponding to the second combination is determined; the candidate combination list is determined according to the costs corresponding to all of the T second combinations.

In the manner 2, for each of the T second combinations, the template of the current block is predicted by using the weight derivation mode and the K prediction modes included in the second combination; and prediction values of the template corresponding to the second combination is obtained. Specifically, for each of the T second combinations, K prediction modes in the second combination are used for predicting the template of the current block to obtain K prediction values. Furthermore, based on the weight derivation mode in the second combination, template weights corresponding to the second combination is determined, and then K prediction values of the template are weighted based on the template weights to obtain the prediction values of the template corresponding to the second combination.

Since the template of the current block is a reconstructed area, the encoding end may obtain reconstructed values of the template, and thus, for each of the T second combinations, the cost corresponding to the second combination may be determined according to the prediction values of the template and the reconstructed values of the template that correspond to the second combination. The manner of determining the cost corresponding to the second combination includes, but is not limited to, the SAD, the SATD, the SEE, etc. Furthermore, the candidate combination list is constructed based on the costs corresponding to all of the T second combinations.

In some embodiments, a fast cost calculation method may be used for determining the costs corresponding to all second combinations. It may be seen from the forgoing, the prediction values of the template corresponding to the second combination includes the prediction value of the template corresponding to each of the K prediction modes included in the second combination. In this case, the cost corresponding to each of the K prediction modes in the second combination may be determined according to the prediction value of the template corresponding to each of the K prediction modes and the reconstructed values of the template in the second combination; the cost corresponding to the second combination is determined according to the costs corresponding to the K prediction modes in the second combination. For example, the sum of the costs corresponding to K prediction modes in the second combination is determined as the cost corresponding to the second combination.

According to the above method, the costs corresponding to all of the T second combinations may be determined, and then the candidate combination list may be constructed based on the costs corresponding to all of the T second combinations.

In a first example, the T second combinations are ranked according to the costs corresponding to all of the T second combinations; and the ranked T second combinations are determined as the candidate combination list. The generated candidate combination list in first example includes T first candidate combinations.

In a second example, C second combinations are selected from T second combinations according to the costs corresponding to the second combinations, and a list composed of the C second combinations is determined as the candidate combination list. Optionally, the C second combinations are the first C second combinations corresponding to the smallest costs among the T second combinations. For example, C second combinations corresponding to the smallest costs are selected from the T second combinations based on the costs corresponding to all of the T second combinations, to construct the candidate combination list. In this case, the candidate combination list includes C candidate combinations. Optionally, the C candidate combinations in the candidate combination list are ranked in an ascending order of the costs, i.e., the costs corresponding to the C candidate combinations in the candidate combination list increases sequentially according to the ranking.

The encoding end determines the candidate combination list based on the above operations; selects the first combination corresponding to the first index from the candidate combination list; determines the weight derivation mode included in the first combination as the weight derivation mode for the current block; and determines K prediction modes included in the first combination as the K prediction modes for the current block.

Based on the above operations, the encoding end determines K prediction modes for the current block, and then performs the following operation S202.

In operation S202, the current block is predicted based on the K prediction modes for the current block to obtain a prediction value of the current block.

In the embodiment of the present disclosure, at least one of the K prediction modes for the current block determined by the encoding end is the N-directional prediction mode, so that when the current block is predicted based on the K prediction modes, the prediction accuracy can be improved.

The specific types of the K prediction modes for the current block are not limited in the embodiment of the present disclosure.

In some embodiments, each of the K prediction modes is the inter prediction mode.

In some embodiments, a part of the K prediction modes are the intra prediction mode, and a part of the K prediction modes are the inter prediction mode.

In some embodiments, the N-directional prediction mode in the embodiment of the present disclosure is the inter prediction mode, such as, bi-directional motion information or multi-directional motion information, etc.

It is to be noted that, in the embodiment of the present disclosure, when the N-directional prediction mode is used for the current block, a prediction value of the current block is finally obtained. For example, the K prediction modes include a first one of the prediction modes and a second one of the prediction modes, where the first one of the prediction modes is the N-directional prediction mode, the encoding end predicts the current block by using the N-directional prediction mode to obtain a prediction value 1 of the current block; predicts the current block by using the second one of the prediction modes to obtain a prediction value 2 of the current block; and then processes the prediction value 1 and the prediction value 2 to obtain the prediction value of the current block.

A specific manner where the encoding end predicts the current block based on K prediction modes to obtain the prediction value of the current block is not limited in the embodiment of the present disclosure.

In some embodiments, if the N-directional prediction mode is N-directional motion information, then operation S202 includes following operations S202-A to S202-D.

In operation S202-A, for an i-th prediction mode among the K prediction modes, if the i-th prediction mode is the N-directional prediction mode, determining N pieces of first motion information corresponding to the i-th prediction mode, where i is a positive integer less than or equal to K.

In operation S202-B, an i-th prediction value of the current block is obtained based on the N pieces of first motion information.

In operation S202-C, the current block is predicted by using prediction modes other than the i-th prediction mode among the K prediction modes, to obtain other prediction values of the current block.

In operation S202-D, the prediction value of the current block is obtained based on the i-th prediction value and the other prediction values.

In this embodiment, when the i-th prediction mode among the K prediction modes for the current block is the N-directional prediction mode, the encoding end firstly determines N pieces of first motion information corresponding to the i-th prediction mode, where the first motion information may be understood as an initial value of each piece of motion information in the N-directional motion information, or may be referred to as the initial motion information. Based on the N pieces of first motion information, the i-th prediction value of the current block is obtained. Furthermore, the current block is predicted by using prediction modes other than the i-th prediction mode among the K prediction modes, to obtain other prediction values of the current block; and finally, the prediction value of the current block is obtained based on the i-th prediction value and the other prediction values.

Hereinafter, a specific process where the encoding end determines the N pieces of first motion information corresponding to the i-th prediction mode is described.

In the embodiment of the present disclosure, each piece of motion information in the N-directional motion information includes one reference picture and one motion vector, and one reference block of the current block in the reference picture may be obtained based on the motion vector. In this way, N reference blocks of the current block may be determined by the N-directional motion information, and then the prediction value of the current block in the i-th prediction mode may be obtained based on the N reference blocks.

In some embodiments, the encoding end constructs a reference picture list; obtains a reference picture corresponding to the motion information from the constructed reference picture list. The encoding end constructs a motion information candidate list; and obtains a motion vector corresponding to the motion information from the constructed motion information candidate list. Furthermore, the encoding end writes the index of the reference picture corresponding to each piece of motion information in the N-directional motion information and the index of the motion vector into the bitstream.

As can be seen from foregoing, before the N pieces of first motion information is determined, the encoding end firstly needs to construct the reference picture list and the motion information candidate list.

In some embodiments, the encoding end constructs one reference picture list for the N-directional motion information.

In some embodiments, the encoding end constructs one reference picture list for each piece of motion information in the N-directional motion information. For example, since the N-directional motion information includes the motion information 1 and the motion information 2, the encoding end constructs a reference picture list RPL0 for the motion information 1 and constructs a reference picture list RPL1 for the motion information 2. In an example, the reference pictures in at least one of the reference picture list RPL0 and the reference picture list RPL1 are preset or default. In another example, the decoding end sends identification information (such as, a picture order count) of a reference picture included in at least one of the reference picture list RPL0 and the reference picture list RPL1 to the encoding end, so that the encoding end may construct at least one of the reference picture list RPL0 and the reference picture list RPL1 based on the identification information of the reference picture.

The construction process of the motion information candidate list is described below.

In some embodiments, the encoding end constructs one motion information candidate list for the N-directional motion information.

In some embodiments, the encoding end constructs one motion information candidate list for each piece of motion information in the N-directional motion information.

In some embodiments, the motion information candidate list may be a merge candidate list. Exemplarily, the merge candidate list includes multiple candidate motion vectors.

For example, it is assumed that the K prediction modes include a first one of the prediction modes and a second one of the prediction modes, and it is assumed that both the first one of the prediction modes and the second one of the prediction modes are the inter prediction modes. In this case, the K prediction modes may be understood as K pieces of motion information, such as the motion information 1 and the motion information 2, and at least one of the motion information 1 and the motion information 2 is the N-directional motion information. It is assumed that the motion information 1 is the bi-directional motion information, the encoding end determines a reference picture and a motion vector corresponding to each piece of motion information in the bi-directional motion information. For example, based on the above method, the encoding end determines a motion information candidate list (such as, a merge candidate list); determines a motion vector mvL0 corresponding to the first one piece of motion information from the motion information candidate list. For example, a motion vector corresponding to the smallest cost is determined as the motion vector mvL0. In this way, the motion vector mvL0 and the reference picture refL0 that correspond to the first one piece of motion information are determined as the first motion information or the initial motion information corresponding to the first one piece of motion information. For another example, based on the above method, the encoding end determines the motion vector mvL1 corresponding to the second one piece of motion information from the motion information candidate list. For example, the motion vector corresponding to the second smallest cost is determined as the motion vector mvL1. In this way, the motion vector mvL1 and the reference picture refL1 that correspond to the second one piece of motion information are determined as the first motion information or the initial motion information corresponding to the second one piece of motion information.

In some embodiments, the encoding end writes the index mvIdxL0 of the motion vector mvL0 and the index refIdxL0 of the reference picture refL0 that correspond to the determined first one piece of motion information into the bitstream; and writes the index mvIdxL1 of the motion vector mvL1 and the index refIdxL1 of the reference picture refL1 that correspond to the determined second one piece of motion information into the bitstream.

As may be seen from the above, each of the N pieces of first motion information includes reference picture information and motion vector information that correspond to the motion information, and the reference picture information may be the reference picture index, a POC of the reference picture, etc. The motion vector information may be an initial value of the first motion vector that also referred to as an initial motion vector or a motion vector.

In the above embodiment, the encoding end determining the first motion vector from the motion information candidate list based on the index of the motion vector is taken as an example to describe. In some embodiments, the first motion vector may be directly encoded into the bitstream at the encoding end, so that the first motion vector may be directly decoded from the bitstream at the decoding end.

In the embodiment of the present disclosure, after the encoding end determines the N pieces of first motion information corresponding to the i-th prediction mode based on the above operations, the encoding end obtains the i-th prediction value of the current block based on the N pieces of first motion information.

The specific manner of obtaining the i-th prediction value of the current block based on the N pieces of first motion information in operation S202-B is not limited in the embodiment of the present disclosure.

In some embodiments, it may be seen from the above that each of the N pieces of first motion information includes one first motion vector, so that the N pieces of first motion information correspond to N first motion vectors. In this case, the operation S202-B includes operations S202-B1 and S202-B2

In operation S202-B1, at least one first motion vector of the N first motion vectors is improved to obtain at least one second motion vector.

In operation S202-B2, the i-th prediction value of the current block is obtained based on the at least one second motion vector.

In this embodiment, in order to further improve the prediction accuracy for the current block by the N-directional prediction mode, at least one first motion vector of the N first motion vectors corresponding to the N-directional prediction mode is improved to obtain at least one second motion vector. For example, the first motion vector mvL0 and/or the first motion vector mvL1 is improved. The second motion vector may be understood as the improved first motion vector. In this way, the i-th prediction value of the current block may be obtained based on the at least one second motion vector obtained by improving the at least one first motion vector.

In an example, if the encoding end improves all of the N first motion vectors, then N second motion vectors may be obtained; N reference blocks may be obtained based on the N second motion vectors; and the i-th prediction value of the current block may be obtained based on the N reference blocks.

In another example, if the encoding end improves a part of the first motion vectors of the N first motion vectors but does not improve the other part of the first motion vectors, then the encoding end obtains a part of the reference blocks of the current block based on a part of the second motion vectors obtained by improving; obtains the other part of the reference blocks of the current block based on the unimproved part of the first motion vectors, i.e., a total of N reference blocks of the current block is obtained; and then obtains the i-th prediction value of the current block based on the N reference blocks.

In the embodiment of the present disclosure, the specific manners of improving the first motion vector to obtain the second motion vector include, but are not limited to, the following first manner and second manner.

In the first manner, the first motion vector is improved by using a motion vector difference. In this case, the operation S202-B1 includes the following operations S202-B1-A1 to S202-B1-A3.

In operation S202-B1-A1, motion vector difference information is determined.

In operation a first motion vector difference is obtained based on the motion vector difference information.

In operation S202-B1-A3, the at least one first motion vector of the N first motion vectors is improved based on the first motion vector difference, to obtain the at least one second motion vector.

In the first manner, when the encoding end determines that at least one first motion vector of the N first motion vectors is improved by using the motion vector difference, the encoding end firstly determines the motion vector difference information; then obtains the the motion vector difference by using the motion vector difference information; and then improves the at least one first motion vector by using the first motion vector difference to obtain at least one second motion vector.

The specific content of the motion vector difference information is not limited in the embodiment of the present disclosure, and the motion vector difference information may be any information used for deriving the first motion vector difference.

In some embodiments, the motion vector difference information includes a direction index mmvd_direction_idx and a distance index mmvd_distance_idx. In this case, the operation that the motion vector difference information is determined in S202-B1-A1 may include: the direction index mmvd_direction_idx and the distance index mmvd_distance_idx are determined. Correspondingly, the operation that the first motion vector difference is obtained based on the motion vector difference information in S202-B1-A2 includes: the first motion vector difference is obtained based on the direction index mmvd_direction_idx and the distance index mmvd_distance_idx.

For example, the direction of the motion vector difference in the embodiment of the present disclosure includes: a unilateral horizontal direction, a unilateral vertical direction, a direction of top-left 45 degrees, a direction of bottom-left at 45 degrees, a direction of top-right at 45 degrees, a direction of bottom-right at 45 degrees, etc.

In some embodiments, before the encoding end determines the direction index mmvd_direction_idx and the distance index mmvd_distance_idx, the encoding end firstly determines whether the i-th prediction mode is improved by using the motion vector difference. Specifically, first information is determined, where the first information indicates whether the i-th prediction mode is improved by using motion vector difference. If the first information indicates that the i-th prediction mode is improved by using the motion vector difference, the direction index and the distance index are determined.

Specific manners where the encoding end determines the direction index mmvd_direction_idx and the distance index mmvd_distance_idx include, but are not limited to, the following several manners.

In one manner, the direction index mmvd_direction_idx and the distance index mmvd_distance_idx are preset or indicated by a higher layer.

In another manner, the encoding end determines a cost corresponding to each MmvdDistance and MmvdSign in Table 7 and Table 8; selects the MmvdDistance and MmvdSign corresponding to the smallest cost; and then obtains the distance index mmvd_distance_idx of the MmvdDistance corresponding to the smallest cost and the distance index mmvd_distance_idx of the MmvdSign corresponding to the smallest cost.

In some embodiments, the encoding end writes the determined direction index mmvd_direction_idx and the determined distance index mmvd_distance_idx in to the bitstream.

After the direction index mmvd_direction_idx and the distance index mmvd_distance_idx are determined, the encoding end determines direction information corresponding to the direction index mmvd_direction_idx and distance information corresponding to the distance index mmvd_distance_idx; and further obtains the first motion vector difference based on the direction information and the distance information. In some embodiments, the operation of improving the first motion vector includes: the two components x, y, are respectively improved. Exemplarily, the encoding end obtains the first motion vector difference based on the formula (1).

After the encoding end determines the first motion vector difference based on the above operations, the encoding end improves at least one first motion vector of the N first motion vectors based on the first motion vector difference to obtain at least one second motion vector.

In the embodiment of the present disclosure, the implementations of the operation S202-B1-A3 include, but are not limited to, the following manner 1 to manner 3.

In the manner 1, the encoding end improves all of the N first motion vectors based on the first motion vector difference to obtain N second motion vectors.

For example, it is assumed that the N first motion vectors include a first one of the N first motion vectors and a second one of the N first motion vectors, the first one of the N first motion vectors is improved by using the first motion vector difference to obtain a first one of second motion vectors, and the second one of the N first motion vectors is improved by using the first motion vector difference to obtain a second one of the second motion vectors.

In an example, the first motion vector difference is added to the first motion vector to obtain the second motion vector.

For example, if the N first motion vectors include a first one of the N first motion vectors mvL0 and a second one of the N first motion vectors mvL1, the encoding end obtains the second motion vector by using the above formula (2).

In some embodiments, the improvement of each of the mvL0 and the mvL1 is to respectively improve the component x and component y. In this case, the second motion vector may be obtained based on the above formula (3).

In the manner 2, the encoding end improves a part of the N first motion vectors by using the first motion vector difference, and improves the other part of the N first motion vectors by using the second motion vector difference. In this case, the operation S202-B1-A3 includes the following operations S202-B1-A3-11 to S202-B1-A3-13.

In operation S202-B1-A3-11, the first one of the N first motion vectors is improved based on the first motion vector difference to obtain a first one of second motion vectors.

In operation S202-B1-A3-12, a second motion vector difference is determined based on the first motion vector difference.

In operation S202-B1-A3-13, the second one of the N first motion vectors is improved based on the second motion vector difference to obtain a second one of the second motion vectors.

In the manner 2, for convenience of description, it is assumed that the N first motion vectors include the first one of the N first motion vectors and the second one of the N first motion vectors, so that the encoding end directly compensates the first one of the N first motion vectors based on the first motion vector difference to obtain the first one of second motion vectors. Moreover, the second motion vector difference is obtained by using the first motion vector difference; and the second one of the N first motion vectors is compensated by using the second motion vector difference, to obtain the second one of second motion vectors. It is to be noted that, the N first motion vectors including two first motion vectors is taken as an example in the manner 2, but the specific number of the N first motion vectors is not limited in the embodiment of the present disclosure. That is to say, when N is a positive integer larger than 2, the N first motion vectors may be improved by the manner 2.

In the manner 2, a specific manner of improving the first one of the N first motion vectors based on the first motion vector difference to obtain the first one of the second motion vectors may be referred to the related description in the manner 1. For example, the first motion vector difference is added to the first one of the N first motion vectors to obtain the first one of the second motion vectors. Specifically, the detailed description of the above formula (2) and formula (3) may be referred to, which is not repeated herein.

Hereinafter, a specific process of determining the second motion vector difference based on the first motion vector difference in operation S202-B1-A3-12 may be described.

In a possible implementation, the first motion vector difference is processed based on a deviation between the first one of the N first motion vectors and the second one of the N first motion vectors to obtain the second motion vector difference. For example, the deviation between the first one of the N first motion vectors and the second one of the N first motion vectors is added to the first motion vector difference to obtain the second motion vector difference.

In a possible implementation, the operation S202-B1-A3-12 includes the following operations S202-B1-A3-121 and S202-B1-A3-122.

In operation S202-B1-A3-121, a picture order count of a first reference picture corresponding to the first one of the N first motion vectors, a picture order count of a current picture, and a picture order count of a second reference picture corresponding to the second one of the N first motion vectors are determined.

In operation S202-B1-A3-122, the second motion vector difference is determined based on the picture order count of the first reference picture, the picture order count of the current picture, the picture order count of the second reference picture and the first motion vector difference.

As may be seen from the above, since each of the N pieces of first motion information corresponds to one reference picture and one motion vector, for each piece of motion information, the reference picture corresponding to the motion information is used as the reference picture corresponding to the first motion vector corresponding to the motion information. For convenience of description, in the embodiment of the present disclosure, the reference picture corresponding to the first one of the N first motion vectors is recorded as a first reference picture, and a reference picture corresponding to a second one of the N first motion vectors is recorded as a second reference picture.

In this implementation, the encoding end determines the picture order count of the first reference picture corresponding to the first one of the N first motion vectors, the picture order count of the current picture, and the picture order count of the second reference picture corresponding to the second one of the N first motion vectors; and further determines the second motion vector difference based on the picture order count of the first reference picture, the picture order count of the current picture, the picture order count of the second reference picture, and the first motion vector difference.

The specific manner of determining the second motion vector difference based on the picture order count of the first reference picture, the picture order count of the current picture, the picture order count of the second reference picture, and the first motion vector difference is not limited in the embodiment of the present disclosure.

In an example, the first motion vector difference is mapped based on an association between the picture order count of the first reference picture, the picture order count of the current picture, and the picture order count of the second reference picture, to obtain the second motion vector difference.

In another example, the encoding end determines a first difference value between the picture order count of the second reference picture and the picture order count of the current picture; determines a second difference value between the picture order count of the first reference picture and the picture order count of the current picture; and obtains the second motion vector difference based on the first difference value, the second difference value, and the first motion vector difference.

For example, a difference between the first difference value and the second difference value is determined, and the difference is added to the first motion vector difference to obtain the second motion vector difference.

For another example, a ratio between the first difference value and the second difference value is determined; and a product of the ratio and the first motion vector difference is determined as the second motion vector difference. Exemplarily, the second motion vector difference is obtained based on the above formula (4)

After the second motion vector difference is obtained based on the above operations, the second one of the N first motion vectors is improved based on the second motion vector difference to obtain the second one of the second motion vectors. The manner where the encoding end improves the second one of the N first motion vectors by using the second motion vector difference is basically the same as the manner where the encoding end improves the first one of the N first motion vectors by using the first motion vector difference.

For example, the second motion vector difference is added to the second one of the N first motion vectors to obtain the second one of the second motion vectors.

In this first manner, in addition to improving the N first motion vectors by using the manner 1 or the manner 2 described above, the encoding end may also improve the N first motion vectors by using the following manner 3.

In the manner 3, the encoding end improves a part of the N first motion vectors by using the first motion vector difference, and improves the other part of the N first motion vectors in a manner of matching search. In this case, the operation S202-B1-A3 includes the following operations S202-B1-A3-21 to S202-B1-A3-22.

In operation S202-B1-A3-21, the first one of the N first motion vectors is improved based on the first motion vector difference to obtain a first one of second motion vectors.

In operation S202-B1-A3-22, a matching search is performed, based on the second one of the N first motion vectors, within a preset search range of a reference picture corresponding to the second one of the N first motion vectors, to obtain the second one of the second motion vectors.

In the manner 3, a specific manner of improving the first one of the N first motion vectors based on the first motion vector difference to obtain the first one of the second motion vectors may be referred to the related description in the manner 1. For example, the first motion vector difference is added to the first one of the N first motion vectors to obtain the first one of the second motion vectors. Specifically, the detailed description of the above formula (2) and formula (3) may be referred to, which is not repeated herein.

Hereinafter, a specific process where the matching search is performed, based on the second one of the N first motion vectors, within a preset search range of a reference picture corresponding to the second one of the N first motion vectors, to obtain the second one of the second motion vectors in operation S202-B1-A3-22 is described.

As may be seen from the above, the reference picture corresponding to the second one of the N first motion vectors is recorded as the second reference picture, so that the encoding end performs the search within a preset search range of the second reference picture based on the second one of the N first motion vectors to obtain multiple reference blocks; selects one reference block from the multiple reference blocks; and determines a motion vector corresponding to the reference block as the second one of the second motion vectors.

The specific manner were the matching search is performed, based on the second one of the N first motion vectors, within a preset search range of a reference picture corresponding to the second one of the N first motion vectors, to obtain the second one of the second motion vectors is not limited in the embodiment of the present disclosure.

In some embodiments, the encoding end may perform sub-block search, i.e., each of sub-blocks of the current block is separately improved. In this case, the operation S202-B1-A3-22 includes the following operations S202-B1-A3-221 and S202-B1-A3-222.

In operation S202-B1-A3-221, the current block is partitioned into at least one first sub-block.

In operation S202-B1-A3-222, for any one of the at least one first sub-block, the matching search is performed within the preset search range of the reference picture corresponding to the second one of the N first motion vectors to obtain the second one of the second motion vectors corresponding to the first sub-block.

The size and shape of at least one first sub-block partitioned from the current block is not limited in the embodiment of the present disclosure. Exemplarily, the size of the first sub-block is 4×4, 8×8, 16×16, etc. In some embodiments, the encoding end may partition the whole current block into one or more first sub-blocks, i.e., there is no area that is not partitioned in the current block. In some embodiments, the encoding end partitions a part of area in the current block into at least one first sub-block, and the encoding end does not partition the other area in the current block.

The manners where the encoding end performs the matching search on each of the at least one first sub-block obtained by the partitioning to obtain the second one of the second motion vectors corresponding to the first sub-block are the same as each other. For convenience of description, one first sub-block is taken as an example to describe.

The specific manner where the matching search is performed within the preset search range of the reference picture corresponding to the second one of the N first motion vectors to obtain the second one of the second motion vectors corresponding to the first sub-block in the operation S202-B1-A3-222 is not limited in the embodiment of the present disclosure.

In some embodiments, the operation S202-B1-A3-222 includes the following operations S202-B1-A3-2221 to S202-B1-A3-2224.

In operation S202-B1-A3-2221, a search starting point corresponding to the second one of the N first motion vectors is determined, and search is performed, by using the search starting point as a starting point, within the preset search range of the reference picture corresponding to the second one of the N first motion vectors to obtain multiple first reference sub-blocks corresponding to the first sub-block.

In operation S202-B1-A3-2222, a second reference sub-block corresponding to the first sub-block is determined, based on the first one of the second motion vectors, from a reference picture corresponding to the first one of the N first motion vectors.

In operation S202-B1-A3-2223, matching costs between the multiple first reference sub-blocks and the second reference sub-block are determined, and a first reference sub-block corresponding to a smallest matching cost is selected from the multiple first reference sub-blocks.

In operation S202-B1-A3-2224: the second one of the second motion vectors corresponding to the first sub-block is obtained based on a motion vector corresponding to the first reference sub-block corresponding to the smallest matching cost.

As may be seen from the above, the reference picture corresponding to the first one of the N first motion vectors is denoted as the first reference picture, and the reference picture corresponding to the second one of the N first motion vectors is denoted as the second reference picture. In this way, for each of the at least one first sub-block of the current block, as shown in FIG. 19, the encoding end determines multiple first reference sub-blocks corresponding to the first sub-block from the second reference picture based on the second one of the N first motion vectors mvL1; and determines a second reference sub-block corresponding to the first sub-block from the first reference picture based on the first one of the second motion vectors mvL0′. For each of the multiple first reference sub-blocks, a matching cost between the first reference sub-block and the second reference sub-block is determined, for example, the SAD, the SATD or the SSE, etc. between the first reference sub-block and the second reference sub-block is calculated. In this way, matching costs between different first reference sub-blocks and second reference sub-block may be calculated; a first reference sub-block corresponding to the smallest matching cost may be selected from the multiple first reference sub-blocks based on the matching costs; and a second one of the second motion vectors corresponding to the first sub-block may be obtained based on a motion vector corresponding to the first reference sub-block corresponding to the smallest matching cost.

Hereinafter, the specific process of determining the search starting point corresponding to the second one of the N first motion vectors is described.

In an example 1, the second one of the N first motion vectors is directly used as the search starting point. That is to say, the encoding end performing the search within the preset search range of the second reference picture by using the second one of the N first motion vectors as the search starting point, to obtain the multiple first reference sub-blocks corresponding to the first sub-block.

In an example 2, the second one of the N first motion vectors is improved based on the first motion vector difference to obtain an improved second one of the N first motion vectors; and the improved second one of the N first motion vectors is used as the search starting point. The manner of improving the second one of the N first motion vectors based on the first motion vector difference is substantially the same as the manner of improving the first one of the N first motion vectors based on the first motion vector difference. For example, the first motion vector difference is added to the second one of the N first motion vectors to obtain the improved second one of the N first motion vectors. In this way, the encoding end performs the search within the preset search range of the second reference picture by using the improved second one of the N first motion vectors as the search starting point, to obtain the multiple first reference sub-blocks corresponding to the first sub-block.

In an example 3, a second motion vector difference is determined based on the first motion vector difference; the second one of the N first motion vectors is improved based on the second motion vector difference to obtain an improved second one of the N first motion vectors; and the improved second one of the N first motion vectors is used as the search starting point. The specific process of determining the second motion vector difference based on the first motion vector difference refers to the description of the above-described embodiment, which is not repeatedly described herein. The process of improving the second one of the N first motion vectors based on the second motion vector difference may be the same as that in the above-described embodiment. For example, the second motion vector difference is added to the second first motion vector to obtain the improved second one of the N first motion vectors. In this way, the encoding end performs the search within the preset search range of the second reference picture by using the improved second one of the N first motion vectors as the search starting point, to obtain the multiple first reference sub-blocks corresponding to the first sub-block.

The operation that the second reference sub-block corresponding to the first sub-block is determined, based on the first one of the second motion vectors, from the reference picture corresponding to the first one of the N first motion vectors in S202-B1-A3-2222 includes at least the following manners.

In one manner, in a unit of the first sub-block, the second reference sub-block corresponding to the first sub-block is directly determined from the first reference picture based on the first one of the second motion vectors. That is to say, in this manner, for the first sub-block 1, the second reference sub-block corresponding to the first sub-block 1 is searched in the first reference picture; for the first sub-block 2, the second reference sub-block corresponding to the first sub-block 2 is searched in the first reference picture, and so on.

In the other manner, a reference block corresponding to the current block is firstly determined, and a second reference sub-block corresponding to each first sub-block is determined from the reference block. Specifically, the encoding end determines the reference block corresponding to the current block from the first reference picture based on the first one of the second motion vectors. Furthermore, for each first sub-block of the current block, the second reference sub-block corresponding to each first sub-block is determined from the reference blocks corresponding to the current block.

Hereinafter, a process of determining the matching cost between the first reference sub-block and the second reference sub-block is described.

In some embodiments, when the embodiment of the present disclosure is applied to the GPM, the matching cost between the first reference sub-block and the second reference sub-block may be determined by the following operations 1 to 3, i.e., as described in the foregoing.

In operation 1, a weight derivation mode for the current block is determined.

In operation 2, a weight corresponding to the i-th prediction mode is determined based on the weight derivation mode.

In operation 3, for any one of the multiple first reference sub-blocks, a matching cost between the first reference sub-block and the second reference sub-block is obtained based on the weight corresponding to the i-th prediction mode and the first reference sub-block and the second reference sub-block.

In this embodiment, the i-th prediction mode is the N-directional prediction mode, and the prediction block predicted by the N-directional prediction mode is used in the GPM. That is to say, for a prediction block having the size being the same as the size of the current block, a part of the prediction block (i.e., the part having a non-zero weight) will work, and the other part of the prediction block (i.e., the part having a weight of 0) will not work. Therefore, when the matching cost is calculated for the N-directional prediction, a mask similar to the GPM prediction may be used for the manner of calculating the matching cost. Specifically, the weight derivation mode for the current block is determined, and a specific manner of determining the weight derivation mode for the current block may refer to the description of the above-described embodiment. For example, the weight derivation mode for the current block and the K prediction modes are determined as a combination. Furthermore, the weight corresponding to the i-th prediction mode may be determined based on the weight derivation mode for the current block. For example, if the weight derivation mode for the current block is mode 45 in FIG. 4, if the i-th prediction mode is the first one of the prediction modes for the current block, areas where the weight corresponding to the i-th prediction mode is not 0 is the white area and the gray area; and if the i-th prediction mode is the second one of the prediction modes for the current block, areas where the weight corresponding to the i-th prediction mode is not 0 is the black area and the gray area. In this way, the matching cost between the first reference sub-block and the second reference sub-block may be obtained based on the weight corresponding to the i-th prediction mode.

The specific manners where the matching cost between the first reference sub-block and the second reference sub-block is obtained based on the weight corresponding to the i-th prediction mode and the first reference sub-block and the second reference sub-block in the operation 3 include, but are not limited to, the following several implementations.

In a possible implementation, based on the weight corresponding to the i-th prediction mode, only the areas where the weight corresponding to the i-th prediction mode is not zero in the first reference sub-block and the second reference sub-block are processed to obtain the matching cost between the first reference sub-block and the second reference sub-block.

In another possible implementation, the encoding end obtains a first differential value based on the first reference sub-block and the second reference sub-block; and multiplies the weight corresponding to the i-th prediction mode with the first differential value, to obtain the matching cost between the first reference sub-block and the second reference sub-block. The manner of obtaining the first differential value based on the first reference sub-block and the second reference sub-block may be that: a difference value between the first reference sub-block and the second reference sub-block is determined as the first differential value, or an absolute value of a difference value between the first reference sub-block and the second reference sub-block is determined as the first differential value, or may be that: the difference value between the first reference sub-block and the second reference sub-block is determined, and preset processing is performed on the difference value to obtain the first differential value.

In an example, the matching cost SADwithMask1 between the first reference sub-block and the second reference sub-block may be obtained according to the above formula (10).

In some embodiments, the manner of calculating the wValue may also be simplified, for example, the w Value for calculating the SADwithMask1 is simplified to have a value of only 0 and 1, to facilitate calculation.

Based on the above operations, the encoding end may determine the matching cost between each of the multiple first reference sub-blocks and the second reference sub-block, select one first reference sub-block corresponding to the smallest matching cost from the multiple first reference sub-blocks based on the matching costs, and further obtain a second one of the second motion vectors corresponding to the first sub-block based on the motion vector corresponding to the first reference sub-block corresponding to the smallest matching cost.

In a possible implementation, the encoding end may directly determine the motion vector corresponding to the first reference sub-block corresponding to the smallest matching cost as the second one of the second motion vectors corresponding to the first sub-block.

In another possible implementation, a fractional-pixel search may be performed for higher precision, such as ½ pixel precision, ¼ pixel precision, 1/16 pixel precision, etc. Specifically, the fractional-pixel search is performed within a surrounding area of the first reference sub-block corresponding to the smallest matching cost to obtain a motion vector of a first fractional-pixel; and the second one of the second motion vectors corresponding to the first sub-block is obtained based on the motion vector of the first fractional-pixel and the motion vector corresponding to the first reference sub-block corresponding to the smallest matching cost.

The specific process of determining the second one of the second motion vectors corresponding to one first sub-block is described above, and the above manner may be adopted for each first sub-block of the current block to determine the second one of the second motion vectors corresponding to each first sub-block; and then a prediction value of each first sub-block in the i-th prediction mode is obtained based on the first one of the second motion vectors and the second one of the second motion vectors that correspond to each first sub-block.

The specific process of improving at least one first motion vector of the N first motion vectors based on the motion vector difference in the first manner is described above. As may be seen from the above, the improvement of at least one first motion vector of the N first motion vectors based on the motion vector difference may be performed in any one of the manner 1 to manner 3. In some embodiments, if the current block is partitioned into multiple first sub-blocks, some of the first sub-blocks may be improved by the above-described manne1, some of the first sub-blocks may be improved by the above-described manne2, and some of the sub-blocks may be improved by the above-described manne3. That is to say, the first sub-block of the current block may be improved in at least two of the manner 1, manner 2, and manner 3.

In addition to improving the at least one first motion vector of the N first motion vectors by using the method described in the first manner, the encoding end may improve the first motion vector by using the method in the following second manner.

In the second manner, the operation S202-B1 includes the following operation S202-B1-B.

In operation S202-B1-B, based on the at least one first motion vector, a matching search is performed within a preset search range of a reference picture corresponding to the at least one first motion vector, to obtain the at least one second motion vector.

In the second manner, the manner of search is used for each of the at least one first motion vector of the N first motion vectors, to obtain the second motion vector of the first motion vector to be improved.

The specific manner where based on the at least one first motion vector, a matching search is performed within a preset search range of a reference picture corresponding to the at least one first motion vector, to obtain the at least one second motion vector is not limited in the embodiment of the present disclosure.

In some embodiments, the encoding end performs whole-block search, i.e., the encoding end searches for multiple reference blocks corresponding to the current block from the reference picture; selects one reference block from the multiple reference blocks; and determines the motion vector corresponding to the reference block as one second motion vectors. For example, a reference block 1 is searched from the first reference picture based on a first one of the N first motion vectors, a reference block 2 is searched from the second reference picture based on a second one of the N first motion vectors; a matching cost between the reference block 1 and the reference block 2 is calculated; two reference blocks having the highest matching degree (i.e., the smallest matching cost) may be obtained; and the motion vectors corresponding to the two reference blocks are determined as the first one of the second motion vectors and a second one of the second motion vectors.

In some embodiments, the encoding end may perform sub-block search, i.e., each of sub-blocks of the current block is separately improved. In this case, the operation S202-B1-B includes the following operations S202-B1-B1 to S202-B1-B4.

In operation S202-B1-B1, the current block is partitioned into at least one second sub-block.

In operation S202-B1-B2, for any one of the at least one second sub-block, the matching search is performed within a preset search range of a reference picture corresponding to the first one of the at least one first motion vector, to obtain multiple third reference sub-blocks corresponding to the second sub-block, and the matching search is performed within a preset search range of a reference picture corresponding to the second one of the at least one first motion vector, to obtain multiple fourth reference sub-blocks corresponding to the second sub-block.

In operation S202-B1-B3, matching costs between the multiple third reference sub-blocks and the multiple fourth reference sub-blocks are determined, and a third reference sub-block and a fourth reference sub-block corresponding to a smallest matching cost are selected from the multiple third reference sub-blocks and the multiple fourth reference sub-blocks.

In operation S202-B1-B4, a first one of second motion vectors corresponding to the second sub-block is obtained based on a motion vector corresponding to the third reference sub-block corresponding to the smallest matching cost, and a second one of the second motion vectors corresponding to the second sub-block is obtained based on a motion vector corresponding to the fourth reference sub-block corresponding to the smallest matching cost.

In this embodiment, for convenience of description, it is assumed that at least one first motion vector to be improved of the N first motion vectors includes a first one of the N first motion vectors and a second one of the N first motion vectors. In this case, the encoding end improves the first one of the N first motion vectors and the second one of the N first motion vectors by searching to obtain two second motion vectors. It is to b noted that although the first motion vectors to be improved being two first motion vectors is taken as an example to describe in the present embodiment, the specific number of the first motion vectors to be improved of the N first motion vectors is not limited in the present embodiment. That is to say, if the number of first motion vectors to be improved is more than two, the manner of search in the embodiment of the present disclosure may also be used for improving the multiple first motion vectors.

In this embodiment, the current block may be partitioned into at least one second sub-block, and each second sub-block is separately improved.

It is to be noted that, in this embodiment, if the at least one second sub-block includes one second sub-block, and the second sub-block has a size being same as the size of the current block, then the encoding end performs the whole-block search in a unit of the current block. In this embodiment, if the second sub- has a size smaller than the size of the current block, then the encoding end performs the search in a part of area in the current block to obtain an second motion vector subjected to the improvement of the part of area, and then predicts and optimizes a picture of the part of area based on the second motion vector subjected to the improvement, to improve a picture encoding effect for the part of area.

The size and shape of at least one second sub-block partitioned from the current block is not limited in the embodiment of the present disclosure. Exemplarily, the size of the second sub-block is 4×4, 8×8, 16×16, etc. In some embodiments, the encoding end may partition the whole current block into one or more second sub-blocks, i.e., there is no area that is not partitioned in the current block. In some embodiments, the encoding end partitions a part of area in the current block into at least one second sub-block, and the encoding end does not partition the other area in the current block.

The manners where the encoding end performs the matching search on all second sub-blocks of the at least one second sub-block obtained by the partitioning to obtain the second motion vectors corresponding to the second sub-blocks are the same as each other. For convenience of description, one second sub-block is taken as an example to describe.

Specifically, as shown in FIG. 20, the encoding end searches in the first reference picture by using the first one of the at least one first motion vector as the search starting point to obtains of the multiple third reference sub-blocks corresponding to the second sub-block; searches in the second reference picture by using the second one of the at least one first motion vector as the search starting point to obtain the multiple fourth reference sub-blocks corresponding to the second sub-block. Then, the matching cost between each pair of the third reference sub-block and the fourth reference sub-block of the multiple third reference sub-blocks and the multiple fourth reference sub-blocks is calculated; and a pair of the third reference sub-block and the fourth reference sub-block corresponding to the smallest matching cost is obtained. In this way, the first one of the second motion vectors corresponding to the second sub-block may be obtained based on the motion vector corresponding to the third reference sub-block corresponding to the smallest matching cost, and the second one of the second motion vectors corresponding to the second sub-block may be obtained based on the motion vector corresponding to the fourth reference sub-block corresponding to the smallest matching cost.

It is to be noted that, in some embodiments, after one third reference sub-block and one fourth reference sub-block are searched, the encoding end may match the third reference sub-block with the fourth reference sub-block to obtain a matching cost between the third reference sub-block and the fourth reference sub-block. In some embodiments, the encoding end may firstly obtain multiple third reference sub-blocks and multiple fourth reference sub-blocks by searching, and then perform one-to-one matching between each of the multiple third reference sub-blocks and each of the multiple fourth reference sub-blocks, to obtain the matching cost between each third reference sub-block and each fourth reference sub-block.

Hereinafter, a process of determining the matching cost between the third reference sub-block and the fourth reference sub-block is described.

The specific process of determining the matching cost between the third reference sub-block and the fourth reference sub-block is not limited in the embodiment of the present disclosure.

In some embodiments, the operation S202-B1-B3 includes the operations S202-B1-B31 and S202-B1-B32.

In operation S202-B1-B31, for any one of the multiple third reference sub-blocks and any one of the multiple fourth reference blocks, a first matching cost between the third reference sub-block and the fourth reference sub-block is determined.

In operation S202-B1-B32: a matching cost between the third reference sub-block and the fourth reference sub-block is obtained based on the first matching cost.

In this embodiment, for any one of the multiple third reference sub-blocks and any one of the multiple fourth reference blocks, the first matching cost between the third reference sub-block and the fourth reference sub-block is determined. Furthermore, the matching cost between the third reference sub-block and the fourth reference sub-block is determined based on the first matching cost. For example, the first matching cost is determined as the matching cost between the third reference sub-block and the fourth reference sub-block.

Herein, the manner of determining the first matching cost between the third reference sub-block and the fourth reference sub-block in operation S202-B1-B31 may be the same as the manner of determining the matching cost between the first reference sub-block and the second reference sub-block.

In some embodiments, since both the third reference sub-block and the fourth reference sub-block are picture blocks in the encoded reference picture, a sample value of each sample of the third reference sub-block and the fourth reference sub-block is known. Based on this, the encoding end may compare the sample value of each sample of the third reference sub-block with the sample value of the corresponding sample of the second reference sub-block, to obtain the matching cost between the third reference sub-block and the fourth reference sub-block. For example, a difference value between the sample value of the sample 1 of the third reference sub-block and the sample value of the sample 1 of the fourth reference sub-block is determined, a difference value between the sample value of the sample 2 of the third reference sub-block and the sample value of the sample 2 of the fourth reference sub-block is determined, and so on. Difference values between the samples in the third reference sub-block and the samples in the fourth reference sub-block are determined; and matching cost between the third reference sub-block and the fourth reference sub-block is obtained based on the difference values between the samples. For example, the sum of the difference values between the samples in the third reference sub-block and the samples in the fourth reference sub-block is determined as the matching cost between the third reference sub-block and the fourth reference sub-block.

In some embodiments, when the embodiment of the present disclosure is applied to the GPM, the matching cost between the third reference sub-block and the fourth reference sub-block may be determined by the following operations S102-B1-B311 to S102-B1-B313. That is to say, the first matching cost between the third reference sub-block and the fourth reference sub-block in the above S102-B1-B31 may include operations S102-B1-B311 to S102-B1-B313.

In operation S202-B1-B311, a weight derivation mode for the current block is determined.

In operation S202-B1-B312, a weight corresponding to the i-th prediction mode is determined based on the weight derivation mode.

In operation S202-B1-B313, the first matching cost between the third reference sub-block and the fourth reference sub-block is obtained based on the weight corresponding to the i-th prediction mode and the third reference sub-block and the fourth reference sub-block.

In this embodiment, the i-th prediction mode is the N-directional prediction mode, and the prediction block predicted by the N-directional prediction mode is used in the GPM. That is to say, for a prediction block having the size being the same as the size of the current block, a part of the prediction block (i.e., the part having a non-zero weight) will work, and the other part of the prediction block (i.e., the part having a weight of 0) will not work. Therefore, when the matching cost is calculated for the N-directional prediction, a mask similar to the GPM prediction may be used for the manner of calculating the matching cost.

The specific manners of determining the weight derivation mode for the current block and determining the weight corresponding to the i-th prediction mode based on the weight derivation mode may be referred to the related descriptions of operation 1 and operation 2, which is not repeated herein.

The specific manners where the first matching cost between the third reference sub-block and the fourth reference sub-block is obtained based on the weight corresponding to the i-th prediction mode and the third reference sub-block and the fourth reference sub-block in operation S202-B1-B313 include, but are not limited to, the following several implementations.

In a possible implementation, based on the weight corresponding to the i-th prediction mode, only the areas where the weight corresponding to the i-th prediction mode is not zero in the third reference sub-block and the fourth reference sub-block are processed to obtain the matching cost between the third reference sub-block and the fourth reference sub-block.

In another possible implementation, the encoding end obtains a second differential value based on the third reference sub-block and the fourth reference sub-block; and multiplies the weight corresponding to the i-th prediction mode with the second differential value, to obtain the first matching cost between the third reference sub-block and the fourth reference sub-block. The manner of obtaining the second differential value based on the third reference sub-block and the fourth reference sub-block may be that: a difference value between the third reference sub-block and the fourth reference sub-block is determined as the second differential value, or an absolute value of the difference value between the third reference sub-block and the fourth reference sub-block is determined as the second differential value, or may be that: the difference value between the third reference sub-block and the fourth reference sub-block is determined, and preset processing is performed on the difference value to obtain the second differential value.

In an example, the first matching cost SADwithMask2 between the third reference sub-block and the fourth reference sub-block may be obtained according to the above formula (11).

In some embodiments, the manner of calculating the wValue may also be simplified, for example, the w Value for calculating the SADwithMask1 is simplified to have a value of only 0 and 1, to facilitate calculation.

Based on the above operations, the encoding end may determine the first matching cost between each of the multiple third reference sub-blocks and each of the multiple fourth reference sub-blocks; and obtain the matching cost between the third sub-block and the fourth reference sub-block based on the first matching costs.

In an example, operation S202-B1-B32 includes: the encoding end may directly determine the first matching cost as the matching cost between the third reference sub-block and the fourth reference sub-block.

In another example, the operation S202-B1-B32 includes following operations S202-B1-B321 to S202-B1-B323.

In operation S202-B1-B321, a second matching cost between a template of the third reference sub-block and a template of the second sub-block is determined.

In operation S202-B1-B322, a third matching cost between a template of the fourth reference sub-block and the template of the second sub-block is determined.

In operation S202-B1-B323, the matching cost between the third reference sub-block and the fourth reference sub-block is obtained based on the first matching cost, the second matching cost, and the third matching cost.

In this example, the motion vector is improved by using the template matching. For example, the encoding end improves the motion vector of the current block by using the template matching and the above-described manner of the matching search, to improve the precision of the motion vector of the current block. Furthermore, when the current block is predicted based on the high-precision motion vector, the prediction accuracy for the current block can be improved, and thus the encoding effect can be improved.

The size and position of the template used for calculation is not limited in the embodiment of the present disclosure. In some embodiments, the template used for calculation may be a top template, or a left template, or top and left templates.

As shown in FIG. 21, in the template matching, the template area of the reference block is compared with the template area of the current block. For example, the template of the third reference sub-block is compared with the template of the second sub-block to obtain the second matching cost CostTm0 between the template of the third reference sub-block and the template of the second sub-block; the template of the fourth reference sub-block is compared with the template of the second sub-block to obtain the third matching cost CostTm1 between the template of the third reference sub-block and the template of the second sub-block.

The manner of determining the second matching cost between the template of the third reference sub-block and the template of the second sub-block may be that: a third differential value between the template of the third reference sub-block and the template of the second sub-block is determined. For example, an absolute value of the difference value between the template of the third reference sub-block and the template of the second sub-block is determined as the third differential value between the template of the third reference sub-block and the template of the second sub-block; and then, the weight of the template is determined, and a product of the weight of the template and the third differential value is determined as the second matching cost CostTm0 between the template of the third reference sub-block and the template of the second sub-block. Similarly, the manner of determining the third matching cost between the template of the fourth reference sub-block and the template of the second sub-block may be that: a fourth differential value between the template of the fourth reference sub-block and the template of the second sub-block is determined, for example, an absolute value of the difference value between the template of the fourth reference sub-block and the template of the second sub-block is determined as the fourth differential value between the template of the fourth reference sub-block and the template of the second sub-block; and then, the weight of the template is determined, and a product of the weight of the template and the fourth differential value is determined as the third matching cost CostTm1 between the template of the fourth reference sub-block and the template of the second sub-block. Herein, the manner of determining the weight of the template may refer to the description of the above-described embodiments, which will not be repeatedly described herein.

After the encoding end determines the second matching cost between the template of the third reference sub-block and the template of the second sub-block and the third matching cost between the template of the fourth reference sub-block and the template of the second sub-block, the encoding end obtains the matching cost between the third reference sub-block and the fourth reference sub-block based on the first matching cost, the second matching cost and the third matching cost.

For example, the first matching cost is added to the second matching cost and the third matching cost, to obtain the matching cost between the third reference sub-block and the fourth reference sub-block.

Exemplarily, the matching cost between the third reference sub-block and the fourth reference sub-block may be determined based on the above formula (11).

For another example, weighted summation is performed on the first matching cost, the second matching cost and the third matching cost, to obtain the matching cost between the third reference sub-block and the fourth reference sub-block. In this example, each of the first matching cost, the second matching cost, and the third matching cost corresponds to one weight. Optionally, the weights corresponding to the first matching cost, the second matching cost, and the third matching cost may be preset values, respectively.

For another example, a first weighting factor corresponding to the first matching cost is determined; a second weighting factor corresponding to the second matching cost and the third matching cost is determined; the first matching cost, the second matching cost, and the third matching cost are weighted based on the first weighting factor and the second weighting factor, to obtain the matching cost between the third reference sub-block and the fourth reference sub-block.

In this example, the first matching cost corresponds to one weight denoted as the first weighting factor; the second matching cost and the third matching cost collectively correspond to one weight denoted as the second weighting factor. Optionally, the first weighting factor and the second weighting factor may be preset values.

In an example, the matching cost between the third reference sub-block and the fourth reference sub-block may be determined based on the above formula (11).

Based on the above operations, the encoding end determines a matching point between each of the multiple third reference sub-blocks and each of the multiple fourth reference sub-blocks. In this way, the third reference sub-block and the fourth reference sub-block corresponding to the smallest matching cost may be selected from the multiple third reference sub-blocks and the multiple fourth reference sub-blocks; and then the first one of the second motion vectors may be obtained based on the motion vector of the third reference sub-block corresponding to the smallest matching cost, and the second one of the second motion vectors may be obtained based on the motion vector of the fourth reference sub-block corresponding to the smallest matching cost.

In a possible implementation, the encoding end may directly determine the motion vector corresponding to the third reference sub-block corresponding to the smallest matching cost as the first one of the second motion vectors corresponding to the second sub-block, and determine the motion vector corresponding to the fourth reference sub-block corresponding to the smallest matching cost as the second one of the second motion vectors corresponding to the second sub-block.

In another possible implementation, a fractional-pixel search may be performed for higher precision, such as ½ pixel precision, ¼ pixel precision, 1/16 pixel precision, etc. Specifically, the fractional-pixel search is performed within a surrounding area of the third reference sub-block corresponding to the smallest matching cost to obtain a motion vector of a second fractional-pixel; and the first one of the second motion vectors corresponding to the second sub-block is obtained based on the motion vector of the second fractional-pixel and the matching cost. Similarity, the fractional-pixel search is performed within a surrounding area of the fourth reference sub-block corresponding to the smallest matching cost to obtain a motion vector of a third fractional-pixel; and a second one of the second motion vectors corresponding to the second sub-block is obtained based on the motion vector of the third fractional-pixel and the motion vector corresponding to the fourth reference sub-block corresponding to the smallest matching cost.

The specific process of determining two second motion vectors corresponding to one second sub-block is described above, and the above manner may be adopted for each second sub-block of the current block to determine two second motion vectors corresponding to each second sub-block; and then a prediction value of each second sub-block in the i-th prediction mode is obtained based on the first one of the second motion vectors and the second one of the second motion vectors that correspond to each second sub-block.

The process of determining the prediction value of the current block in the i-th prediction mode when the i-th prediction mode among the K prediction modes is the N-directional prediction mode is described above.

If other prediction modes other than the i-th prediction mode among the K prediction modes are also the N-directional prediction modes, prediction values of the current block in the other prediction modes may be determined by referring to the above operations.

If the K prediction modes include other prediction modes in addition to the N-directional prediction mode, for example, the K prediction modes include the unidirectional prediction mode, then the current block is predicted by using the unidirectional prediction mode, and the prediction value of the current block in the unidirectional prediction mode is obtained.

In the embodiment of the present disclosure, the manner of predicting the current block based on the K prediction modes to obtain the prediction value of the current block includes, but is not limited to, the following case 1 and case 2.

In the case 1, when the encoding end predicts the current block based on K prediction modes, without considering the weight derivation mode. For example, the encoding end predicts the current block by using the K prediction modes for the current block, respectively, to obtain K prediction values of the current block, and processes the K prediction values to obtain the prediction value of the current block. Specifically, an average value, a sum value, a weighted summation value, etc. of the i-th prediction value of the current block determined above and other prediction values is used as the prediction value of the current block.

In the case 2, the encoding end predicts the current block based on the K prediction modes for the current block and the weight derivation mode for the current block. In this case, the operation S202-D includes the following operations S202-D1 and S202-D2

In operation S202-D1, weights of the prediction values are determined based on the weight derivation mode.

In operation S202-D2, the i-th prediction value and the other prediction values are weighted based on the weights of the prediction values to obtain the prediction value of the current block.

In this case 2, when the prediction value of the current block is determined, the weight derivation mode is considered, and the weights of the prediction values are further determined based on the weight derivation mode. In this way, the encoding end may weight the i-th prediction value and the other prediction values based on the weights of the prediction values to obtain the prediction value of the current block.

The specific process of determining the weights of the prediction values based on the weight derivation mode is not limited in the embodiment of the present disclosure.

In some embodiments, if the weight gradient parameter (also referred to as a blending parameter) is not considered when the weights of the prediction values are determined, then the weights of the prediction values of the current block are directly determined based on the weight derivation mode for the current block.

In some embodiments, when the weights of the prediction values are determined, the weight gradient parameter is considered. In this case, the weight gradient parameter may be determined, and then the weights of the prediction values may be obtained according to the weight gradient parameter and the weight derivation mode for the current block.

Exemplarily, the value of the weight gradient parameter blendingCoeff may be derived by the weight gradient index gpm_blending_idx.

In this way, the K prediction values (such as, the i-th prediction value and other prediction values) may be weighted based on the weights of the prediction values determined above to obtain the prediction value of the current block.

In some embodiments, the prediction process is performed in a unit of sample; correspondingly, the weight of the prediction value is also the weight corresponding to the sample. In this case, when the current block is predicted, a certain sample A in the current block is predicted by using each of the K prediction modes for the current block to obtain K prediction values in the K prediction modes for the current block with respect to the sample A; and the weights of the prediction values of the sample A is determined according to the weight derivation mode for the current block and the weight gradient parameter. Furthermore, the K prediction values are weighted by using the weights of the prediction values of the sample A to obtain the prediction values of the sample A. the above operations are performed on each sample in the current block, and the prediction values of each sample in the current block may be obtained, and the prediction values of each sample in the current block constitutes the prediction value of the current block. Taking K=2 as an example, a first one of the prediction modes is used for predicting a certain sample A in the current block to obtain a first prediction value of the sample A, a second one of the prediction modes is used for predicting the sample A to obtain a second prediction value of the sample A, and the first prediction value and the second prediction value are weighted according to weights of prediction values corresponding to the sample A to obtain the prediction value of the sample A.

In some embodiments, if K is greater than 2, the weights of prediction values corresponding to two prediction modes among the K prediction modes for the current block may be determined according to the weight derivation mode for the current block, and the weights of prediction values corresponding to other prediction modes among the K prediction modes for the current block may be preset values. For example, K=3, the first weight of the prediction values corresponding to the first one of the prediction modes and the second one of the prediction modes is derived according to the weight derivation mode, and the weight of the prediction value corresponding to the third prediction mode is a preset value. In some embodiments, if the weight of the total prediction values corresponding to the K prediction modes for the current block is a fixed value, such as, 8, then a weight of a prediction value corresponding to each of the K prediction modes for the current block may be determined according to a preset weight ratio. It is assumed that the weight of the prediction value corresponding to the third one of the prediction modes accounts for ¼ of the weight of the all prediction values, the weight of the prediction value of the third one of the prediction modes may be determined to be 2, and the remaining ¾ of the weight of the all prediction values is allocated to the first one of the prediction modes and the second one of the prediction modes. For example, if the weight of the prediction value corresponding to the first one of the prediction modes derived according to the weight derivation mode for the current block is 3, then it is determined that the weight of the prediction value corresponding to the first one of the prediction modes is (¾)*3, and the weight of the prediction value corresponding to the second one of the prediction modes is (¾)*5.

According to the above method, the prediction value of the current block is determined. Moreover, the quantization coefficient of the current block is determined, inverse quantization and inverse transform is performed on the quantization coefficient of the current block to obtain the residual value of the current block, and the prediction value of the current block is added to the residual value of the current block to obtain the reconstructed value of the current block.

In the method for video encoding provided by the embodiment of the present disclosure, when the encoding end encodes the current block, the encoding end determines K prediction modes for the current block, and at least one prediction mode of the K prediction modes is a multi-directional prediction mode (for example, a bi-directional prediction mode), so that when the K prediction modes are used for predicting the current block, the prediction accuracy for the current block can be improved, and the encoding effect for the video can be improved.

It is to be understood that FIG. 15 to FIG. 19 are merely examples of the present disclosure and should not be construed as limitations of the present disclosure.

Preferred embodiments of the present disclosure have been described in detail with reference to the accompanying drawings, but the present disclosure is not limited to the specific details of the above embodiments. Within the scope of the technical conception of the present disclosure, various simple modifications may be made to the technical solution of the present disclosure, and these simple modifications all fall within the scope of protection of the present disclosure. For example, each of the specific technical features described in the above specific embodiments may be combined in any suitable manner without contradiction, and various possible combinations are not further described in this disclosure in order to avoid unnecessary repetition.

It is to be understood that, in various embodiments of the present disclosure, the sequence numbers of the above processes do not imply the sequence of execution, and the sequence of execution of each process should be determined according to its functions and internal logic, and should not constitute any limitation on the implementation process of the embodiments of the present disclosure. In addition, in embodiments of the present disclosure, the term “and/or” is only an association relationship describing associated objects and represents that three relationships may exist. For example, A and/or B may represent three conditions: i.e., independent existence of A, existence of both A and B and independent existence of B. In addition, the character “/” in the present disclosure generally indicates that the relationship between the associated objects is “or”.

The method embodiments of the present disclosure are described in detail above with reference to FIG. 18 to FIG. 22. Hereinafter, and device embodiments of the present disclosure are described in detail with reference to FIG. 23 to FIG. 26.

FIG. 23 is a flowchart of a method for video decoding according to an embodiment of the present disclosure, and the device 10 for video decoding is applied to the video decoder described above.

As shown in FIG. 23, the device 10 for video decoding includes a determining unit 11 and a predicting unit 12.

The determining unit 11 is configured to determine prediction modes for a current block, where at least one of the K prediction modes is an N-directional prediction mode, and each of the K and N is a positive integer greater than 1.

The predicting unit 12 is configured to predict the current block based on the K prediction modes to obtain a prediction value of the current block.

In some embodiments, the predicting unit 12 is specifically configured to: for an i-th prediction mode among the K prediction modes, if the i-th prediction mode is the N-directional prediction mode, determine N pieces of first motion information corresponding to the i-th prediction mode, where i is a positive integer less than or equal to K; obtain an i-th prediction value of the current block based on the N pieces of first motion information; predict the current block by using prediction modes other than the i-th prediction mode among the K prediction modes, to obtain other prediction values of the current block; and obtaining the prediction value of the current block based on the i-th prediction value and the other prediction values.

In some embodiments, the first motion information includes a first motion vector, and the predicting unit 12 is specifically configured to: improve at least one first motion vector of the N first motion vectors to obtain at least one second motion vector; and obtain the i-th prediction value of the current block based on the at least one second motion vector.

In some embodiments, the predicting unit 12 is specifically configured to: determine motion vector difference information; obtain a first motion vector difference based on the motion vector difference information; and improve the at least one first motion vector of the N first motion vectors based on the first motion vector difference, to obtain the at least one second motion vector.

In some embodiments, the motion vector difference information includes: a direction index and a distance index, and the predicting unit 12 is specifically configured to: decoding a bitstream to obtain the direction index and the distance index, and obtain the first motion vector difference based on the direction index and the distance index.

In some embodiments, before the bitstream is decoded to obtain the direction index and the distance index, the predicting unit 12 is further configured to: decode the bitstream to obtain first information, where the first information indicates whether the i-th prediction mode is improved by using motion vector difference; and if the i-th prediction mode is improved by using the motion vector difference, decode the bitstream to obtain the direction index and the distance index.

In some embodiments, the predicting unit 12 is specifically configured to improve all of the N first motion vectors based on the first motion vector difference to obtain N second motion vectors.

In some embodiments, the N is 2, the N first motion vectors comprise a first one of the N first motion vectors and a second one of the N first motion vectors, and the predicting unit 12 is specifically configured to: improve the first one of the N first motion vectors based on the first motion vector difference to obtain a first one of second motion vectors; determine a second motion vector difference based on the first motion vector difference; and improve the second one of the N first motion vectors based on the second motion vector difference to obtain a second one of the second motion vectors.

In some embodiments, the predicting unit 12 is specifically configured to add the second motion vector difference to the second one of the N first motion vectors to obtain the second one of the second motion vectors.

In some embodiments, the N is 2, the N first motion vectors comprise a first one of the N first motion vectors and a second one of the N first motion vectors, and the predicting unit 12 is specifically configured to: improve the first one of the N first motion vectors based on the first motion vector difference to obtain a first one of second motion vectors; and perform, based on the second one of the N first motion vectors, a matching search within a preset search range of a reference picture corresponding to the second one of the N first motion vectors, to obtain the second one of the second motion vectors.

In some embodiments, the predicting unit 12 is specifically configured to: the current block into at least one first sub-block; and for any one of the at least one first sub-block, perform the matching search within the preset search range of the reference picture corresponding to the second one of the N first motion vectors to obtain the second one of the second motion vectors corresponding to the first sub-block.

In some embodiments, the predicting unit 12 is specifically configured to: determine a search starting point corresponding to the second one of the N first motion vectors, and perform by using the search starting point as a starting point, search within the preset search range of the reference picture corresponding to the second one of the N first motion vectors to obtain multiple first reference sub-blocks corresponding to the first sub-block; determine, based on the first one of the second motion vectors, a second reference sub-block corresponding to the first sub-block from a reference picture corresponding to the first one of the N first motion vectors; determine matching costs between the multiple first reference sub-blocks and the second reference sub-block, and select a first reference sub-block corresponding to a smallest matching cost from the multiple first reference sub-blocks; and obtain the second one of the second motion vectors corresponding to the first sub-block based on a motion vector corresponding to the first reference sub-block corresponding to the smallest matching cost.

In some embodiments, the predicting unit 12 is specifically configured to use the second one of the N first motion vectors as the search starting point.

In some embodiments, the predicting unit 12 is specifically configured to: improve the second one of the N first motion vectors based on the first motion vector difference to obtain an improved second one of the N first motion vectors; and use the improved second one of the N first motion vectors as the search starting point.

In some embodiments, the predicting unit 12 is specifically configured to add the first motion vector difference to the second one of the N first motion vectors to obtain the improved second one of the N first motion vectors.

In some embodiments, the predicting unit 12 is specifically configured to: determine a second motion vector difference based on the first motion vector difference; improve the second one of the N first motion vectors based on the second motion vector difference to obtain an improved second one of the N first motion vectors; and use the improved second one of the N first motion vectors as the search starting point.

In some embodiments, the predicting unit 12 is specifically configured to add the second motion vector difference to the second one of the N first motion vectors to obtain the improved second one of the N first motion vectors.

In some embodiments, the predicting unit 12 is specifically configured to: determine a weight derivation mode for the current block; determining a weight corresponding to the i-th prediction mode based on the weight derivation mode; and for any one of the multiple first reference sub-blocks, obtain a matching cost between the first reference sub-block and the second reference sub-block based on the weight corresponding to the i-th prediction mode and the first reference sub-block and the second reference sub-block.

In some embodiments, the predicting unit 12 is configured to: obtain a first differential value based on the first reference sub-block and the second reference sub-block; and multiply the weight corresponding to the i-th prediction mode with the first differential value, to obtain the matching cost between the first reference sub-block and the second reference sub-block.

In some embodiments, the predicting unit 12 is specifically configured to determine an absolute value of a difference value between the first reference sub-block and the second reference sub-block as the first differential value.

In some embodiments, the predicting unit 12 is specifically configured to: perform fractional-pixel search within a surrounding area of the first reference sub-block corresponding to the smallest matching cost to obtain a motion vector of a first fractional-pixel; and obtain the second one of the second motion vectors corresponding to the first sub-block based on the motion vector of the first fractional-pixel and the motion vector corresponding to the first reference sub-block corresponding to the smallest matching cost.

In some embodiments, the predicting unit 12 is specifically configured to: determine a picture order count of a first reference picture corresponding to the first one of the N first motion vectors, a picture order count of a current picture, and a picture order count of a second reference picture corresponding to the second one of the N first motion vectors; and determine the second motion vector difference based on the picture order count of the first reference picture, the picture order count of the current picture, the picture order count of the second reference picture and the first motion vector difference.

In some embodiments, the predicting unit 12 is specifically configured to: determine a first difference value between the picture order count of the second reference picture and the picture order count of the current picture; determine a second difference value between the picture order count of the first reference picture and the picture order count of the current picture; and obtain the second motion vector difference based on the first difference value, the second difference value, and the first motion vector difference.

In some embodiments, the predicting unit 12 is specifically configured to: determine a ratio between the first difference value and the second difference value; and determine a product of the ratio and the first motion vector difference as the second motion vector difference.

In some embodiments, the predicting unit 12 is specifically configured to add the first motion vector difference to the first motion vector to obtain the second motion vector.

In some embodiments, the predicting unit 12 is specifically configured to: based on the at least one first motion vector, perform a matching search within a preset search range of a reference picture corresponding to the at least one first motion vector, to obtain the at least one second motion vector.

In some embodiments, the at least one first motion vector includes a first one of the at least one first motion vector and a second one of the at least one first motion vector, and the predicting unit 12 is specifically configured to: partition the current block into at least one second sub-block; for any one of the at least one second sub-block, perform the matching search within a preset search range of a reference picture corresponding to the first one of the at least one first motion vector, to obtain multiple third reference sub-blocks corresponding to the second sub-block, and perform the matching search within a preset search range of a reference picture corresponding to the second one of the at least one first motion vector, to obtain multiple fourth reference sub-blocks corresponding to the second sub-block; determine matching costs between the multiple third reference sub-blocks and the multiple fourth reference sub-blocks, and select a third reference sub-block and a fourth reference sub-block corresponding to a smallest matching cost from the multiple third reference sub-blocks and the multiple fourth reference sub-blocks; and obtain a first one of second motion vectors corresponding to the second sub-block based on a motion vector corresponding to the third reference sub-block corresponding to the smallest matching cost, and obtain a second one of the second motion vectors corresponding to the second sub-block based on a motion vector corresponding to the fourth reference sub-block corresponding to the smallest matching cost.

In some embodiments, the predicting unit 12 is specifically configured to: for any one of the multiple third reference sub-blocks and any one of the multiple fourth reference blocks, determine a first matching cost between the third reference sub-block and the fourth reference sub-block; and obtain a matching cost between the third reference sub-block and the fourth reference sub-block based on the first matching cost.

In some embodiments, the predicting unit 12 is specifically configured to: determine a weight derivation mode for the current block; determine a weight corresponding to the i-th prediction mode based on the weight derivation mode; and obtain the first matching cost between the third reference sub-block and the fourth reference sub-block based on the weight corresponding to the i-th prediction mode and the third reference sub-block and the fourth reference sub-block.

In some embodiments, the predicting unit 12 is configured to: obtain a second differential value based on the third reference sub-block and the fourth reference sub-block; and multiply the weight corresponding to the i-th prediction mode with the second differential value to obtain the first matching cost.

In some embodiments, the predicting unit 12 is specifically configured to determine an absolute value of a difference value between the third reference sub-block and the fourth reference sub-block as the second differential value.

In some embodiments, the predicting unit 12 is specifically configured to determine the first matching cost as the matching cost between the third reference sub-block and the fourth reference sub-block.

In some embodiments, the predicting unit 12 is specifically configured to: determine a second matching cost between a template of the third reference sub-block and a template of the second sub-block; determine a third matching cost between a template of the fourth reference sub-block and the template of the second sub-block; and obtain the matching cost between the third reference sub-block and the fourth reference sub-block based on the first matching cost, the second matching cost, and the third matching cost.

In some embodiments, the predicting unit 12 is specifically configured to add the first matching cost, the second matching cost and the third matching cost, to obtain the matching cost between the third reference sub-block and the fourth reference sub-block.

In some embodiments, the predicting unit 12 is specifically configured to perform weighted summation on the first matching cost, the second matching cost and the third matching cost, to obtain the matching cost between the third reference sub-block and the fourth reference sub-block.

In some embodiments, the predicting unit 12 is specifically configured to: determine a first weighting factor corresponding to the first matching cost; determine a second weighting factor corresponding to the second matching cost and the third matching cost; and weight the first matching cost, the second matching cost, and the third matching cost based on the first weighting factor and the second weighting factor, to obtain the matching cost between the third reference sub-block and the fourth reference sub-block.

In some embodiments, the predicting unit 12 is specifically configured to: perform a fractional-pixel search within a surrounding area of the third reference sub-block corresponding to the smallest matching cost to obtain a motion vector of a second fractional-pixel; obtain the first one of the second motion vectors corresponding to the second sub-block based on the motion vector of the second fractional-pixel and the motion vector corresponding to the third reference sub-block corresponding to the smallest matching cost; perform the fractional-pixel search within a surrounding area of the fourth reference sub-block corresponding to the smallest matching cost to obtain a motion vector of a third fractional-pixel; and obtain the second one of the second motion vectors corresponding to the second sub-block based on the motion vector of the third fractional-pixel and the motion vector corresponding to the fourth reference sub-block corresponding to the smallest matching cost.

In some embodiments, the predicting unit 12 is specifically configured to: determine weights of prediction values based on the weight derivation mode; and weight the i-th prediction value and the other prediction values based on the weights of the prediction values to obtain the prediction value of the current block.

It is to be understood that device embodiments and method embodiments may correspond to each other and similar descriptions of the device embodiments may refer to the method embodiments, which is not described again herein to avoid repetition. In particular, the device 10 shown in FIG. 23 may perform the method for video decoding in the embodiments of the present disclosure, and the above and other operations and/or functions of all units in the device 10 respectively implement the corresponding workflows of the method for video decoding, which are not repeated herein for the sake of brevity.

FIG. 24 is a schematic block diagram of a device for video encoding according to an embodiment of the present disclosure, and the device for video encoding is applied to the encoder described above.

As shown in FIG. 24, the device 20 for video encoding may include a determining unit 21 and a predicting unit 22.

The determining unit 21 is configured to determine prediction modes for a current block, where at least one of the K prediction modes is an N-directional prediction mode, and each of the K and N is a positive integer greater than 1.

The predicting unit 22 is configured to predict the current block based on the K prediction modes to obtain a prediction value of the current block.

In some examples, the predicting unit 22 is specifically configured to: for an i-th prediction mode among the K prediction modes, if the i-th prediction mode is the N-directional prediction mode, determine N pieces of first motion information corresponding to the i-th prediction mode, where i is a positive integer less than or equal to K; obtain an i-th prediction value of the current block based on the N pieces of first motion information; predict the current block by using prediction modes other than the i-th prediction mode among the K prediction modes, to obtain other prediction values of the current block; and obtaining the prediction value of the current block based on the i-th prediction value and the other prediction values.

In some embodiments, the first motion information includes a first motion vector, and the predicting unit 22 is specifically configured to: improve at least one first motion vector of the N first motion vectors to obtain at least one second motion vector; and obtain the i-th prediction value of the current block based on the at least one second motion vector.

In some embodiments, the predicting unit 22 is specifically configured to: determine motion vector difference information; obtain a first motion vector difference based on the motion vector difference information; and improve the at least one first motion vector of the N first motion vectors based on the first motion vector difference, to obtain the at least one second motion vector.

In some embodiments, the motion vector difference information includes: a direction index and a distance index, and the predicting unit 22 is specifically configured to: determine the direction index and the distance index, and obtain the first motion vector difference based on the direction index and the distance index.

In some embodiments, before the direction index and the distance index is determined, the predicting unit 22 is further configured to: determine first information, where the first information indicates whether the i-th prediction mode is improved by using motion vector difference; and if the i-th prediction mode is improved by using the motion vector difference, determine the direction index and the distance index.

In some embodiments, the predicting unit 22 is specifically configured to improve all of the N first motion vectors based on the first motion vector difference to obtain N second motion vectors.

In some embodiments, the N is 2, the N first motion vectors comprise a first one of the N first motion vectors and a second one of the N first motion vectors, and the predicting unit 22 is specifically configured to: improve the first one of the N first motion vectors based on the first motion vector difference to obtain a first one of second motion vectors; determine a second motion vector difference based on the first motion vector difference; and improve the second one of the N first motion vectors based on the second motion vector difference to obtain a second one of the second motion vectors.

In some embodiments, the predicting unit 22 is specifically configured to add the second motion vector difference to the second one of the N first motion vectors to obtain the second one of the second motion vectors.

In some embodiments, the N is 2, the N first motion vectors comprise a first one of the N first motion vectors and a second one of the N first motion vectors, and the predicting unit 22 is specifically configured to: improve the first one of the N first motion vectors based on the first motion vector difference to obtain a first one of second motion vectors; and perform, based on the second one of the N first motion vectors, a matching search within a preset search range of a reference picture corresponding to the second one of the N first motion vectors, to obtain the second one of the second motion vectors.

In some embodiments, the predicting unit 22 is specifically configured to: the current block into at least one first sub-block; and for any one of the at least one first sub-block, perform the matching search within the preset search range of the reference picture corresponding to the second one of the N first motion vectors to obtain the second one of the second motion vectors corresponding to the first sub-block.

In some embodiments, the predicting unit 22 is specifically configured to: determine a search starting point corresponding to the second one of the N first motion vectors, and perform by using the search starting point as a starting point, search within the preset search range of the reference picture corresponding to the second one of the N first motion vectors to obtain multiple first reference sub-blocks corresponding to the first sub-block; determine, based on the first one of the second motion vectors, a second reference sub-block corresponding to the first sub-block from a reference picture corresponding to the first one of the N first motion vectors; determine matching costs between the multiple first reference sub-blocks and the second reference sub-block, and select a first reference sub-block corresponding to a smallest matching cost from the multiple first reference sub-blocks; and obtain the second one of the second motion vectors corresponding to the first sub-block based on a motion vector corresponding to the first reference sub-block corresponding to the smallest matching cost.

In some embodiments, the predicting unit 22 is specifically configured to use the second one of the N first motion vectors as the search starting point.

In some embodiments, the predicting unit 22 is specifically configured to: improve the second one of the N first motion vectors based on the first motion vector difference to obtain an improved second one of the N first motion vectors; and use the improved second one of the N first motion vectors as the search starting point.

In some embodiments, the predicting unit 22 is specifically configured to add the first motion vector difference to the second one of the N first motion vectors to obtain the improved second one of the N first motion vectors.

In some embodiments, the predicting unit 22 is specifically configured to: determine a second motion vector difference based on the first motion vector difference; improve the second one of the N first motion vectors based on the second motion vector difference to obtain an improved second one of the N first motion vectors; and use the improved second one of the N first motion vectors as the search starting point.

In some embodiments, the predicting unit 22 is specifically configured to add the second motion vector difference to the second one of the N first motion vectors to obtain the improved second one of the N first motion vectors.

In some embodiments, the predicting unit 22 is specifically configured to: determine a weight derivation mode for the current block; determining a weight corresponding to the i-th prediction mode based on the weight derivation mode; and for any one of the multiple first reference sub-blocks, obtain a matching cost between the first reference sub-block and the second reference sub-block based on the weight corresponding to the i-th prediction mode and the first reference sub-block and the second reference sub-block.

In some embodiments, the predicting unit 22 is configured to: obtain a first differential value based on the first reference sub-block and the second reference sub-block; and multiply the weight corresponding to the i-th prediction mode with the first differential value, to obtain the matching cost between the first reference sub-block and the second reference sub-block.

In some embodiments, the predicting unit 22 is specifically configured to determine an absolute value of a difference value between the first reference sub-block and the second reference sub-block as the first differential value.

In some embodiments, the predicting unit 22 is specifically configured to: perform fractional-pixel search within a surrounding area of the first reference sub-block corresponding to the smallest matching cost to obtain a motion vector of a first fractional-pixel; and obtain the second one of the second motion vectors corresponding to the first sub-block based on the motion vector of the first fractional-pixel and the motion vector corresponding to the first reference sub-block corresponding to the smallest matching cost.

In some embodiments, the predicting unit 22 is specifically configured to: determine a picture order count of a first reference picture corresponding to the first one of the N first motion vectors, a picture order count of a current picture, and a picture order count of a second reference picture corresponding to the second one of the N first motion vectors; and determine the second motion vector difference based on the picture order count of the first reference picture, the picture order count of the current picture, the picture order count of the second reference picture and the first motion vector difference.

In some embodiments, the predicting unit 22 is specifically configured to: determine a first difference value between the picture order count of the second reference picture and the picture order count of the current picture; determine a second difference value between the picture order count of the first reference picture and the picture order count of the current picture; and obtain the second motion vector difference based on the first difference value, the second difference value, and the first motion vector difference.

In some embodiments, the predicting unit 22 is specifically configured to: determine a ratio between the first difference value and the second difference value; and determine a product of the ratio and the first motion vector difference as the second motion vector difference.

In some embodiments, the predicting unit 22 is specifically configured to add the first motion vector difference to the first motion vector to obtain the second motion vector.

In some embodiments, the predicting unit 22 is specifically configured to: based on the at least one first motion vector, perform a matching search within a preset search range of a reference picture corresponding to the at least one first motion vector, to obtain the at least one second motion vector.

In some embodiments, the at least one first motion vector includes a first one of the at least one first motion vector and a second one of the at least one first motion vector, and the predicting unit 22 is specifically configured to: partition the current block into at least one second sub-block; for any one of the at least one second sub-block, perform the matching search within a preset search range of a reference picture corresponding to the first one of the at least one first motion vector, to obtain multiple third reference sub-blocks corresponding to the second sub-block, and perform the matching search within a preset search range of a reference picture corresponding to the second one of the at least one first motion vector, to obtain multiple fourth reference sub-blocks corresponding to the second sub-block; determine matching costs between the multiple third reference sub-blocks and the multiple fourth reference sub-blocks, and select a third reference sub-block and a fourth reference sub-block corresponding to a smallest matching cost from the multiple third reference sub-blocks and the multiple fourth reference sub-blocks; and obtain a first one of second motion vectors corresponding to the second sub-block based on a matching cost, and obtain a second one of the second motion vectors corresponding to the second sub-block based on a motion vector corresponding to the fourth reference sub-block corresponding to the smallest matching cost.

In some embodiments, the predicting unit 22 is specifically configured to: for any one of the multiple third reference sub-blocks and any one of the multiple fourth reference blocks, determine a first matching cost between the third reference sub-block and the fourth reference sub-block; and obtain a matching cost between the third reference sub-block and the fourth reference sub-block based on the first matching cost.

In some embodiments, the predicting unit 22 is specifically configured to: determine a weight derivation mode for the current block; determine a weight corresponding to the i-th prediction mode based on the weight derivation mode; and obtain the first matching cost between the third reference sub-block and the fourth reference sub-block based on the weight corresponding to the i-th prediction mode and the third reference sub-block and the fourth reference sub-block.

In some embodiments, the predicting unit 22 is configured to: obtain a second differential value based on the third reference sub-block and the fourth reference sub-block; and multiply the weight corresponding to the i-th prediction mode with the second differential value to obtain the first matching cost.

In some embodiments, the predicting unit 22 is specifically configured to determine an absolute value of a difference value between the third reference sub-block and the fourth reference sub-block as the second differential value.

In some embodiments, the predicting unit 22 is specifically configured to determine the first matching cost as the matching cost between the third reference sub-block and the fourth reference sub-block.

In some embodiments, the predicting unit 22 is specifically configured to: determine a second matching cost between a template of the third reference sub-block and a template of the second sub-block; determine a third matching cost between a template of the fourth reference sub-block and the template of the second sub-block; and obtain the matching cost between the third reference sub-block and the fourth reference sub-block based on the first matching cost, the second matching cost, and the third matching cost.

In some embodiments, the predicting unit 22 is specifically configured to add the first matching cost, the second matching cost and the third matching cost, to obtain the matching cost between the third reference sub-block and the fourth reference sub-block.

In some embodiments, the predicting unit 22 is specifically configured to perform weighted summation on the first matching cost, the second matching cost and the third matching cost, to obtain the matching cost between the third reference sub-block and the fourth reference sub-block.

In some embodiments, the predicting unit 22 is specifically configured to: determine a first weighting factor corresponding to the first matching cost; determine a second weighting factor corresponding to the second matching cost and the third matching cost; and weight the first matching cost, the second matching cost, and the third matching cost based on the first weighting factor and the second weighting factor, to obtain the matching cost between the third reference sub-block and the fourth reference sub-block.

In some embodiments, the predicting unit 22 is specifically configured to: perform a fractional-pixel search within a surrounding area of the third reference sub-block corresponding to the smallest matching cost to obtain a motion vector of a second fractional-pixel; obtain the first one of the second motion vectors corresponding to the second sub-block based on the motion vector of the second fractional-pixel and the motion vector corresponding to the third reference sub-block corresponding to the smallest matching cost; perform the fractional-pixel search within a surrounding area of the fourth reference sub-block corresponding to the smallest matching cost to obtain a motion vector of a third fractional-pixel; and obtain the second one of the second motion vectors corresponding to the second sub-block based on the motion vector of the third fractional-pixel and the motion vector corresponding to the fourth reference sub-block corresponding to the smallest matching cost.

In some embodiments, the predicting unit 22 is specifically configured to: determine weights of prediction values based on the weight derivation mode; and weight the i-th prediction value and the other prediction values based on the weights of the prediction values to obtain the prediction value of the current block.

It is to be understood that device embodiments and method embodiments may correspond to each other and similar descriptions of the device embodiments may refer to the method embodiments, which is not described again herein to avoid repetition. In particular, the device 20 shown in FIG. 24 may correspond to a corresponding body in the method for video decoding in the embodiments of the present disclosure, and the above and other operations and/or functions of all units in the device 20 respectively implement the corresponding workflows of the method for video decoding, which are not repeated herein for the sake of brevity.

The device and system of the embodiment of the present disclosure are described above from the perspective of functional units with reference to the accompanying drawings. It is to be understood that the functional units may be implemented in hardware form, by instructions in software form, or by a combination of hardware and software modules. In particular, each operation of the method embodiments in the embodiments of the present disclosure can be implemented by the integrated logic circuit of the hardware in the processor and/or the instruction in software form, and the steps of the methods disclosed in connection with the embodiments of the present disclosure may be directly embodied in the execution completion of the hardware decoding processor, or by the combination of the hardware and software modules in the decoding processor. Optionally, the software unit may be located in random memory, flash memory, read-only memory, programmable read-only memory or electrically erasable programmable memory, register and other mature storage media in the art. The storage medium is located in the memory, and the processor reads the information in the memory and completes the steps of the above method in combination with its hardware.

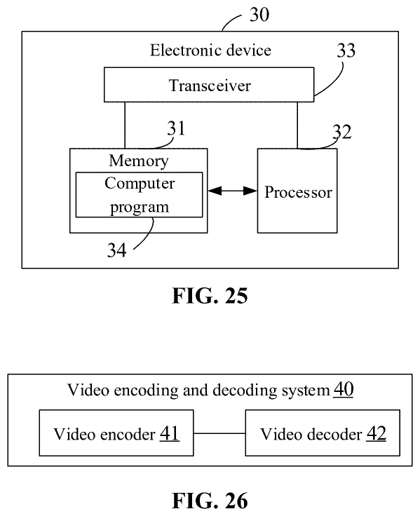

FIG. 25 is a schematic block diagram of an electronic device according to an embodiment of the present disclosure.

As shown in FIG. 25, the electronic device 30 may be a video encoder or a video decoder described in the embodiments of the present disclosure, and the electronic device 30 may include a memory 31 and a processor 32.

The memory 31 is configured to store a computer program 34 and transmit the computer program 34 to the processor 32. In other words, the processor 32 may invoke and execute the computer program 34 from the memory 31 to implement the method in the embodiment of the present disclosure.

For example, the processor 32 may be configured to perform the operations of the method described above according to instructions in the computer program 34.

In some embodiments of the present disclosure, the processor 32 may include, but is not limited to:
a general purpose processor, a Digital Signal Processor (DSP), an Application Specific Integrated Circuit (ASIC), a Field Programmable Gate Array (FPGA) or other programmable logic devices, discrete gate or transistor logic devices, discrete hardware components and so on.

In some embodiments of the present disclosure, the memory 31 includes, but is not limited to:
A volatile memory or a non-volatile memory, or may include both volatile and non-volatile memory. The nonvolatile memory can be Read-Only Memory (ROM), Programmable ROM (PROM), Erasable Prom (EPROM), Electrically Erasable EPROM (EEPROM) or flash memory. The volatile memory can be Random Access Memory (RAM), which is used as an external cache. Many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synch link DRAM (SLDRAM) and Direct Rambus RAM (DR RAM).

In some embodiments of the present disclosure, the computer program 34 may be divided into one or more units stored in the memory 31 and executed by the processor 32 to complete the methods provided herein. The one or more units may be a series of computer program instruction segments capable of implementing particular functions, and the instruction segments are used for describing execution of the computer program 34 in the electronic device 30.

As shown in FIG. 25, the electronic device 30 may further include a transceiver 33.

The transceiver 33 may be connected to the processor 32 or memory 31.

The processor 32 may control the transceiver 33 to communicate with other devices, specifically, may transmit information or data to other devices, or receive information or data transmitted by other devices. The transceiver 33 may include a transmitter and a receiver. The transceiver 33 may further include antennas, and the number of antennas may be one or more.

It is to be understood that the various components in the electronic device 30 are connected by a bus system that includes a power bus, a control bus, and a status signal bus, in addition to a data bus.

FIG. 26 is a schematic block diagram of a video encoding and decoding system according to an embodiment of the present disclosure.

As shown in FIG. 26, the video encoding and decoding system 40 may include a video encoder 41 and a video decoder 42. The video encoder 41 is configured to perform the method for video encoding according to the embodiment of the present disclosure, and the video decoder 42 is configured to perform the method for video decoding according to the embodiment of the present disclosure.

The present disclosure also provides a computer storage medium having stored thereon a computer program that, when executed by a computer, enables the computer to perform the method of the method embodiments described above. In other words, the embodiment of the present disclosure further provide a computer program product including instructions that, when executed by a computer, cause the computer to perform the method of the method embodiments described above.

The present disclosure also provides a bitstream generated according to the encoding method described above.

Embodiments of the present disclosure provide a method for video encoding, a method for video decoding, devices, apparatuses, a system, and a storage medium, at least one prediction mode for a current block is set to be a multi-directional prediction mode (such as, a bi-directional prediction mode), thereby improving prediction accuracy for the current block.

According to a first aspect, the present disclosure provides a method for video decoding, applied to a decoder, and the method for video decoding includes following operations.

K prediction modes for a current block are determined, where at least one of the K prediction modes is an N-directional prediction mode, and each of the K and N is a positive integer greater than 1.

The current block is predicted based on the K prediction modes to obtain a prediction value of the current block.

According to a second aspect, the embodiment of the present disclosure provides a method for video encoding including following operations.

K prediction modes for a current block are determined, where at least one of the K prediction modes is an N-directional prediction mode, and each of the K and N is a positive integer greater than 1.

The current block is predicted based on the K prediction modes to obtain a prediction value of the current block.

According to a third aspect, the present disclosure provides a device for video decoding configured to perform the method in the first aspect or methods in various implementations of the first aspect. Specifically, the device includes functional units configured to perform the method in the first aspect or methods in various implementations of the first aspect.

According to a fourth aspect, the present disclosure provides a device for video encoding configured to perform the method in the second aspect or methods in various implementations of the second aspect. Specifically, the device includes functional units configured to perform the method in the second aspect or methods in various implementations of the second aspect.

According to a fifth aspect, there is provided a video decoder including a processor and a memory. The memory is configured to store a computer program, and the processor is configured to invoke and execute the computer program stored in the memory to perform the method in the first aspect or methods in various implementations of the first aspect.

According to a sixth aspect, there is provided a video encoder including a processor and a memory. The memory is configured to store a computer program, and the processor is configured to invoke and execute the computer program stored in the memory to perform the method in the second aspect or methods in various implementations of the second aspect.

According to a seventh aspect, there is provided a video encoding and decoding system, including a video encoder and a video decoder. The video decoder is configured to perform the method in the first aspect or methods in various implementations of the first aspect, and the video encoder is configured to perform the method in the second aspect or methods in various implementations of the second aspect.

According to an eighth aspect, there is provided a chip configured to implement the method in any one of the first to second aspects or methods in various implementations of the first to second aspects. Specifically, the chip includes a processor configured to invoke and execute a computer program from a memory, to enable a device on which the chip is mounted to perform the method in any one of the first to second aspects or methods in various implementations of the first to second aspects.

According to a ninth aspect, there is provided a computer-readable storage medium configured to store a computer program that causes a computer to perform the method in any one of the first to second aspects or methods in various implementations of the first to second aspects.

According to a tenth aspect, there is provided a computer program product including computer program instructions that cause a computer to perform the method in any one of the first to second aspects or methods in various implementations of the first to second aspects.

According to an eleventh aspect, there is provided a computer program that, when executed on a computer, causes the computer to perform the method in any one of the first to second aspects or methods in various implementations of the first to second aspects.

According to a twelfth aspect, there is provided a bitstream generated based on the method of the second aspect, and optionally, the bitstream includes a first index for indicating a first combination consisting of one weight derivation mode and K prediction modes, where K is a positive integer greater than 1.

Based on the above technical solutions, when the current block is encoded or decoded, K prediction modes for the current block are determined, and at least one of the K prediction modes is a multi-directional prediction mode (such as, a bi-directional prediction mode), so that when the K prediction modes are used for predicting the current block, the prediction accuracy for the current block can be improved, and the encoding and decoding effects for the video can be improved.

The above-described embodiments are implemented in software, they may be implemented in whole or in part in the form of a computer program product. The computer program product includes one or more computer instructions. When the computer program instructions are loaded and executed on a computer, the flows or functions according to the embodiments of the disclosure are generated in whole or in part. The computer may be a general purpose computer, a dedicated computer, a computer network, or other programmable devices. The computer instructions may be stored in a computer-readable storage medium or transmitted from one computer-readable storage medium to another. For example, the computer instructions may be transmitted from one Web site, computer, server, or data center to another Web site, computer, server, or data center in a wired (e.g. coaxial cable, optical fiber, digital subscriber line (DSL)) manner or wireless (e.g. infrared, wireless, microwave, etc.) manner. The computer-readable storage medium may be any available medium that a computer may access or a data storage device such as a server, a data center, or the like that contains one or more integrations of available medium. The available medium may be magnetic medium (e.g. floppy disk, hard disk, magnetic tape), optical medium (e.g. DVD), or semiconductor medium (e.g. Solid State Disk (SSD)), etc.

Those of ordinary skill in the art may be aware that the units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. A person skilled in the art may realize the described functions for each particular disclosure by different methods, but it is not considered that the implementation is beyond the scope of the disclosure.

In the several embodiments provided in the disclosure, it is to be understood that the disclosed system, device, and method may be implemented in other modes. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, the displayed or discussed mutual couplings or direct couplings or communication connections may be implemented by using some interfaces. The indirect couplings or communication connections between the devices or units may be implemented in electronic, mechanical, or other forms.

The units described as separate components may or may not be physically separated, and the components displayed as units may or may not be physical units, and may be located in one place or may be distributed over multiple network units. Some or all of the units may be selected according to actual needs to achieve the objectives of the schemes of the embodiments For example, functional units in various embodiments of the disclosure may be integrated into one processing unit, or each of the units may be physically separated, or two or more units may be integrated into one unit.

The above descriptions are merely specific implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure is defined by the scope of protection of the claims.

1. A method for video decoding, comprising:
determining K prediction modes for a current block, wherein at least one of the K prediction modes is an N-directional prediction mode, and each of the K and N is a positive integer greater than 1; and
predicting the current block based on the K prediction modes to determine a prediction value of the current block.

2. The method of claim 1, wherein predicting the current block based on the K prediction modes to determine the prediction value of the current block comprises:
for an i-th prediction mode among the K prediction modes, if the i-th prediction mode is the N-directional prediction mode, determining N pieces of first motion information corresponding to the i-th prediction mode, where i is a positive integer less than or equal to K;
determining an i-th prediction value of the current block based on the N pieces of first motion information; and
determining the prediction value of the current block based on the i-th prediction value.

3. The method of claim 2, wherein the first motion information comprises a first motion vector, and determining the i-th prediction value of the current block based on the N pieces of first motion information comprises:
performing refinement on at least one first motion vector of N first motion vectors to determine at least one second motion vector; and
determining the i-th prediction value of the current block based on the at least one second motion vector.

4. The method of claim 3, wherein performing refinement on the at least one first motion vector of the N first motion vectors to determine the at least one second motion vector comprises:
determining motion vector difference information;
determining a first motion vector difference based on the motion vector difference information; and
performing refinement on the at least one first motion vector of the N first motion vectors based on the first motion vector difference, to determine the at least one second motion vector.

5. The method of claim 4, wherein the motion vector difference information comprises: a direction index and a distance index, and determining the motion vector difference information comprises:
decoding a bitstream to determine the direction index and the distance index,
wherein determining the first motion vector difference based on the motion vector difference information comprises:
determining the first motion vector difference based on the direction index and the distance index.

6. The method of claim 5, wherein the method further comprises:
decoding the bitstream to determine first information, wherein the first information indicates whether the i-th prediction mode is refined by using motion vector difference.

7. The method of claim 4, wherein performing refinement on the at least one first motion vector of the N first motion vectors based on the first motion vector difference, to determine the at least one second motion vector comprises:
performing refinement on the N first motion vectors based on the first motion vector difference to determine N second motion vectors.

8. The method of claim 4, where N is 2, and wherein the N first motion vectors comprise a first one of the N first motion vectors and a second one of the N first motion vectors, and wherein performing refinement on the at least one first motion vector of the N first motion vectors based on the first motion vector difference, to determine the at least one second motion vector comprises:
performing refinement on the first one of the N first motion vectors based on the first motion vector difference to determine a first one of second motion vectors;
determining a second motion vector difference based on the first motion vector difference; and
performing refinement on the second one of the N first motion vectors based on the second motion vector difference to determine a second one of the second motion vectors.

9. The method of claim 8, wherein performing refinement on the second one of the N first motion vectors based on the second motion vector difference to determine the second one of the second motion vectors comprises:
adding the second motion vector difference to the second one of the N first motion vectors to determine the second one of the second motion vectors.

10. The method of claim 8, wherein determining the second motion vector difference based on the first motion vector difference comprises:
determining a picture order count of a first reference picture corresponding to the first one of the N first motion vectors, a picture order count of a current picture, and a picture order count of a second reference picture corresponding to the second one of the N first motion vectors; and
determining the second motion vector difference based on the picture order count of the first reference picture, the picture order count of the current picture, the picture order count of the second reference picture and the first motion vector difference.

11. The method of claim 10, wherein determining the second motion vector difference based on the picture order count of the first reference picture, the picture order count of the current picture, the picture order count of the second reference picture and the first motion vector difference comprises:
determining a first difference value between the picture order count of the second reference picture and the picture order count of the current picture;
determining a second difference value between the picture order count of the first reference picture and the picture order count of the current picture; and
determining the second motion vector difference based on the first difference value, the second difference value, and the first motion vector difference.

12. The method of claim 11, wherein determining the second motion vector difference based on the first difference value, the second difference value, and the first motion vector difference comprises:
determining a ratio between the first difference value and the second difference value; and
determining a product of the ratio and the first motion vector difference as the second motion vector difference.

13. The method of claim 7, wherein performing refinement on a first motion vector based on a first motion vector difference to determine a second motion vector comprises:
adding the first motion vector difference to the first motion vector to determine the second motion vector.

14. The method of claim 3, wherein performing refinement on the at least one first motion vector of the N first motion vectors to determine the at least one second motion vector comprises:
based on the at least one first motion vector, performing a matching search within a preset search range of a reference picture corresponding to the at least one first motion vector, to determine the at least one second motion vector.

15. The method of claim 2, wherein determining the prediction value of the current block based on the i-th prediction value comprises:
determining a weight of the i-th prediction value based on a weight derivation mode; and
determining the prediction value of the current block based on the i-th prediction value and the weight of the i-th prediction value.

16. A method for video encoding, comprising:
determining K prediction modes for a current block, wherein at least one of the K prediction modes is an N-directional prediction mode, and each of the K and N is a positive integer greater than 1; and
predicting the current block based on the K prediction modes to determine a prediction value of the current block.

17. The method of claim 16, wherein predicting the current block based on the K prediction modes to determine the prediction value of the current block comprises:
for an i-th prediction mode among the K prediction modes, if the i-th prediction mode is the N-directional prediction mode, determining N pieces of first motion information corresponding to the i-th prediction mode, where i is a positive integer less than or equal to K;
determining an i-th prediction value of the current block based on the N pieces of first motion information; and
determining the prediction value of the current block based on the i-th prediction value.

18. The method of claim 17, wherein the first motion information comprises a first motion vector, and determining the i-th prediction value of the current block based on the N pieces of first motion information comprises:
performing refinement on at least one first motion vector of N first motion vectors to determine at least one second motion vector; and
determining the i-th prediction value of the current block based on the at least one second motion vector.

19. A device for video decoding, comprising:
a processor; and
a memory, configured to store a computer program executable by the processor,
wherein the processor is configured to:
determine K prediction modes for a current block, wherein at least one of the K prediction modes is an N-directional prediction mode, and each of the K and N is a positive integer greater than 1; and
predict the current block based on the K prediction modes to determine a prediction value of the current block.

20. A computer-readable storage medium storing a computer program,
wherein the computer program causes a computer to perform the method of claim 16 to generate a bit stream.
